(19) United States
(12) Patent Application Publication
(10) Pub. No.: US 2009/0198584 A1
(43) Pub. Date: Aug. 6, 2009

(54) MANAGEMENT AND PUBLICATION OF IDEAS FOR INVENTIONS ACCUMULATED IN A COMPUTER DATABASE

(75) Inventors: Jens Erik Sorensen, San Diego, CA (US); Jens Ole Sorensen, Rancho Santa Fe, CA (US)

Correspondence Address: KNOBBE MARTENS OLSON & BEAR LLP, 2040 MAIN STREET, FOURTEENTH FLOOR, IRVINE, CA, 92614, US

(73) Assignee: SORENSEN RESEARCH AND DEVELOPMENT TRUST, San Diego, CA (US)

(21) Appl. No.: 11/760,710

(22) Filed: Jun. 8, 2007

Related U.S. Application Data
(63) Continuation-in-part of application No. 10/309,384, filed on Nov. 25, 2002, now Pat. No. 7,464,108.
Application No. 10/309,384 is a division of application No. 10/072,071, filed on Feb. 8, 2002, now abandoned.
Application No. 10/072,071 is a continuation-in-part of application No. 09/980,654, filed on Oct. 25, 2001, now abandoned.
Application No. 09/980,654 is a continuation-in-part of application No. 10/371,643, filed on Feb. 21, 2003, now abandoned.
Application No. 10/371,643 is a continuation-in-part of application No. 10/072,071, filed on Feb. 8, 2002, now abandoned.
Application No. 10/072,071 is a continuation-in-part of application No. 09/980,654, filed on Oct. 25, 2001, now abandoned.
(60) Provisional application No. 60/224,944, filed on Aug. 11, 2000.
(60) Provisional application No. 60/227,687, filed on Aug. 24, 2000.

(51) Int. Cl. G06Q 30/00; G06Q 50/00; G06F 17/30

(52) U.S. Cl. 705/26; 707/104.1; 707/E17.044

(57) ABSTRACT

Management in a database of inventions, ideas, and rights related to inventions including publication of ideas for inventions accumulated in a computer database. A computerized method includes establishing a contractual obligation by a prospective contributor of an idea contribution for the database to transfer property rights of a prospectively patentable invention. The contributor is enabled to view at least some other idea contributions accumulated in the database. The idea contribution is received for the database from the contributor. Ownership of a contractual benefit is provided to the contributor, wherein the contractual benefit is transferred from the owner of the contractual benefit to a new owner of the contractual benefit. The idea contribution from the database is published. Some of the property rights are transferred to a customer to allow the customer to file a patent application and/or remuneration is distributed to the new owner in exchange for the contractual benefit.

### RELATED APPLICATIONS

This application is a continuation-in-part of U.S. patent application Ser. No. 10/309,384 filed Nov. 25, 2002, which is a division of U.S. patent application Ser. No. 10/072,071 filed Feb. 8, 2002, which is a continuation-in-part of U.S. patent application Ser. No. 09/980,654 filed Oct. 25, 2001, which was the National Stage of International Application No. PCT/US01/25317 filed Aug. 10, 2001, which claims the benefit of U.S. Provisional Patent Application No. 60/224,944 filed Aug. 11, 2000 and U.S. Provisional Patent Application No. 60/227,687 filed Aug. 24, 2000. This application is also a continuation-in-part of U.S. patent application Ser. No. 10/371,643 filed Feb. 21, 2003, which is a continuation-in-part of U.S. patent application Ser. No. 10/072,071 filed Feb. 8, 2002, which is a continuation-in-part of U.S. patent application Ser. No. 09/980,654 filed Oct. 25, 2001, which was the National Stage of International Application No. PCT/US01/25317 filed Aug. 10, 2001, which claims the benefit of U.S. Provisional Patent Application No. 60/224,944 filed Aug. 11, 2000 and U.S. Provisional Patent Application No. 60/227,687 filed Aug. 24, 2000.

### BACKGROUND OF THE INVENTION

1. Field of the Invention

The present invention relates to use of a computer database for management and publication of ideas, and particularly to management and publication of ideas for inventions accumulated in the computer database.

2. Description of the Related Technology

A discovery of a problem, need or requirement calling for a solution is commonly an integral idea-component of an invention. The ideas may include needs, problems, solutions, requirements, discoveries and/or inventions and/or are accumulated prior to filing patent applications for inventions derived at least in part from the accumulated ideas.

### SUMMARY OF CERTAIN INVENTIVE ASPECTS

Embodiments of a system and method pertain to management and publication of ideas for inventions accumulated in a computer database, management of rights related to inventions derived from ideas accumulated in a computer database and managing idea contributions for prospectively patentable inventions that are accumulated in a computer database.

In one embodiment, there is a computerized method of managing idea contributions for prospectively patentable inventions that are accumulated in a computer database, the method comprising (a) establishing a contractual obligation by a prospective contributor of an idea contribution for the database to transfer property rights of the contributor of a prospectively patentable invention derived at least in part from the idea contribution, (b) enabling the contributor to view at least some other idea contributions accumulated in the database that are contributed by other contributors, (c) receiving the idea contribution for the database from the contributor, (d) providing ownership of a contractual benefit relating to the idea contribution to the contributor, wherein the contractual benefit is transferred from the owner of the contractual benefit to a new owner of the contractual benefit, (e): publishing the idea contribution prior to (f), (f) transferring some of the property rights to a customer to thereby allow the customer to file a patent application for the prospectively patentable invention derived at least in part from the idea contribution, and (g) distributing remuneration to the new owner in exchange for the contractual benefit.

Acts (a) through (g) can be performed by a database proprietor and/or one or more parties operating in concert with the database proprietor.

Property rights can include, but are not restricted to, one or more of patent rights, trade secret rights, copyrights, trademark rights, business-idea rights and lead-time rights. The property rights can also include rights to contributed ideas per se. The inventions may be inventions derived from integrated contributed ideas and/or inventions innate to a single idea contributed by a single contributor. In certain embodiments, the property rights include at least the patent rights to prospectively patentable inventions derived at least in part from ideas contributed to the computer database. In certain embodiments, at least one of acts (a) through (d) is performed on-line.

The foregoing acts can be performed by one party or by different parties in concert with one another.

In other embodiment, there is a computer readable storage media, comprising computer executable instructions for causing a computer to manage ideas in a computer database and/or causing a computer to manage rights related to inventions related to ideas accumulated in a computer database and/or causing a computer to publish ideas for inventions accumulated in a computer database in accordance with the present method.

Additional features of the embodiments are described with reference to the detailed description of certain inventive embodiments.

### BRIEF DESCRIPTION OF THE DRAWINGS

FIG. 1 is a diagram illustrating various aspects of an embodiment of a system and method for management and publication of ideas for inventions.

FIG. 1A is a diagram showing in greater detail some of the “contractual obligations” by idea contributors shown only generally in the diagram of FIG. 1.

FIG. 1B is a diagram showing four alternative embodiments of the “enable viewing” function shown only generally in the diagram of FIG. 1.

FIG. 1C is a diagram showing in greater detail the “listings” shown only generally in the diagram of FIG. 1.

FIG. 2 is a diagram of an exemplary embodiment of an organization of an integrated idea in a computer database, where problem ideas are indicated by squares and solution ideas are indicated by circles.

FIGS. 3 through 60 are views of various example screen displays provided from an example website to a user upon accessing an idea database in accordance with the system and method, where FIGS. 19 through 42 are related to browsing the exemplary embodiment of the integrated idea that is organized as shown in FIG. 2.

FIG. 61 is a diagram illustrating various aspects of another embodiment of a system and method for management and publication of ideas for inventions.

FIG. 62 is a diagram showing in greater detail some of the “contractual obligations” by idea contributors shown only generally in the diagram of FIG. 61.

FIG. 63 is a view of an About IDEA SHARES screen display that may be provided to a user after accessing the idea database of FIG. 61.

FIG. 64 is a diagram showing in greater detail the “transfer of contingent contractual rights” functions and the “transfer of property rights” functions shown in the diagram of FIG. 61.

FIG. 65 is a view of an Idea Certificate Owner Marketing Options screen display.

FIG. 66 is a view of a Solution-type screen display.

FIG. 67 is a view of a first Idea Prospector screen display.

FIG. 68 is a view of a second Idea Prospector screen display.

FIG. 69 is a view of a third Idea Prospector screen display.

FIG. 70 is a view of a fourth Idea Prospector screen display.

Views of screen displays overlapping two sheets of drawing are identified by a common FIG. number and A and B suffixes.

### DETAILED DESCRIPTION OF CERTAIN INVENTIVE EMBODIMENTS

The following detailed description of certain embodiments presents various descriptions of specific embodiments of the invention. However, the invention can be embodied in a multitude of different ways as defined and covered by the claims. In this description, reference is made to the drawings where like reference numerals indicate identical or functionally similar elements.

The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

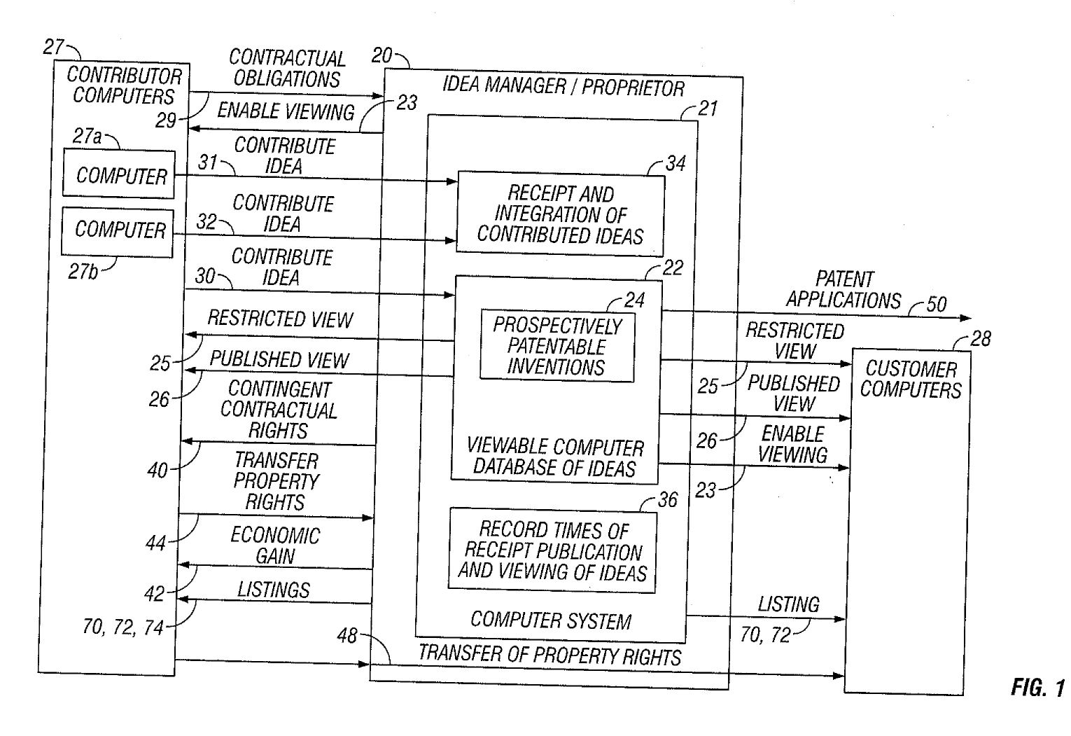

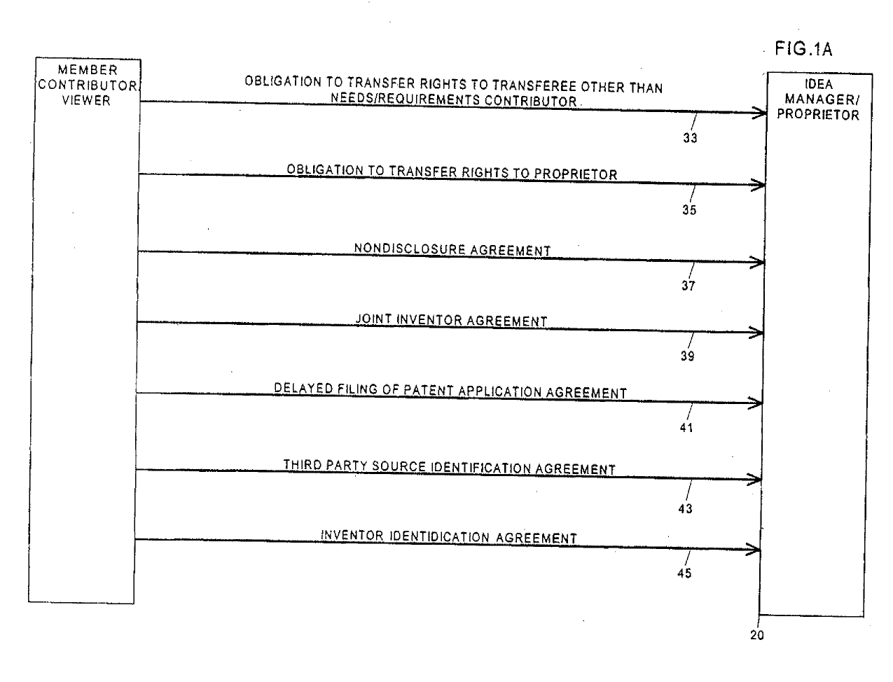

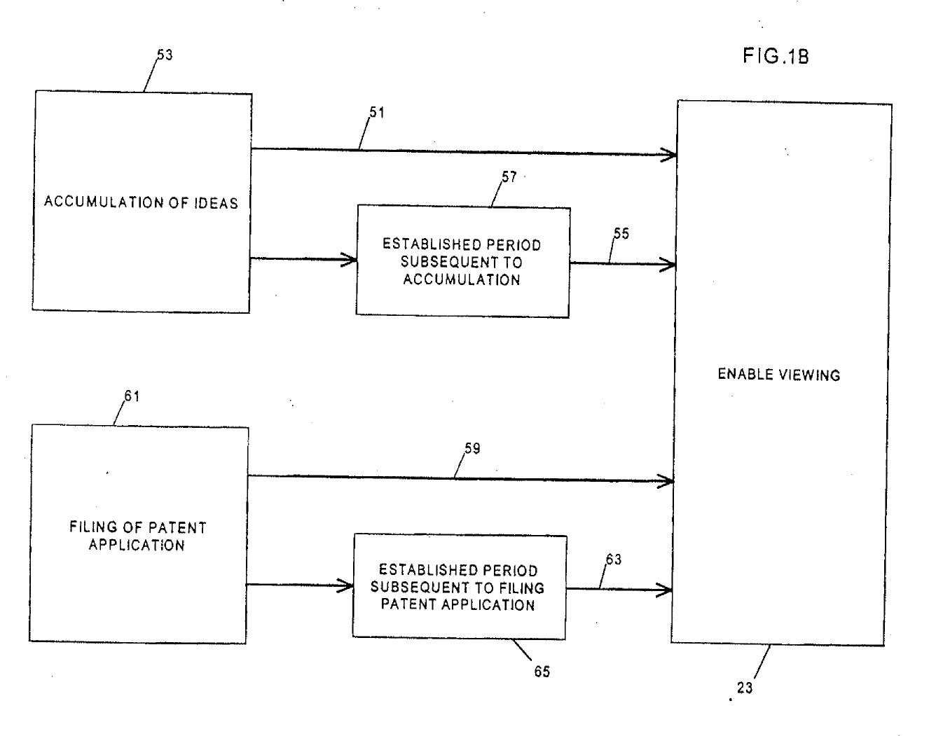

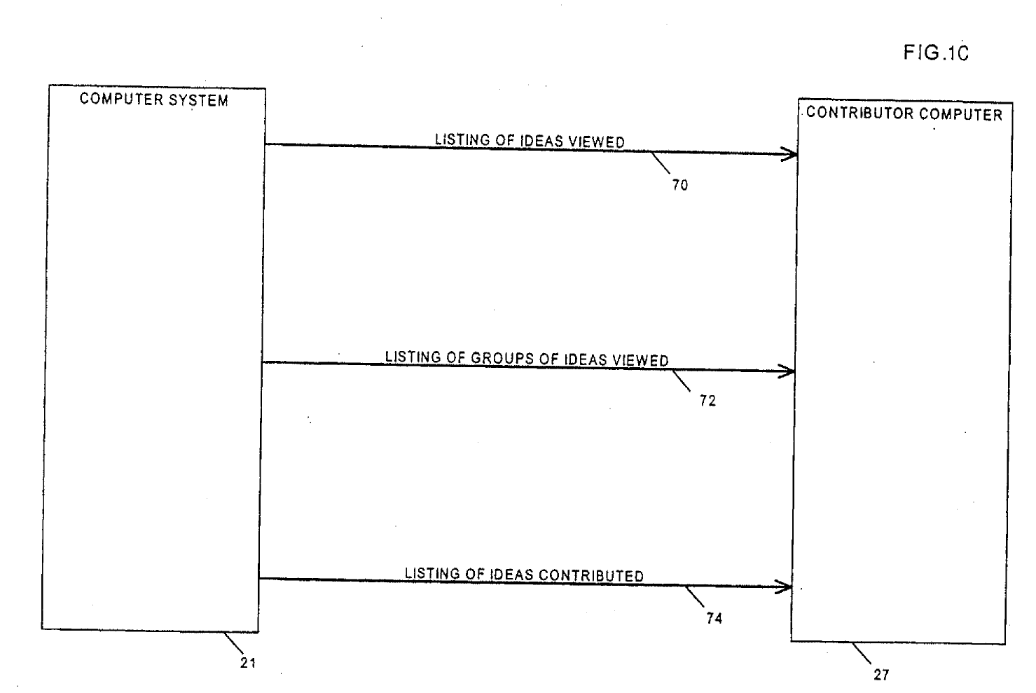

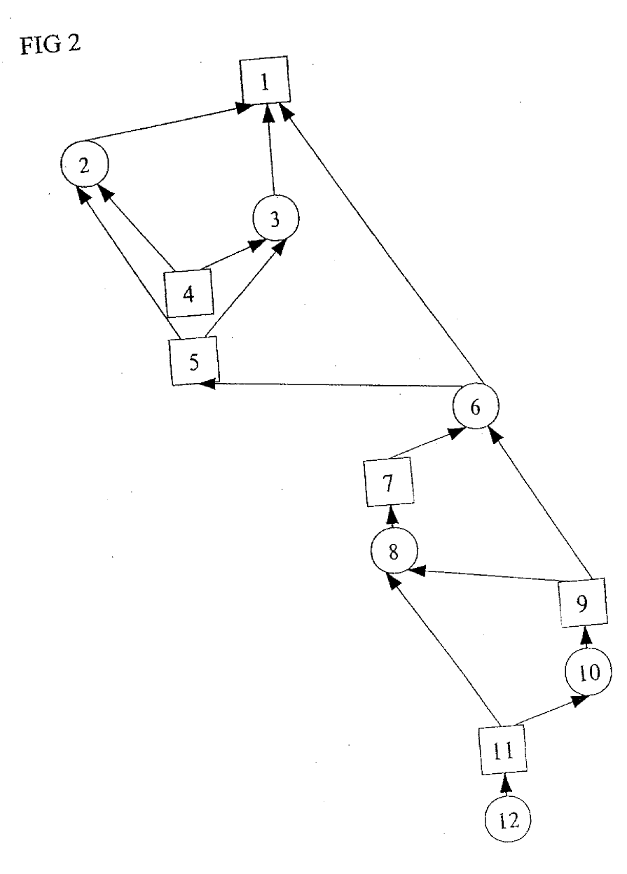

Referring to FIG. 1, in one embodiment, an idea manager 20 maintains a computer system 21 and a computer database 22 for accumulating ideas for prospectively patentable inventions. The accumulated ideas include needs and requirements of such inventions and/or are systematically accumulated prior to filing any patent applications for inventions respectively derived at least in part from the accumulated ideas. In certain embodiments, the idea manager 20 is the proprietor of the computer database 22. The computer system 21 is adapted by hardware, firmware and/or software for performing and/or enabling performance of the various methods described herein.

The computer system 21 may include one or more computers and one or more memories contained within or coupled to the computer(s). The idea manager 20 may be one party or different parties operating in concert with one another. Idea contributors use computers 27 to view 25, 26 the ideas accumulated in the database 22. One idea contributor can be the idea manager 20, including its staff and/or its computer system 21. Some contributor computers 27 may be shared by a plurality of contributors. Potential customers for property rights, including patent rights, to prospectively patentable inventions 24 derived at least in part from the ideas accumulated in the database 22 use computers 28 to view 25, 26 the accumulated ideas in the database 22 when viewing is enabled 23 by the computer system 21. In some embodiments, the contributor computers 27 may be the same as the customer computers 28 and/or the computers of the computer system 21. Some viewings 25 of the ideas from the database 22 are so restricted by non-disclosure agreements by the viewers as not to constitute a publication of the ideas; and some viewings 26 of the ideas from the database 22 are enabled without restriction and thereby constitute a publication of the ideas.

The computer system 21 is programmed by the idea manager 20 to facilitate use of the contributor computers 27 to make on-line contributions of ideas 30, 31, 32 to the computer database of ideas 22. Computer programs that enable the contributor computers 27 to be used to make on-line contributions of ideas to the database 22 can be downloaded by the contributor computers 27 from the computer system 21. An on-line contribution is a contribution that is made over a communication network, such as the Internet.

In some embodiments, the computer system 21 is programmed to require persons to enter into a membership as a prerequisite for viewing a portion of the database 22 containing at least some of the accumulated ideas, and to facilitate entry into such membership by on-line communications between the computer system 21 and the contributor computers 27. Entry into such a membership can also be effected by other means, such as by mail. Upon entering into a viewer membership, a person agrees to give up some legal rights. In alternative embodiments, no such membership is required for on-line viewing of any portion of the database 22 by the general public.

In some embodiments, the computer system 21 is programmed to require contributors of ideas for prospective entry into the database 22 to enter into a membership as a prerequisite for contributing ideas for entry into the database 22, and to facilitate entry into such membership by on-line communications between the computer system 21 and the contributor computers 27. Entry into such a membership can also be effected by other means, such as by mail. Upon entering into a contributor membership, a person agrees to give up some legal rights and/or to transfer some property rights with respect to ideas contributed by such person. In some of the embodiments with such a membership requirement, the membership is limited to any entity that agrees to transfer or otherwise encumber property rights, including patent rights, to any inventions derived from any idea contributed by the entity. In alternative embodiments, no such membership is required for contributing ideas for entry into the computer database 22.

In some embodiments, the computer system 21 is programmed to systematically establish contractual obligations 29 by contributors of the ideas to the database 22 and to facilitate establishment of such obligations 29 by on-line communications between the computer system 21 and the contributor computers 27. With regard to some of the contractual obligations 29, in some embodiments the persons that are obligated generally are not employees of the proprietor 20 or employees of a party in concert with the proprietor 20.

Referring to FIG. 1A, in certain embodiments, these systematically established contractual obligations 29 include one or more of the following:
obligations 33 by contributors of ideas to the computer database 22 to transfer property rights, including patent rights, to inventions respectively derived at least in part from the contributed ideas to transferees other than contributors of ideas of needs and/or requirements of the respectively derived inventions;
obligations 35 by contributors of ideas to the computer database 22 to transfer property rights, including patent rights, to inventions respectively derived at least in part from the contributed ideas to the proprietor 20 of the computer database 22 or to a party in concert with the proprietor 20;
nondisclosure agreements 37 pertaining to given ideas accumulated in the database 22 and consummated by persons whom have entered into a membership as a prerequisite for contributing ideas to the computer database 22 and/or for viewing the accumulated ideas;
joint inventor agreements 39 consummated by persons whom have entered into a membership as a prerequisite for contributing ideas to the computer database 22 and/or for viewing the accumulated ideas and agreeing to file as a joint inventor any patent application for any invention derived from a combination of any ideas contributed to the database 22 by such person and given accumulated ideas contributed to the database 22 by other persons;
delayed filing of patent application agreements 41 consummated by persons whom have entered into a membership as a prerequisite for contributing ideas to the computer database 22 and/or for viewing the accumulated ideas and agreeing not to file, without permission of the proprietor 20 of the computer database 22, a patent application for any invention related to a given idea accumulated in the database 22 until after an established period of time subsequent to accumulation of the given idea;
third party source identification agreements 43 consummated by persons whom have entered into a membership as a prerequisite for contributing ideas to the computer database 22 and/or for viewing the accumulated ideas and agreeing to disclose the identity of any third-party sources of ideas contributed by such person that are related to given ideas accumulated in the database 22; and
inventor identification agreements 45 consummated by persons whom have entered into a membership as a prerequisite for contributing ideas to the computer database 22 and/or for viewing the accumulated ideas and agreeing to disclose the identity of each inventor of any invention derived from ideas contributed by such person that are related to given ideas accumulated in the database 22.

In some embodiments, the idea manager 20 facilitates transfer of property rights 44, 48 by the contributors of ideas to the computer database 22. In some of these embodiments, the transfer of property rights 44, 48 is to transferees other than contributors of ideas from which the invention was at least in part derived. In some of the embodiments, the transfer of property rights 44 is to a proprietor of the database 22, such as the idea manager 20, or to a party in concert with such proprietor 20. In some of these embodiments, the transferees are not identified upon establishing such obligations; and in some of these embodiments, the transferees are identified upon establishing such obligations.

In some embodiments, the transfer of property rights 44, 48 and/or the contractual obligations 29 to transfer property rights are in exchange for contingent economic gain, such as for example: contingent contractual rights 40 or shares of a portfolio of such contractual rights, or stock in the database proprietor 20 or a party in concert with the database proprietor 20. In some of these embodiments, the transfer of property rights 48 and/or the contractual obligations 29 to transfer property rights are in exchange for actual economic gain 42, such as for example: cash or bonds.

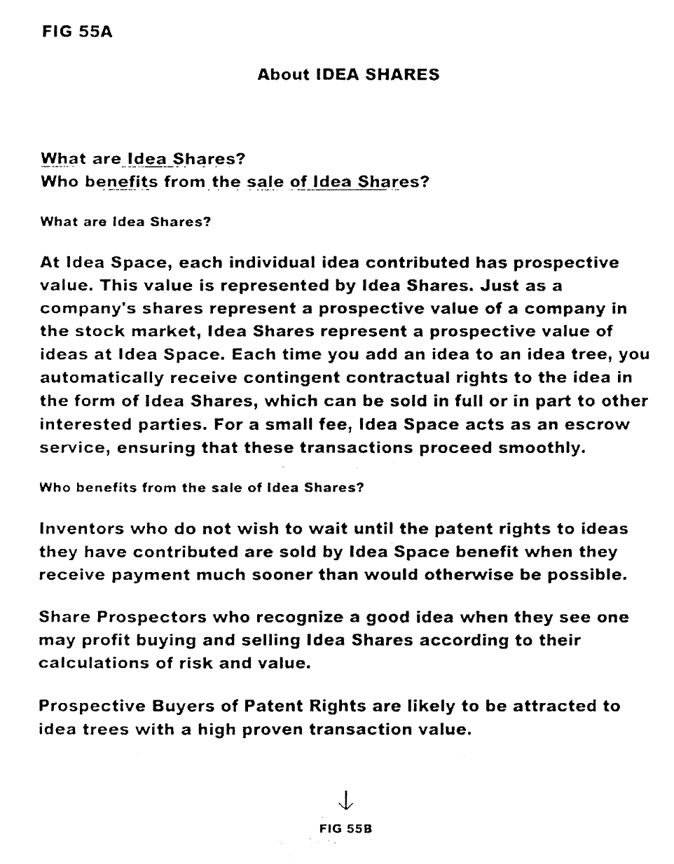

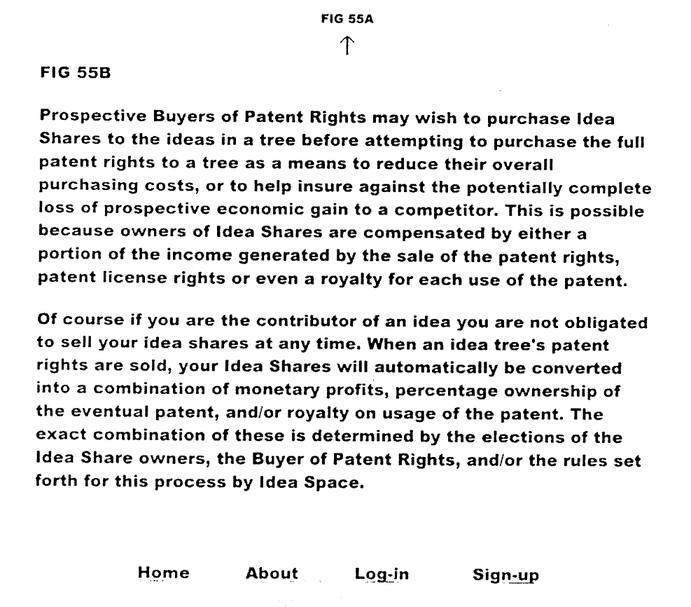

In some embodiments, the computer system 21 is programmed to systematically provide the contributors of ideas with contingent contractual rights 40 to at least some inventions derived at least in part from the ideas accumulated in the database 22, and to facilitate provision of such contingent rights in a marketable format, such as an electronically tradable certificate, by on-line communications between the computer system 21 and the contributor computers 27, or as described below with reference to FIGS. 55-60. The idea manager 20 systematically provides contingent contractual rights 40 to at least some of the contributors of ideas to the database 22 as an incentive for all or selected contributors to contribute ideas to the database 22; and/or compensates by economic gain 42 at least some contributor-owners of the contingent contractual rights in exchange for either acquiring 44 or facilitating transfer 48 of at least some of the property rights. The contingent contractual rights 40 include rights to a portion of anticipated income derived from property rights under the patent rights to prospectively patentable inventions 24 derived at least in part from the ideas contributed by the contributors whom receive such contingent contractual rights 40.

The computer system 21 is programmed to enable receipt of contributions of ideas for prospective entry into the database 22, and to facilitate receipt of such contributions on-line from the contributor computers 27. In some embodiments, the computer system 21 is programmed to systematically enter into the database 22 all the ideas contributed for entry into the database 22 without requiring any contributor of such ideas to have subject matter expertise as a prerequisite for entry of such contributions. In other embodiments, the computer system 21 is programmed to require contributors of ideas to the database 22 to have subject matter expertise as a prerequisite for contributing ideas for prospective entry into the database 22, and facilitate entry of evidence of such expertise by on-line communications between the computer system 21 and the contributor computers 27. Such evidence can also be effected by other means, such as by mail. In still other embodiments, the computer system 21 is programmed to selectively enter only some of the contributed ideas into the database 22. In some embodiments, selective entry is accomplished by systematic computer screening for relevant subject matter. In some embodiments, selective entry is accomplished by systematic computer screening for keywords and by a computer operator making a selective entry decision based upon the context in which the keywords are used.

In alternative embodiments, the computer system 21 is programmed to enable persons, whom have entered into a membership as a prerequisite for contributing ideas to the computer database 22 and/or for viewing the ideas accumulated in the database 22, and have consummated nondisclosure agreements 37, joint inventor agreements 39, delayed filing of patent application agreements 41, third party source identification agreements 43 and/or inventor identification agreements 45, as described above with reference to FIG. 1A, to contribute ideas to the computer database 22.

In some embodiments, the computer system 21 is programmed to systematically establish contractual obligations by the idea contributors to permit immediate public disclosure of the ideas contributed by the idea contributors, and to facilitate establishment of such obligations by on-line communications between the computer system 21 and the contributor computers 27. In certain embodiments, such permission is for immediate public disclosure of all of the ideas contributed by the contributor undertaking such contractual obligation. In some of these embodiments, the ideas received from such contributors and accumulated in the computer database 22 are immediately disclosed to the public upon receipt by entry into a publicly viewable portion of the database 22 and thereby systematically published prior to filing any patent applications for inventions respectively derived at least in part from such accumulated ideas. In other such embodiments, the disclosure is not effected or not effected immediately notwithstanding having permission to do so.

In some embodiments, the computer system 21 is programmed to record (a) the time of receipt of each idea contributed for entry into the database 22; (b) the time of publication in the database 22 of each accumulated idea; (c) the time of first viewing of each idea contributed to the database; and/or (d) the time of first public viewing from the database 22 of each accumulated idea, as indicated at 36 in FIG. 1.

In alternative embodiments, the computer system 21 is programmed to enable 23 persons, whom have entered into a membership as a prerequisite for contributing ideas to the computer database 22 and/or for viewing the ideas accumulated in the database 22, and/or have consummated nondisclosure agreements 37, joint inventor agreements 39, delayed filing of patent application agreements 41, third party source identification agreements 43 and/or inventor identification agreements 45, as described above with reference to FIG. 1A, to view 25, 26 accumulated ideas from the computer database 22, including ideas not respectively contributed by such persons.

In some embodiments, the computer system 21 is programmed to enable 23 persons, whom have not entered into a membership as a prerequisite for viewing the ideas accumulated in the database 22, to view 26 accumulated ideas from the computer database 22, including ideas not respectively contributed by such persons.

Four different embodiments of the timing of the enable viewing function 23 are described with reference to FIG. 1B. These four embodiments are applicable for viewing by both persons whom have entered into a membership as a prerequisite for contributing ideas to the computer database 22 and/or for viewing the ideas accumulated in the database 22 and persons whom have not entered into such a membership.

In one such embodiment, as shown by line 51, viewing of a given accumulated idea in the database 22 is systematically enabled 23 immediately subsequent to accumulation 53 of the given idea in the database 22.

In another such embodiment, as shown by line 55, viewing of a given accumulated idea in the database 22 is systematically enabled 23 only after an established period of time 57 subsequent to accumulation 53 of the given idea in the database 22.

In still another such embodiment, as shown by line 59, viewing of a given accumulated idea in the database 22 is systematically enabled 23 immediately subsequent to filing a patent application 61 for an invention derived at least in part from the given accumulated idea.

In a further embodiment, as shown by line 63, viewing of a given accumulated idea in the database 22 is systematically enabled 23 only after an established period of time 65 subsequent to the filing a patent application 61 for an invention derived at least in part from the given accumulated idea.

The respective established periods of time subsequent to accumulation of the given idea 57, and subsequent to filing of a patent application 65 may be different per se and may be different with respect to enablement of viewing by persons whom have entered into such a membership and enablement of viewing by persons whom have not entered into such a membership.

Referring to FIG. 1C, the computer system 21 is programmed to systematically communicate online individually to computers 27 of persons, whom have entered into a membership as a prerequisite for contributing ideas to the computer database 22 and/or for viewing the ideas accumulated in the database 22, a listing 70 of ideas viewed from the database by said persons, a listing 72 of groups that include ideas viewed from the database by such persons; and/or a listing 74 of ideas contributed to the database by such persons.

The computer system 21 is programmed to enable ideas contributed by one or different contributors to the database 22 to be integrated within the database 22 to thereby facilitate derivation of inventions 24 from the integrated ideas, as indicated at 34 in FIG. 1. For example, a first idea 31 contributed by a first member using the computer 27a is integrated with a second idea 32 contributed by a second member using the computer 27b to provide an integrated idea of a prospectively patentable invention 24. In another example, ideas contributed from the same computer by one or different contributors are integrated within the database 22.

In certain embodiments, the related ideas that are processed to provide an integrated idea include problems and solutions. In certain embodiments, an integrated idea is organized in the database as shown in FIG. 2 by providing access links between a problem idea (square) and one or more solution ideas (circle), and access links between a solution idea and one or more problem ideas, but generally not between a plurality of problem ideas or between a plurality of solution ideas. In an exemplary embodiment, three solution ideas 2, 3, 6 have been contributed in response to contribution of an initial problem idea 1; two problem ideas 4, 5 have been contributed in response to contribution of both of the solution ideas 2, 3, a solution idea 6 has been contributed in response to both of the problem ideas 1, 5; two problem ideas 7, 9 have been contributed in response to contribution of the solution idea 6; a solution idea 8 has been contributed in response to the problem idea 7; a problem idea 9 has been contributed in response to both of the solution ideas 6, 8; a solution idea 10 has been contributed in response to the problem idea 9; a problem idea 11 has been contributed in response to both of the solution ideas 8, 10; and a solution idea 12 has been contributed in response to the problem idea 11.

The idea contributions shown in FIG. 2 are described below in chronological order.

Problem Idea 1: Breaking Spectacles
Spectacle frames often break so that a lens will not adhere to the frame and the frame may twist out of shape and not tack on to the head. The spectacle user often is dependent on only one set of spectacles and it may take a week before they can have new frame or spectacles or have the old frame fixed. Is there a simple way for an ordinary person to temporarily fix her glasses?

Solution Idea 2: Use Glue
Glue the frame together with super glue.

Solution Idea 3: Use Glue
Glue the frame to the glass and buy new spectacles.

Problem Idea 4: Glue Doesn't Work
I have tried gluing with all kinds of glue but nothing has worked.

Problem Idea 5: Glue Doesn't Work
Spectacle frames are made of glass and all kinds of plastics and all kinds of metals, it is not likely that any glue can be made which will glue all of these materials. See Reference “Fix It Yourself”

Solution Idea 6: Use Shrink Wrap Tubes
I have access to the “Co-Brain” software, which suggests the alternative “fasten with shrink-wrap” to “fasten with glue”. Maybe you could have a small tube of shrink-wrap in the shape of a soda-straw, fit the lens and spectacles together so that the thin and soft shrink-wrap fits over the broken section of the frame and put the spectacles in the micro-oven for shrinking.

Problem Idea 7: Tubes Don't Fit
The soda straw solution will only work for some lucky cases. Most often the spectacle frame breaks near the arch or the ear attachment and the soda straw solution will not work because the tube will only fit on one side of the broken frame.

Solution Idea 8: Shrink Wrap Entire Frame
(1) Make a larger tube of shrink wrap with a diameter about the size of the frame around the lens, (2) Cut a thin sliver from the end of the tube with scissors in the form of a circular band, (3) Combine the spectacle parts and wrap the band around the broken frame around the lens, and (4) Use a hair dryer or other means to heat the combination.

Problem Idea 9: Lacks Appeal
The color of the shrink-wrap could in some cases look very ugly.

Solution Idea 10: Clear Choice
The shrink-wrap should be transparent.

Problem Idea 11: Unsuitable Plastic
Some shrink-wraps would not be suitable because they are not elastic enough for the fit of the circular band around the broken frame around the lens.

Solution Idea 12: Suitable Plastic
A suitable plastic can be bought from “Doww Chemicals” and is called Chemical X.

Reference: “Doww Plastic Facts”

In certain embodiments, the idea manager provides a website from which the computer database of ideas can be accessed for viewing and/or for entry of ideas into the computer database, where access to the database usually is over the Internet. A display of the website provides a menu from which a user may select listings of (a) titles of the most recently contributed ideas; (b) titles of ideas that have received the most hits by users accessing the database; (c) integrated ideas combining the greatest number of prior ideas (such as the individual files respectively providing reference to the greatest number of files that are related either directly or indirectly to the identification code of another idea in the database); (d) the most recent integrated ideas (e) the identification codes of the contributors whom have supplied the most ideas to the database; and (f) the identification codes of the contributors whom have supplied the most ideas to the database for which rights have been provided/transferred. Such listings include links for accessing the ideas listed therein. Users can register for being notified by email of new entries of ideas having selected key words in the idea title and/or text; and such users are then so notified. The email notification includes a link to the new entry in the database.

A contributor enters an idea by text and/or attachment entry and/or by using software downloaded from the idea manager's website, or otherwise provided by the idea manager (such as in a CD), to enter drawings.

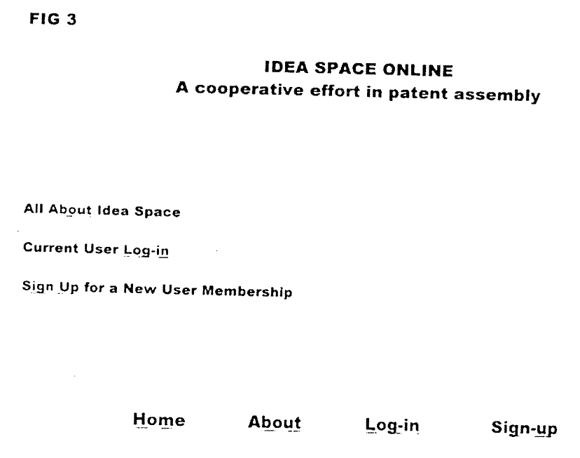

In an exemplary embodiment, the website is named “Idea Space”. Example display screens that are provided to a user of the idea database are shown in FIGS. 3 through 54. The underlined portions of the various display screens provide links to either other display screens or to other portions of the display screen then being displayed.

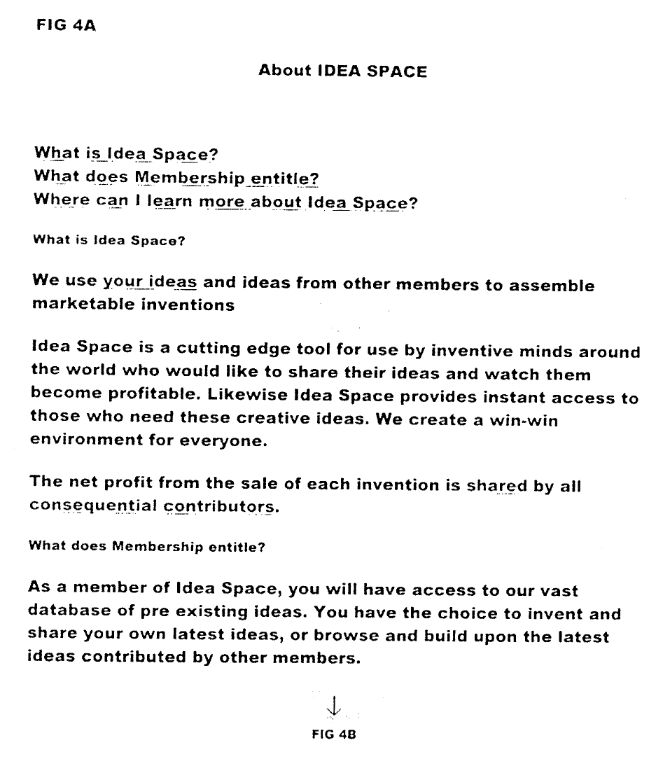

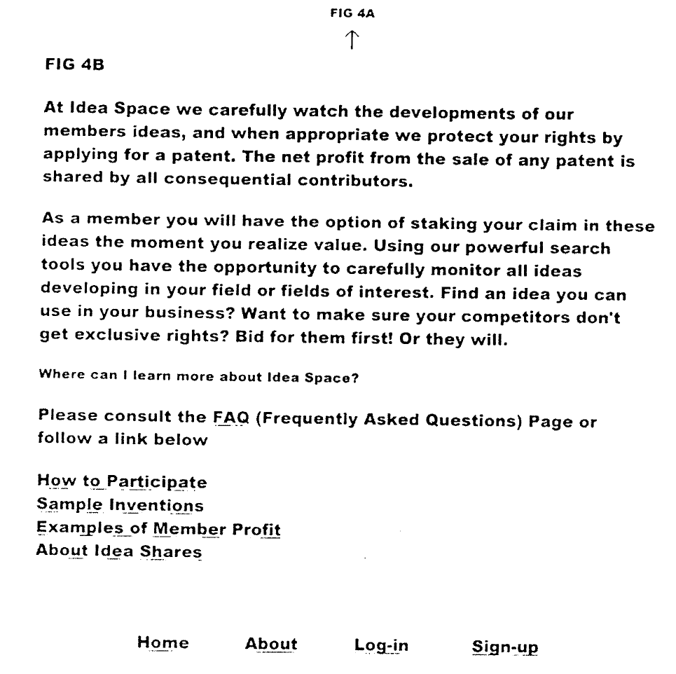

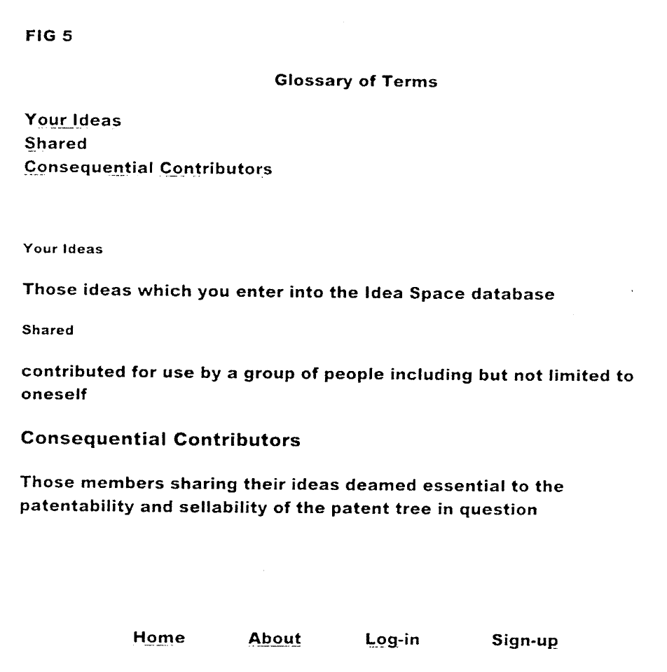

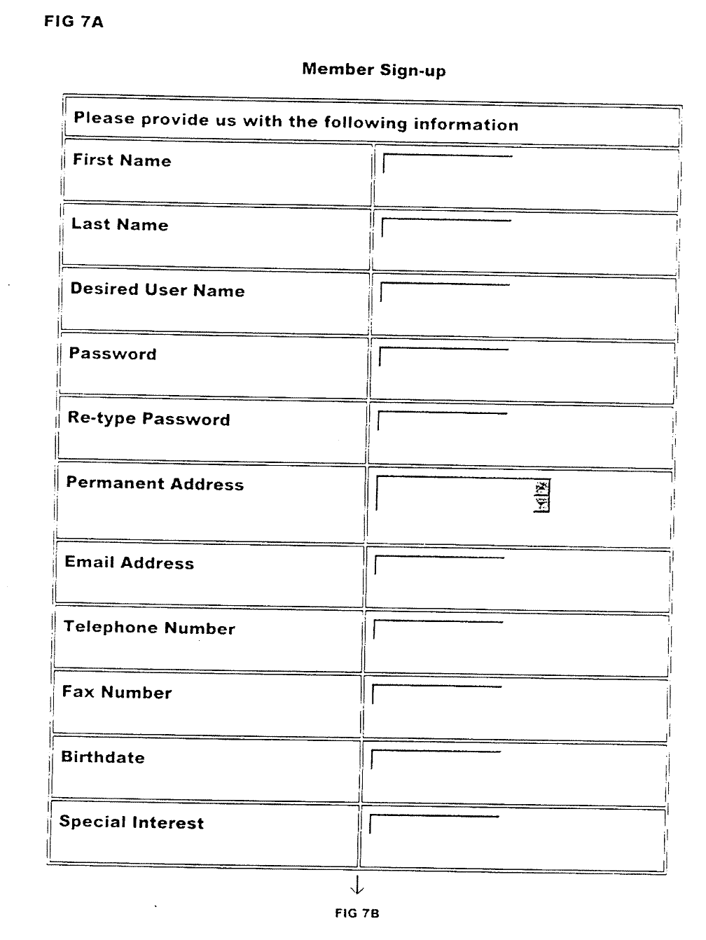

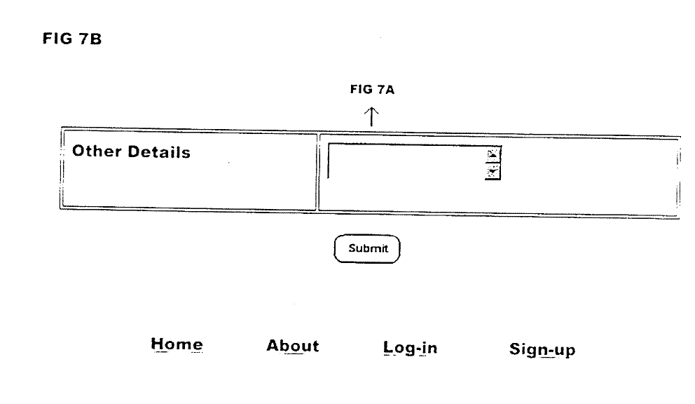

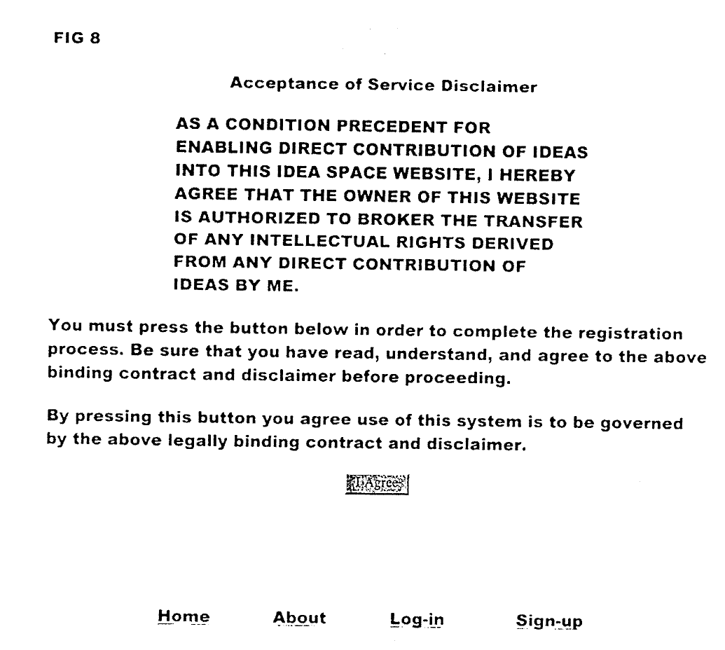

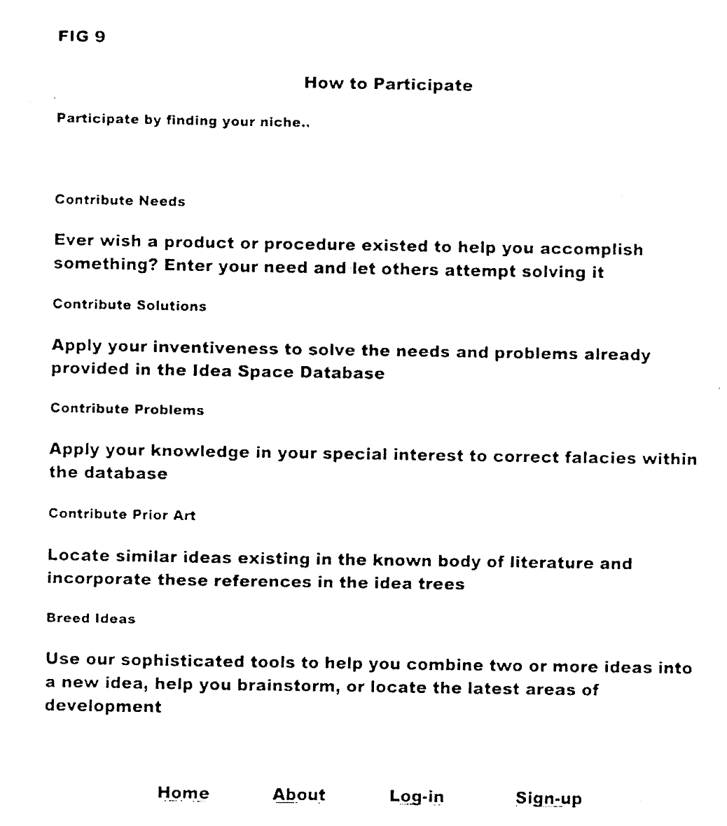

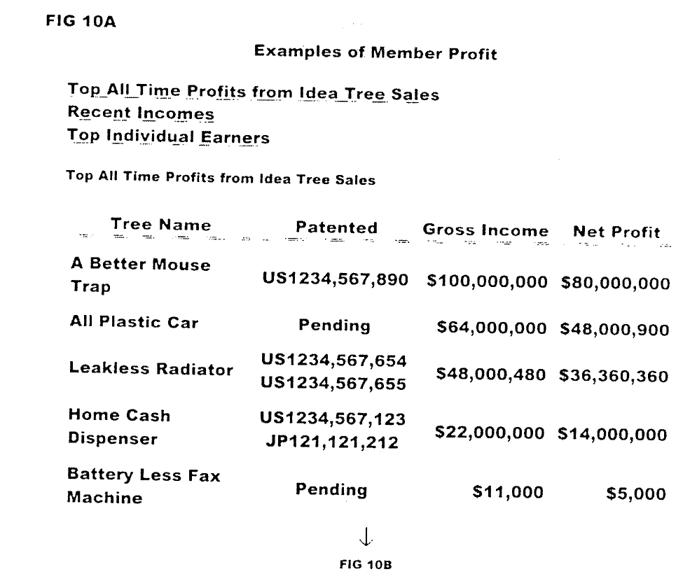

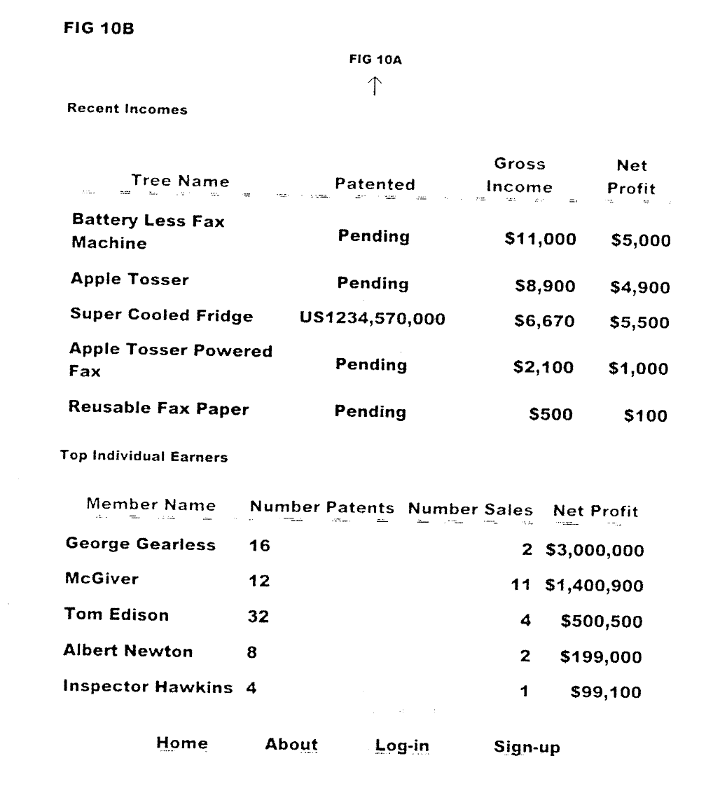

The screen display of the home page of the example website is shown in FIG. 3. The home page provides links to the screen displays shown in FIGS. 4, 6 and 7. The underlined text in the “What is Idea Space” section of the “About Idea Space” screen display of FIG. 3 provides links to definitions of the respective underlined text in a “Glossary of Terms” screen display shown in FIG. 5. The “Submit” button at the bottom of the “Member Sign-up” display screen of FIG. 7 provides a link to the “Acceptance . . . ” display screen shown in FIG. 8. Links to the “How to Participate” display screen of FIG. 9 and the “Examples of Member Profit” display screen of FIG. 10 are provided near the bottom of the “About Idea Space” display screen of FIG. 4.

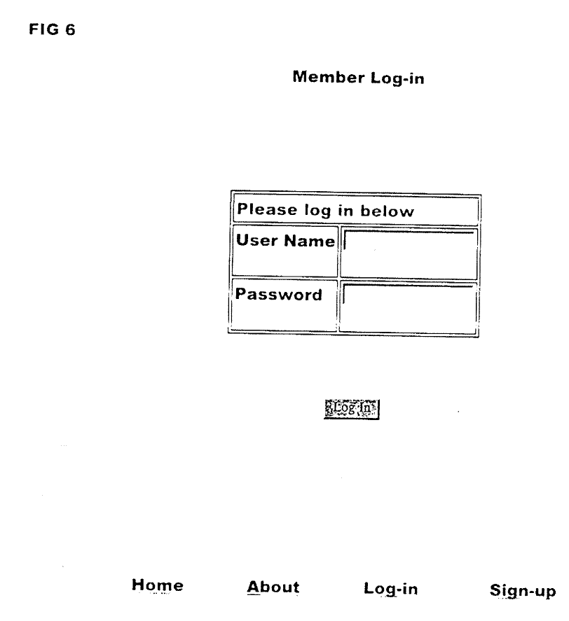

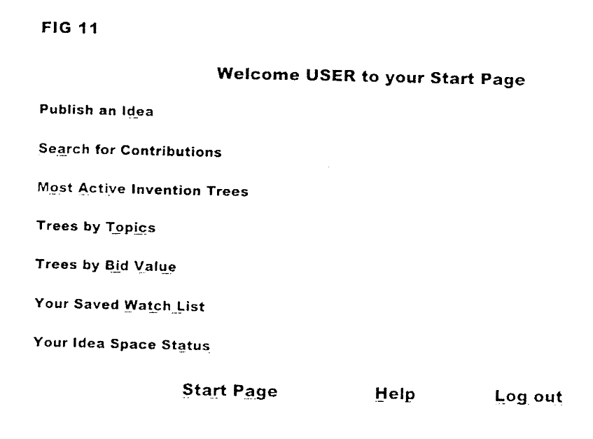

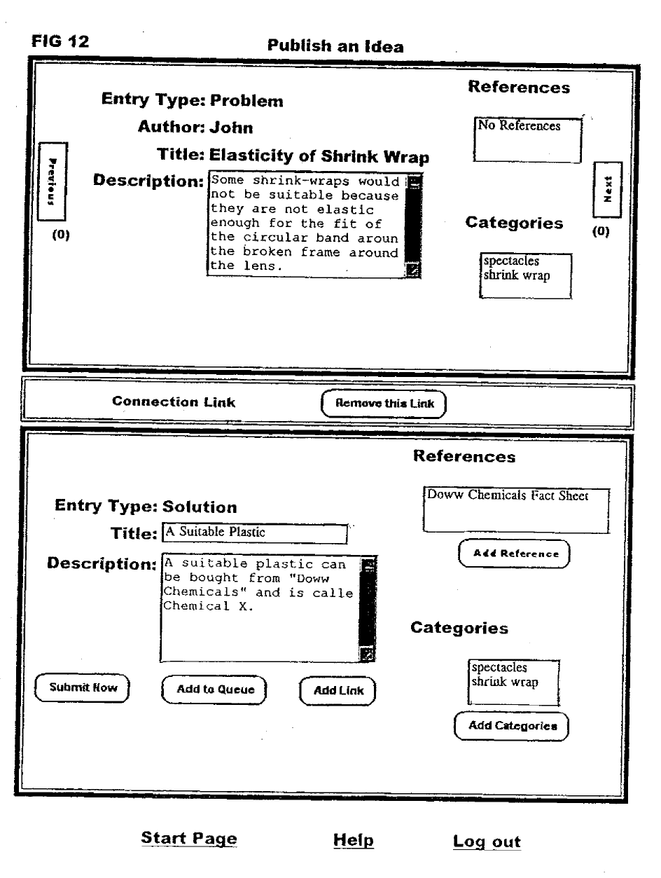

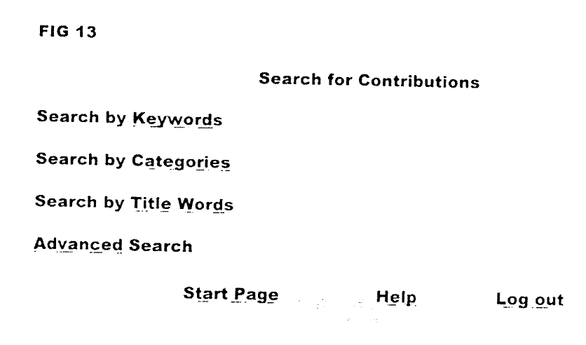

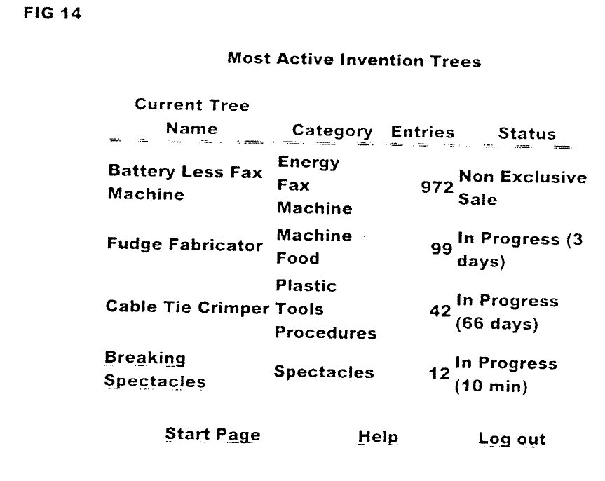

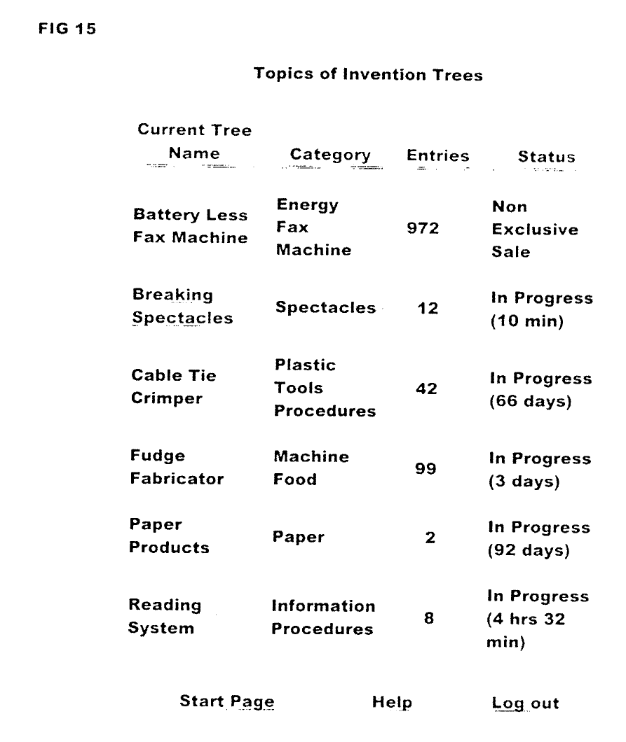

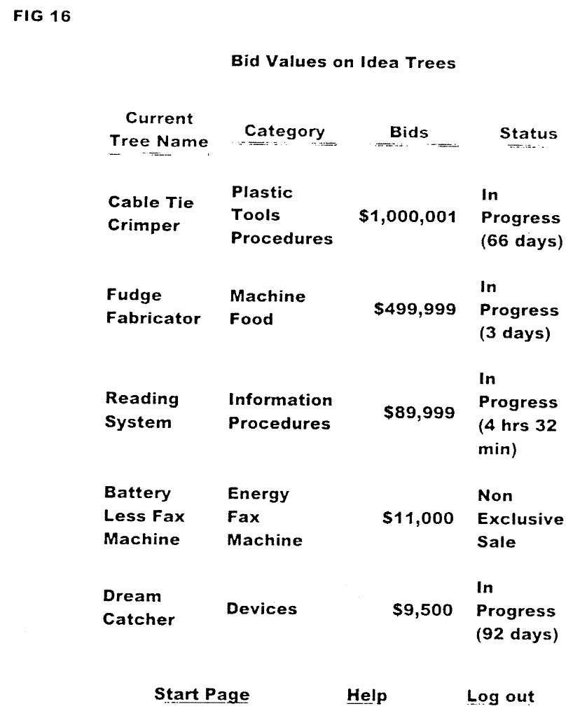

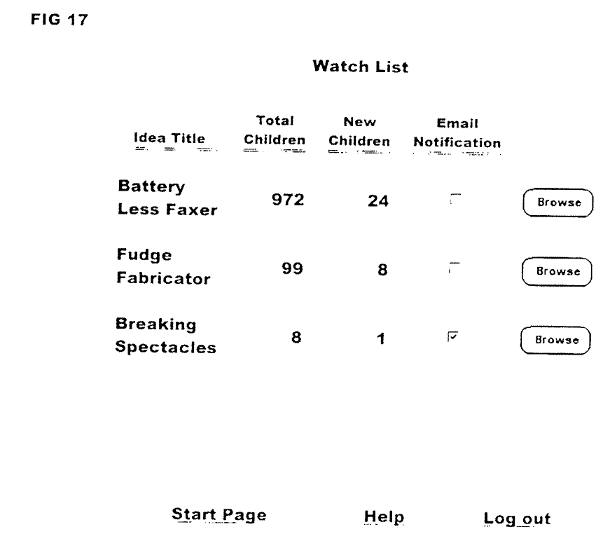

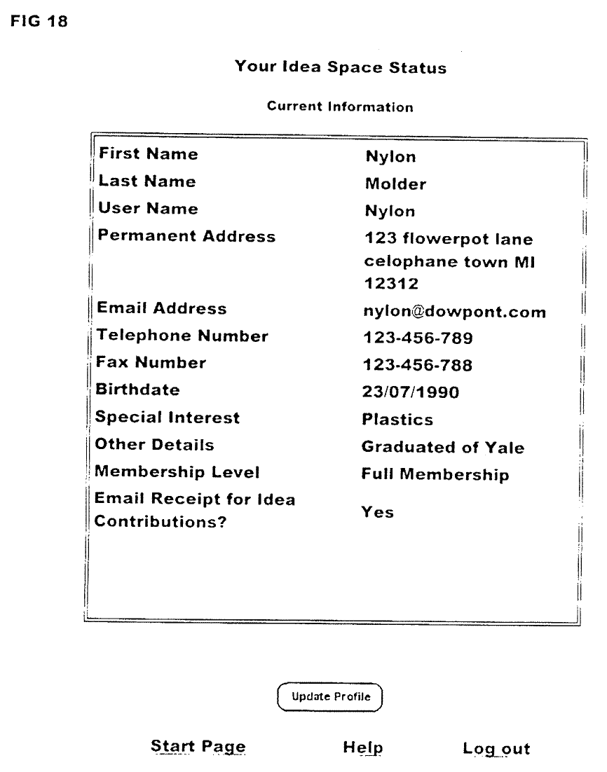

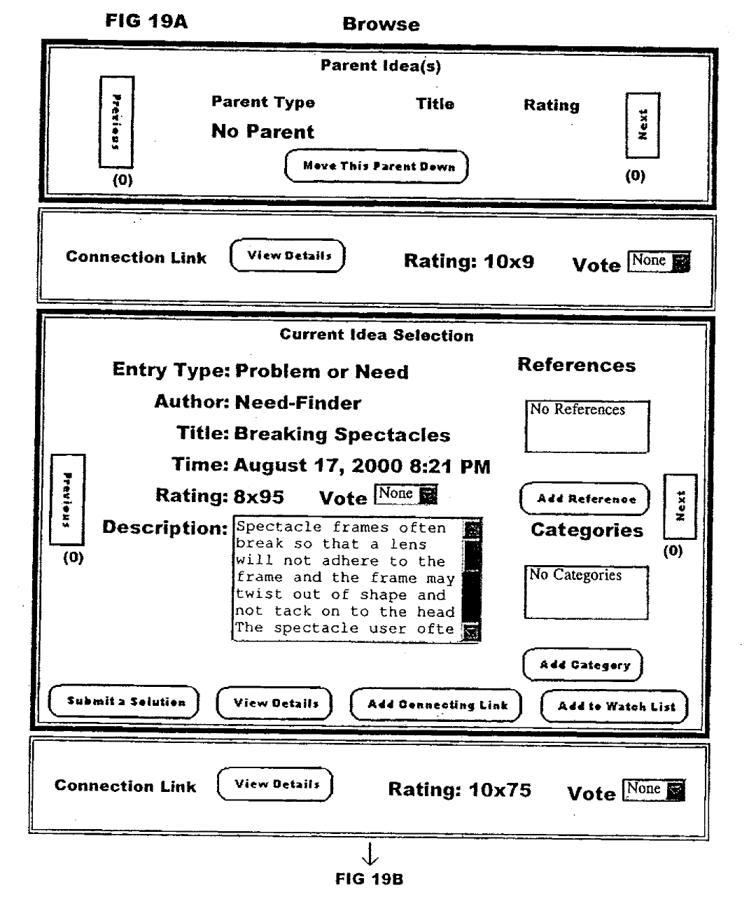

A link to the Start Page screen display of FIG. 11 is provided by the “log in” button on the Member Log-in screen display of FIG. 6. Referring to the Start Page screen display, clicking the “Publish an Idea” link provides the screen display of FIG. 12; clicking the “Search for Contributions” link provides the screen display of FIG. 13; clicking the “Most Active Invention Trees” link provides the screen display of FIG. 14; clicking the “Trees by Topics” link provides the screen display of FIG. 15; clicking the “Trees by Bid Value” link provides the screen display of FIG. 16; clicking the “Your Saved Watch List” link provides the screen display of FIG. 17; and clicking the “Your Idea Space Status” link provides the screen display of FIG. 18.

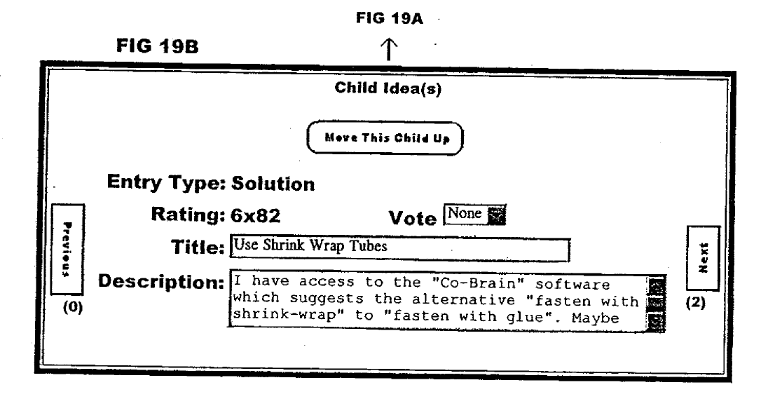

Upon displaying the “Topics of Invention Trees” screen display of FIG. 15, a user can select and browse prior contributions that have been published in the database. The “Breaking Spectacles” link provides access to the exemplary integrated idea described above with reference to FIG. 2, beginning with the screen display of FIG. 19. The format of the screen display for a selected idea (as shown in FIGS. 19-42) includes a “Current Idea Selection” section, a Parent section, a “Child Idea(s)” section, a first “Connection Link” section between the Parent section and the Current Idea Selection section, and a second “Connection Link” section between the Child Idea(s) section and the Current Selection section.

The Current Idea Selection section contains a Description of the selected idea and a Vote window and lists the Entry Type of the selected idea, such as “Problem or Need” or “Solution”; the Author (contributor) of the selected idea, the Title of the selected idea, the Time of publication of the selected idea, a Rating of the appropriateness of the selected idea, any References related to the selected idea, and any Categories related to the selected idea. The Current Idea Selection section also includes Previous and Next buttons for accessing other contributed ideas that are linked to the same parent idea as the selected idea. The quantity of any such other linked contributed ideas are indicated beneath the Previous and Next buttons.

The Parent section contains a Vote window and lists the Type of the linked parent idea, such as “Problem or Need” or “Solution”; the Title of the linked parent idea, and, a Rating of the appropriateness of the linked parent idea. The Parent section also includes Previous and Next buttons for accessing other contributed parent ideas that are linked to the selected idea, and indicates the quantity of any such other linked contributed parent ideas.

The Child Idea(s) section contains a Description of the linked child idea and a Vote window and lists the Entry Type of the linked child idea, such as “Problem or Need” or “Solution”; the Title of the selected idea, and a Rating of the appropriateness of the linked child idea. The Child Idea(s) section also includes Previous and Next buttons for accessing other contributed child ideas that are linked to the selected idea, and indicates the quantity of any such other linked contributed child ideas.

The ratings are provided in response to averaging (or processing by some other formula) the votes by users of the database. Voting is accomplished by selecting a number within a range of 0 to 10 from a drop-down menu displayed by clicking the down-arrow in the Vote window. The listed rating shows the average (or other) rating and the number of voters. Ratings are also listed in the two “Connection Link” sections for the appropriateness of the respective links between the selected idea and either the idea in the Parent section or the idea in the Child Idea(s) section. The ratings provide a user of the database with an immediate indication of the appropriateness of the rated idea or connection link, as voted by other users.

In the screen display of FIG. 19, the selected idea described in the Current Idea Selection section is Problem Idea 1, and the child idea described in the Child Idea(s) section is Solution Idea 6, as described above with reference to FIG. 2. In the Child Idea(s) section, the “(2)” indication beneath the Next button indicates that there are two other child ideas linked to selected Problem Idea 1.

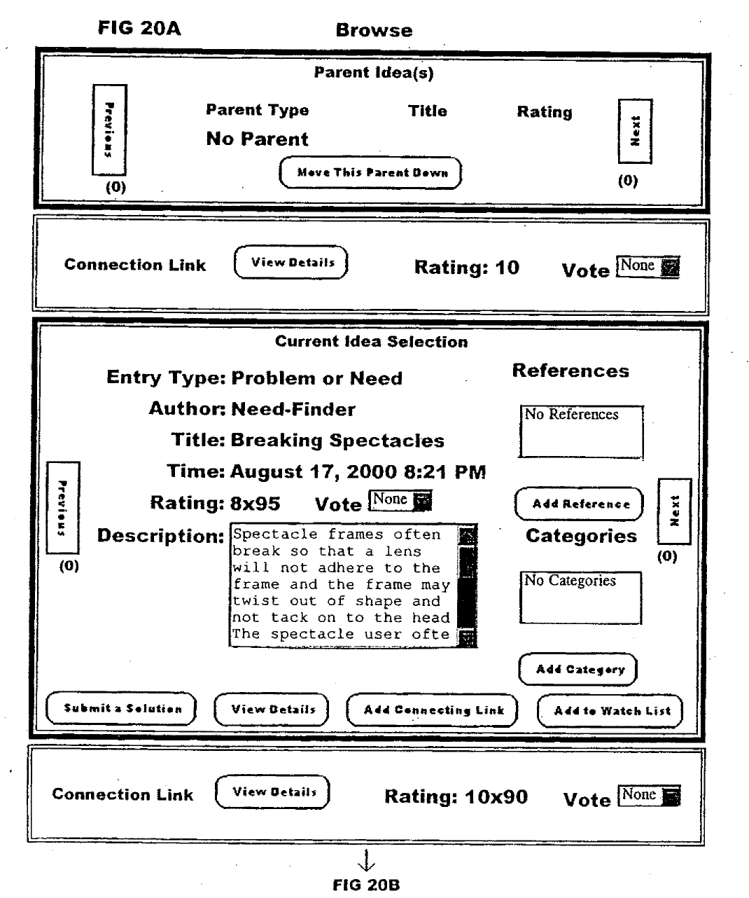

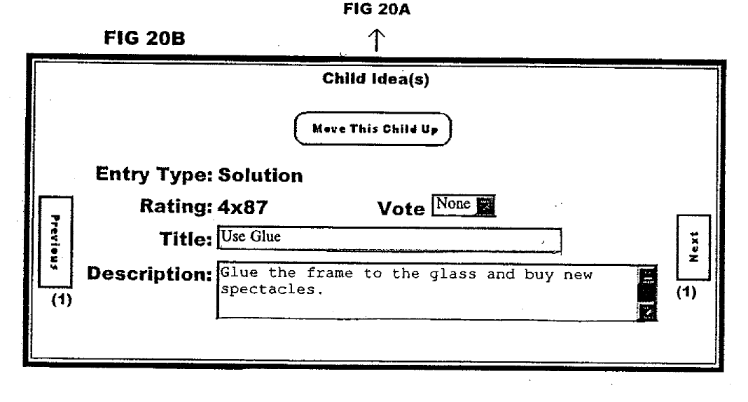

Clicking the Next button in the Child Idea(s) section of the screen display of FIG. 19 provides access to the screen display of FIG. 20, wherein the selected idea described in the Current Idea Selection section is Problem Idea 1, and the child idea described in the Child Idea(s) section is Solution Idea 3, as described above with reference to FIG. 2.

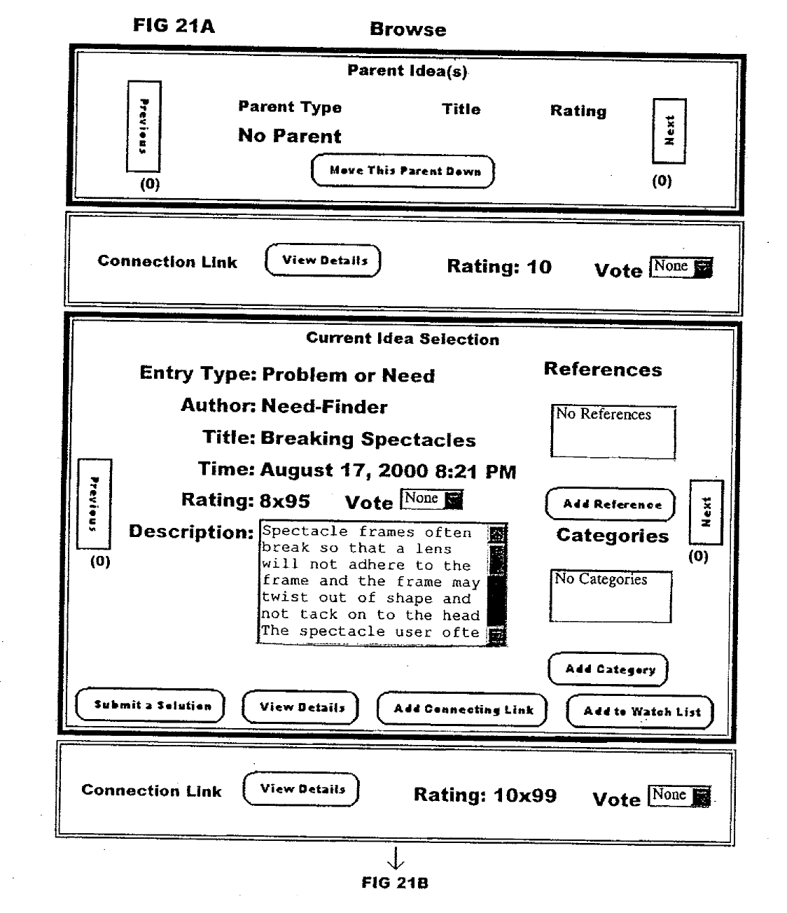

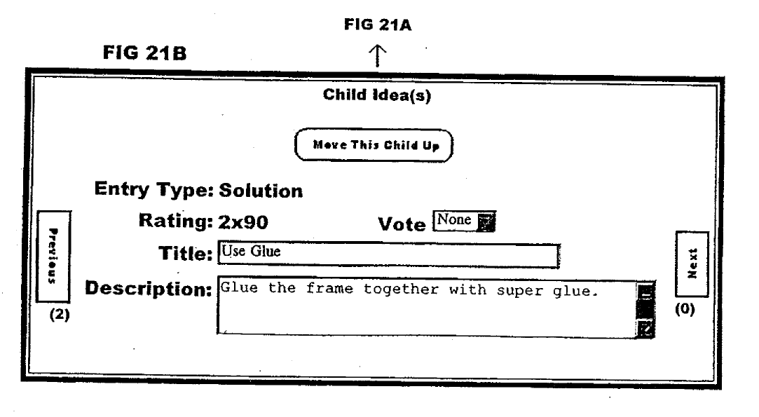

Clicking the Next button in the Child Idea(s) section of the screen display of FIG. 20 provides access to the screen display of FIG. 21, wherein the selected idea described in the Current Idea Selection section is Problem Idea 1, and the child idea described in the Child Idea(s) section is Solution Idea 2, as described above with reference to FIG. 2.

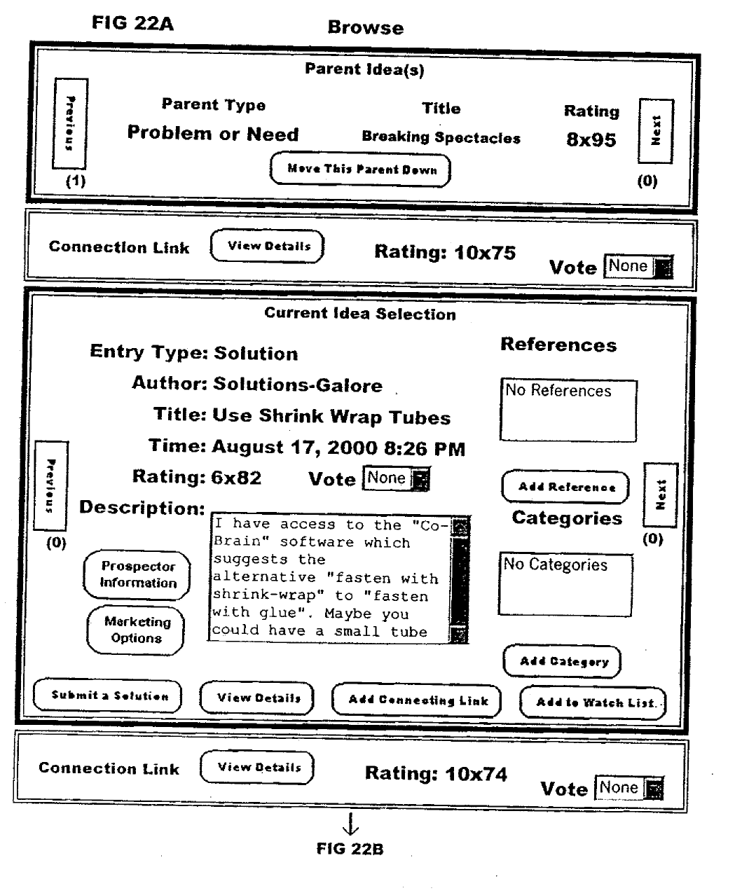

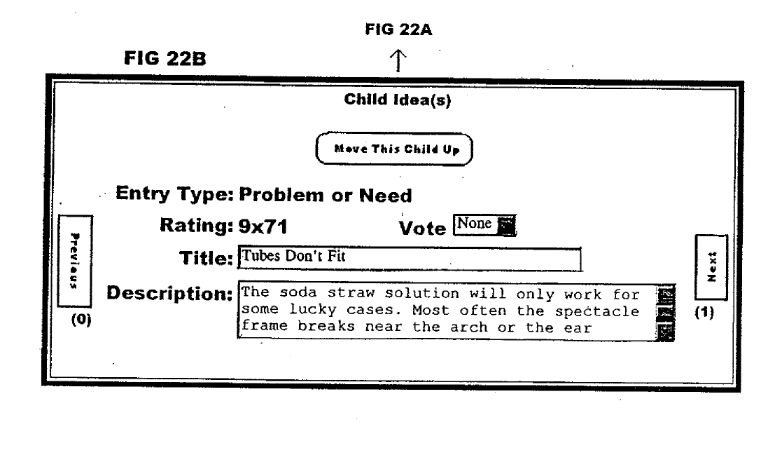

After returning to the initial screen display of FIG. 19, a screen display (as shown in FIG. 22), in which the child idea in the Child Idea(s) section of the screen display of FIG. 19 is displayed as the selected idea in the Current Idea Selection section, is accessed by clicking the “Move This Child Up” button in the Child Idea(s) section, in the screen display of FIG. 19.

In the screen display of FIG. 22, the selected idea described in the Current Idea Selection section is Solution Idea 6, the parent idea listed in the Parent section is Problem Idea 1, and the child idea described in the Child Idea(s) section is Problem Idea 7, as described above with reference to FIG. 2. In the Child Idea(s) section, the “(1)” indication beneath the Next button indicates that there is one other child idea linked to selected Solution Idea 6.

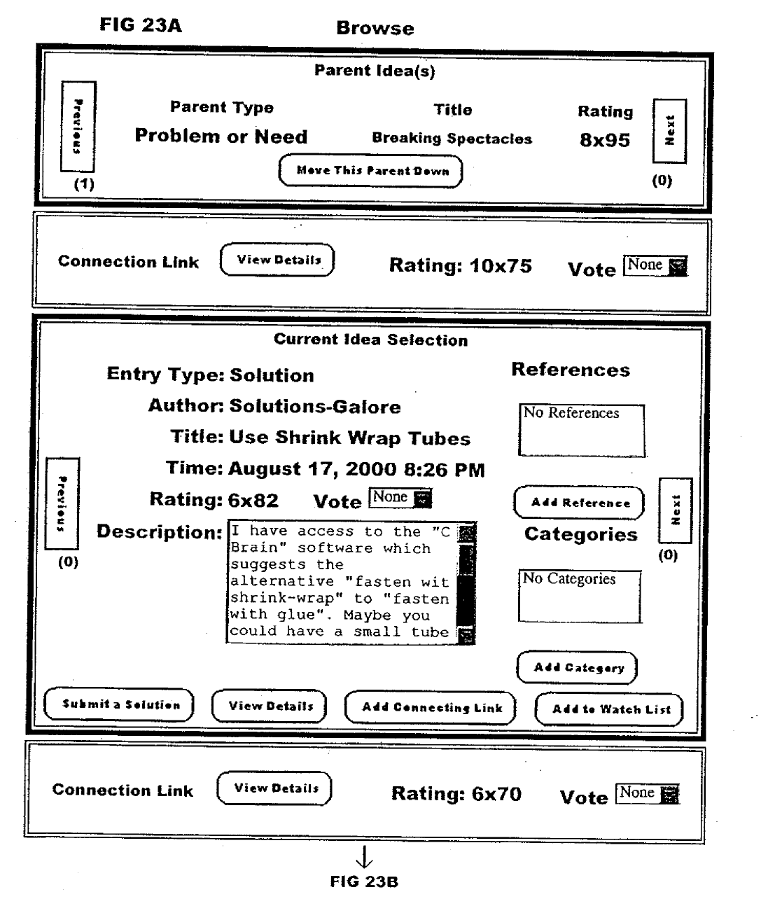

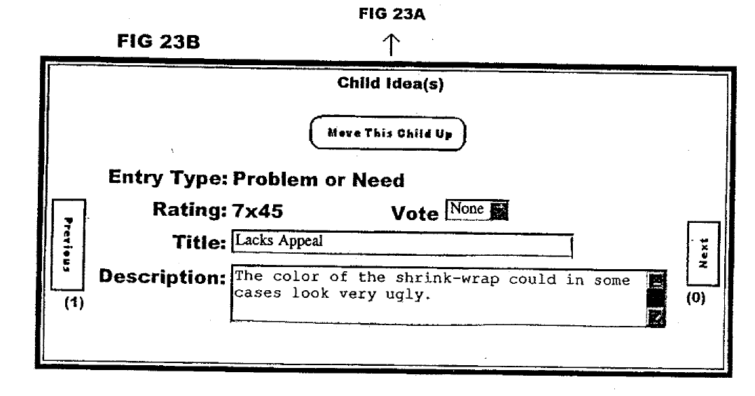

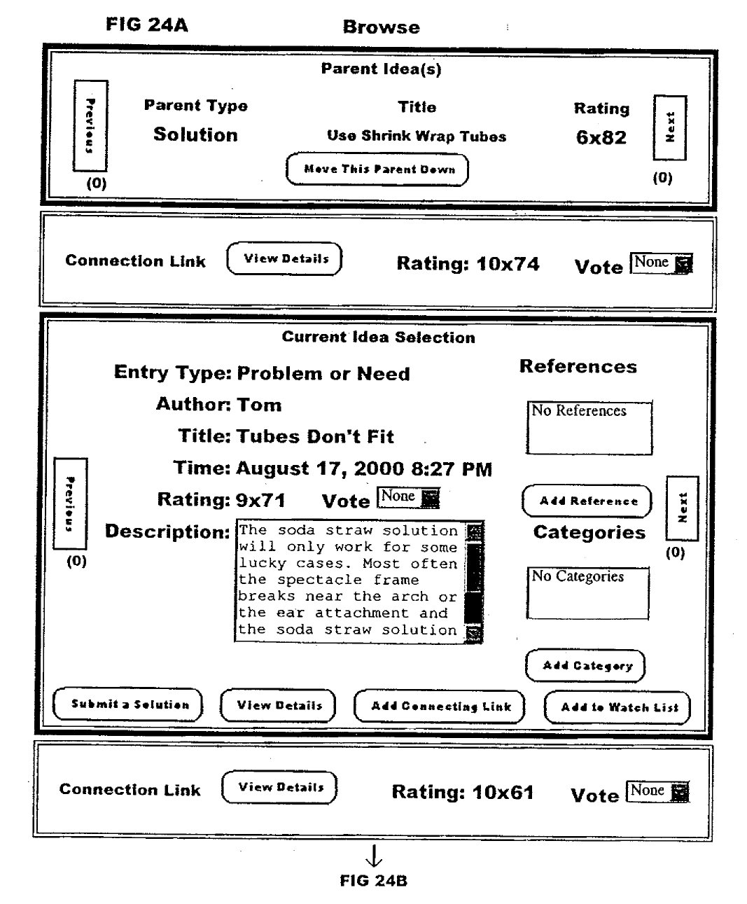

Clicking the Next button in the Child Idea(s) section of the screen display of FIG. 22 provides access to the screen display of FIG. 23, wherein the selected idea described in the Current Idea Selection section is Solution Idea 6, the parent idea listed in the Parent section is Problem Idea 1, and the child idea described in the Child Idea(s) section is Problem Idea 9, as described above with reference to FIG. 2.

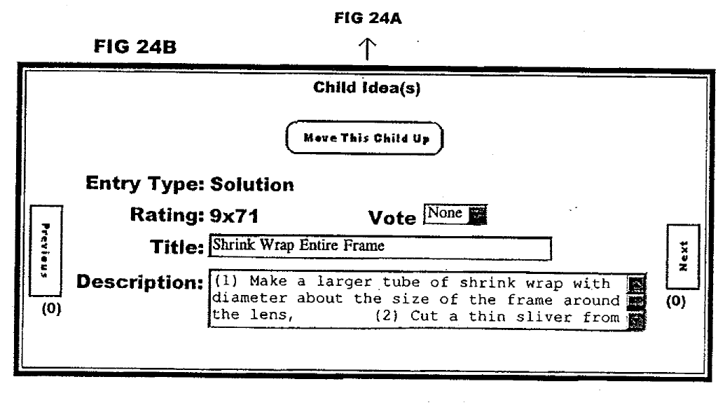

After returning to the screen display of FIG. 22, a screen display (as shown in FIG. 24), in which the child idea in the Child Idea(s) section of the screen display of FIG. 22 is displayed as the selected idea in the Current Idea Selection section, is accessed by clicking the “Move This Child Up” button in the Child Idea(s) section, in the screen display of FIG. 22.

In the screen display of FIG. 24, the selected idea described in the Current Idea Selection section is Problem Idea 7, the parent idea listed in the Parent section is Solution Idea 6, and the child idea described in the Child Idea(s) section is Solution Idea 8, as described above with reference to FIG. 2. In the Child Idea(s) section, the “(0)” indication beneath the Next button indicates that there are no other child ideas linked to selected Problem Idea 7.

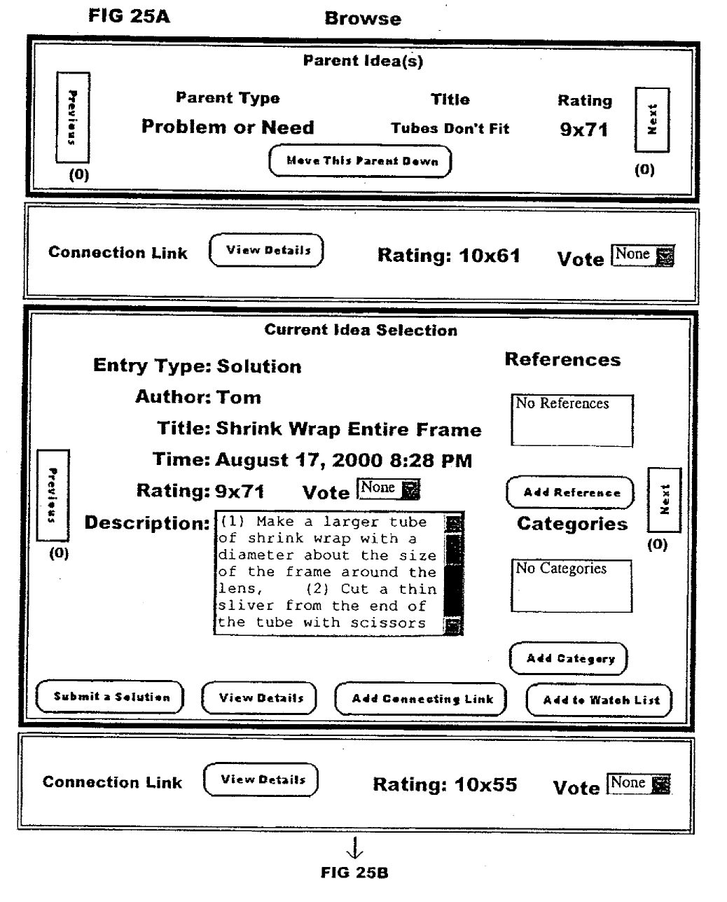

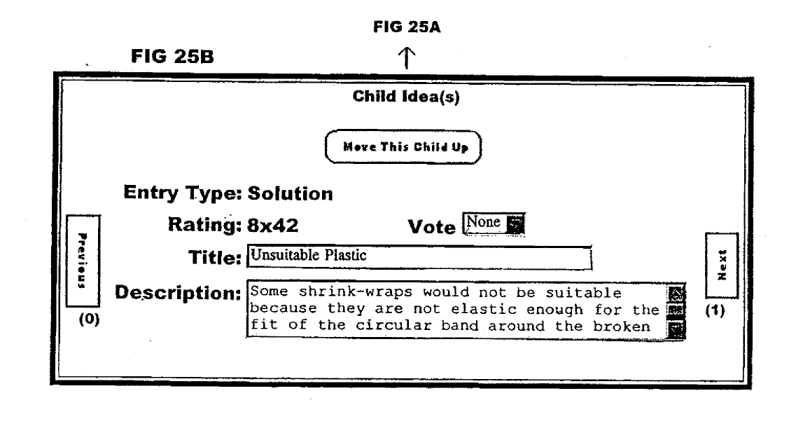

A screen display (as shown in FIG. 25), in which the child idea in the Child Idea(s) section of the screen display of FIG. 24 is displayed as the selected idea in the Current Idea Selection section, is accessed by clicking the “Move This Child Up” button in the Child Idea(s) section, in the screen display of FIG. 24.

In the screen display of FIG. 25, the selected idea described in the Current Idea Selection section is Solution Idea 8, the parent idea listed in the Parent section is Problem Idea 7, and the child idea described in the Child Idea(s) section is Problem Idea 11, as described above with reference to FIG. 2. In the Child Idea(s) section, the “(1)” indication beneath the Next button indicates that there is one other child idea linked to selected Solution Idea 8.

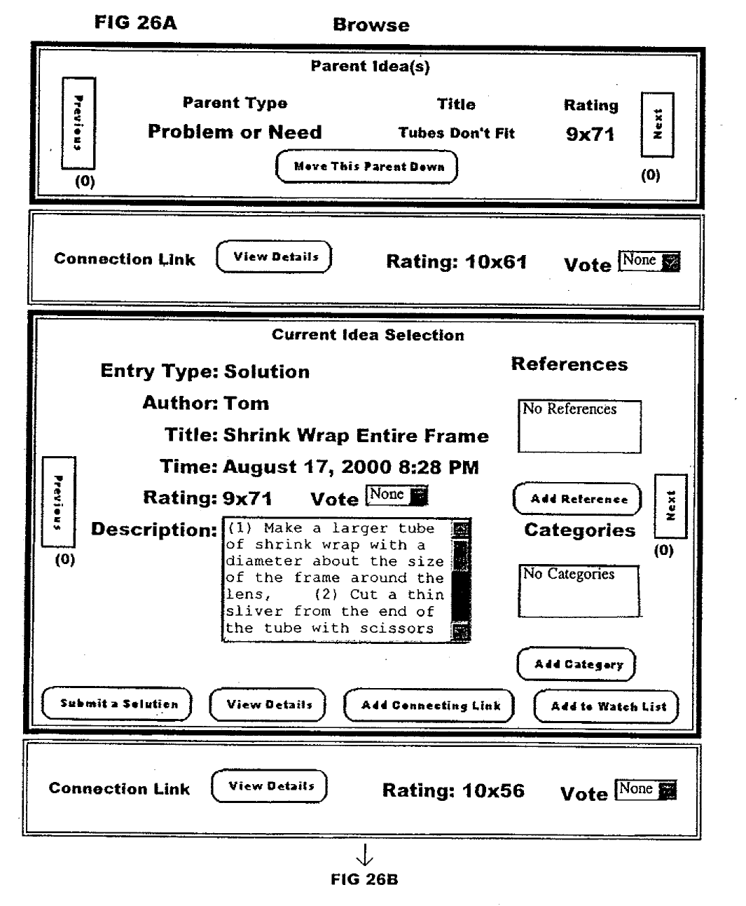

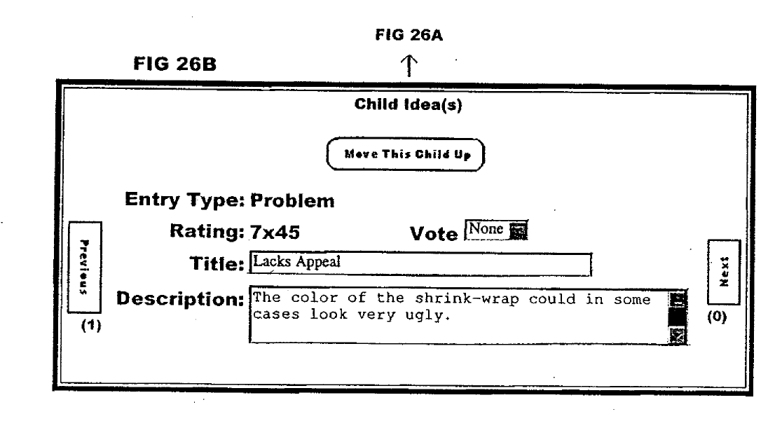

Clicking the Next button in the Child Idea(s) section of the screen display of FIG. 25 provides access to the screen display of FIG. 26, wherein the selected idea described in the Current Idea Selection section is Solution Idea 8, the parent idea listed in the Parent section is Problem Idea 7, and the child idea described in the Child Idea(s) section is Problem Idea 9, as described above with reference to FIG. 2.

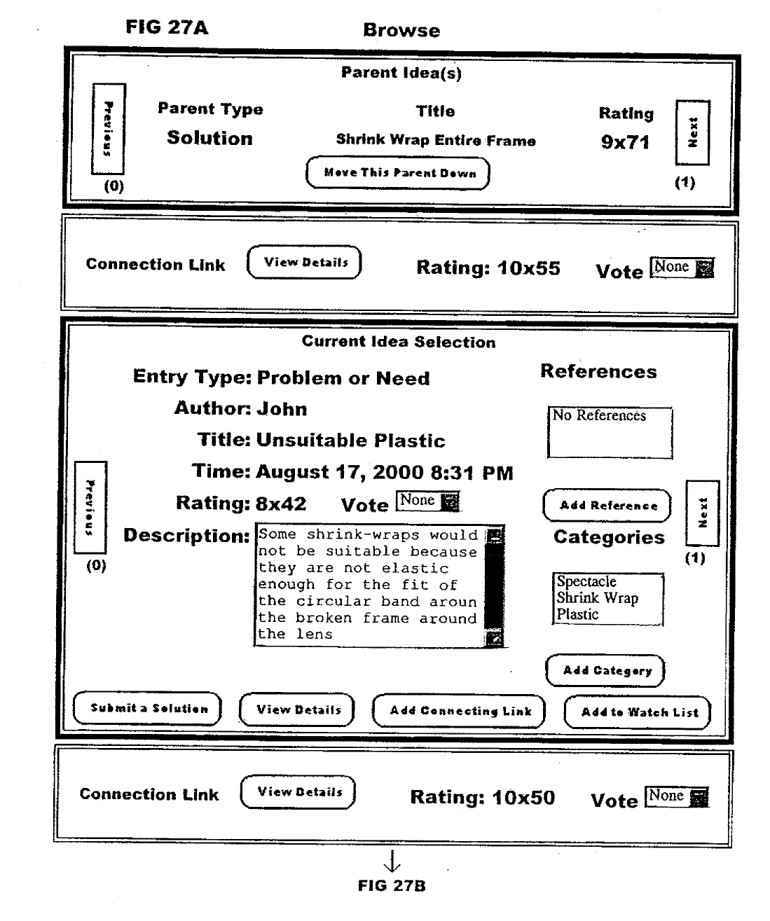

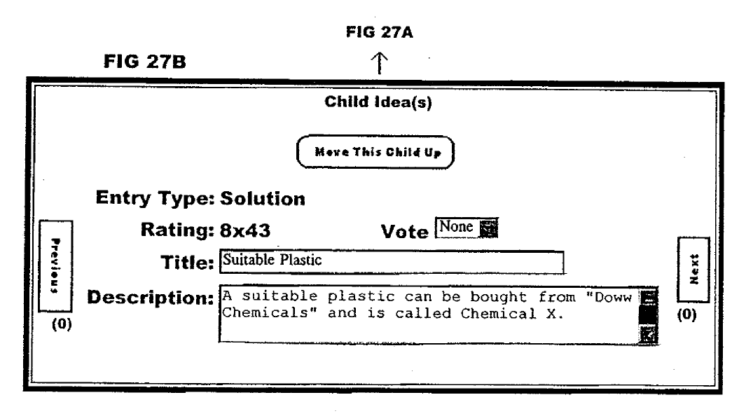

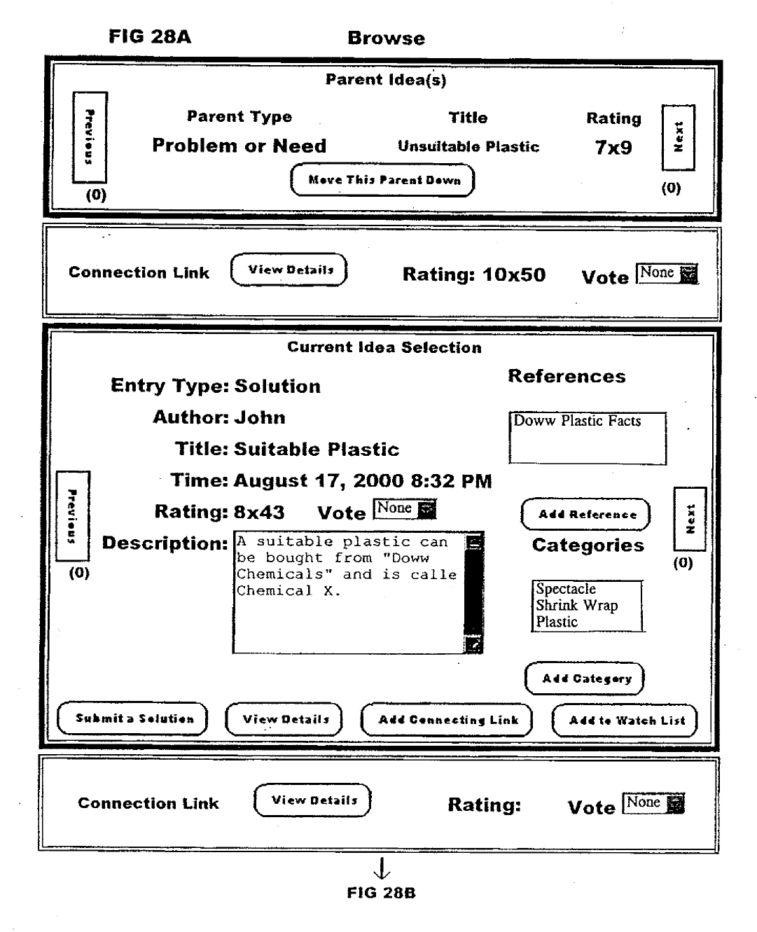

After returning to the screen display of FIG. 25, a screen display (as shown in FIG. 27), in which the child idea in the Child Idea(s) section of the screen display of FIG. 25 is displayed as the selected idea in the Current Idea Selection section, is accessed by clicking the “Move This Child Up” button in the Child Idea(s) section, in the screen display of FIG. 25.

In the screen display of FIG. 27, the selected idea described in the Current Idea Selection section is Problem Idea 11, the parent idea listed in the Parent section is Solution Idea 8, and the child idea described in the Child Idea(s) section is Solution Idea 12, as described above with reference to FIG. 2. In the Child Idea(s) section, the “(0)” indication beneath the Next button indicates that there are no other child ideas linked to selected Problem Idea 11

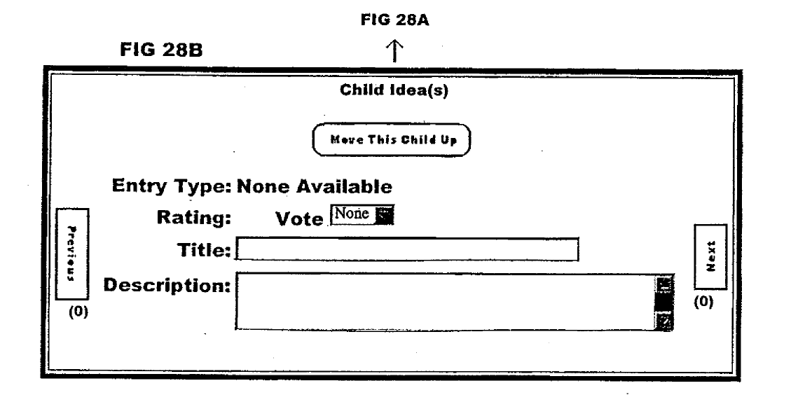

A screen display (as shown in FIG. 28), in which the child idea in the Child Idea(s) section of the screen display of FIG. 27 is displayed as the selected idea in the Current Idea Selection section, is accessed by clicking the “Move This Child Up” button in the Child Idea(s) section, in the screen display of FIG. 27.

In the screen display of FIG. 28, the selected idea described in the Current Idea Selection section is Solution Idea 12, the parent idea listed in the Parent section is Problem Idea 11, and no child idea described in the Child Idea(s) section.

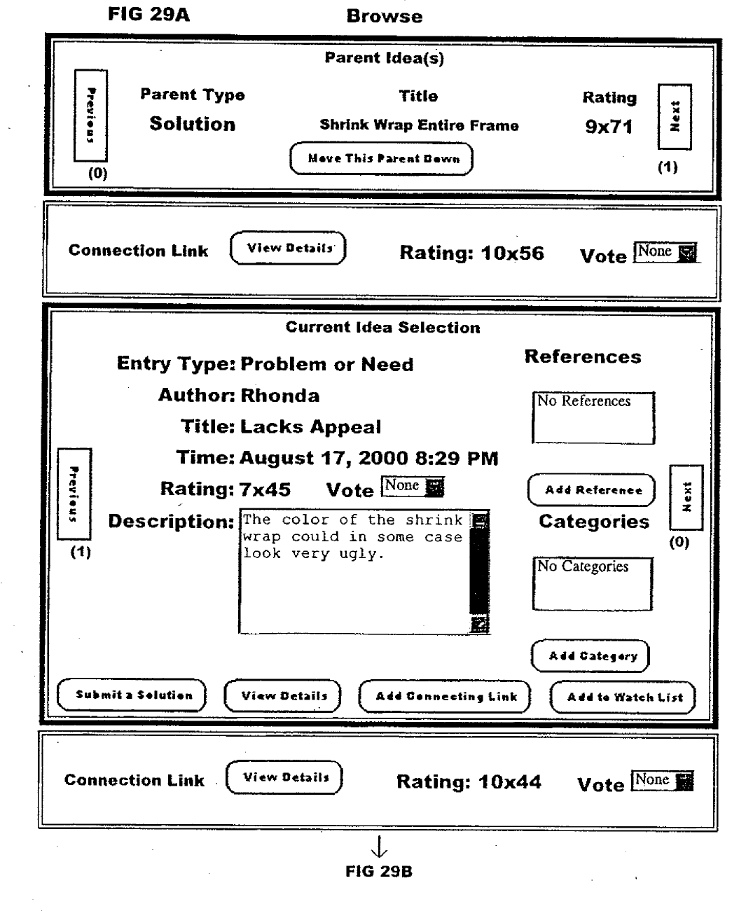

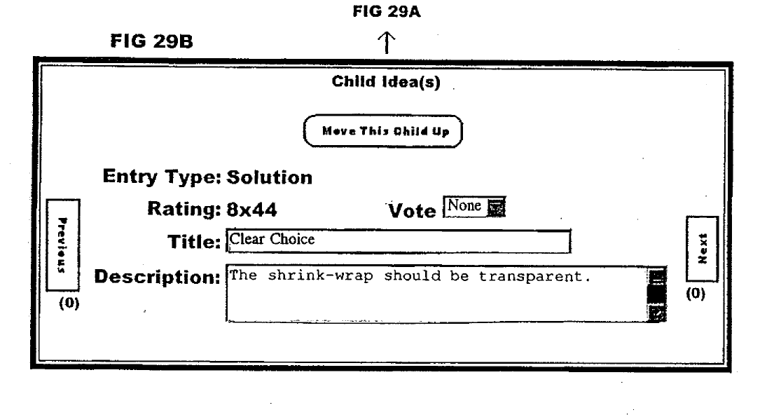

After returning to the screen display of FIG. 26, a screen display (as shown in FIG. 29), in which the child idea in the Child Idea(s) section of the screen display of FIG. 26 is displayed as the selected idea in the Current Idea Selection section, is accessed by clicking the “Move This Child Up” button in the Child Idea(s) section, in the screen display of FIG. 26.

In the screen display of FIG. 29, the selected idea described in the Current Idea Selection section is Problem Idea 9, the parent idea listed in the Parent section is Solution Idea 8, and the child idea described in the Child Idea(s) section is Solution Idea 10, as described above with reference to FIG. 2. In the Child Idea(s) section, the “(0)” indication beneath the Next button indicates that there are no other child ideas linked to selected Problem Idea 9. In the Parent section, the “(1)” indication beneath the Next button indicates that there is one other parent idea linked to selected Problem Idea 9.

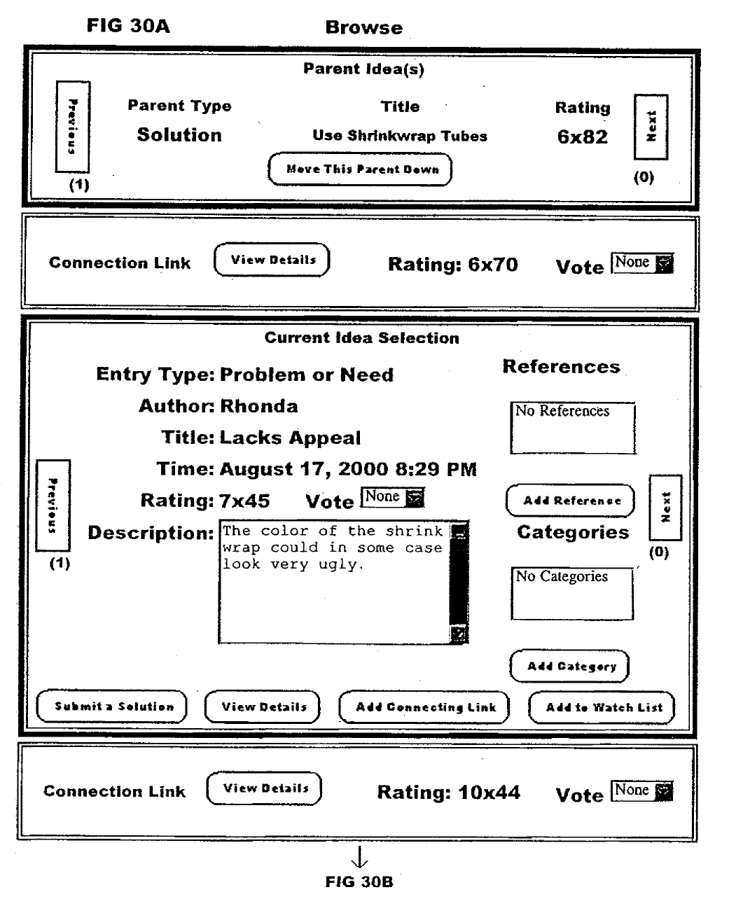

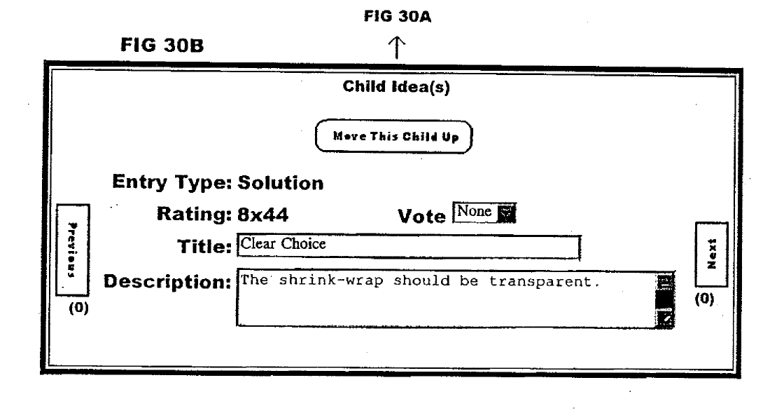

Clicking the Next button in the Parent section of the screen display of FIG. 29 provides access to the screen display of FIG. 30, wherein the selected idea described in the Current Idea Selection section is Problem Idea 9, the parent idea listed in the Parent section is Problem Idea 6, and the child idea described in the Child Idea(s) section is Solution Idea 10.

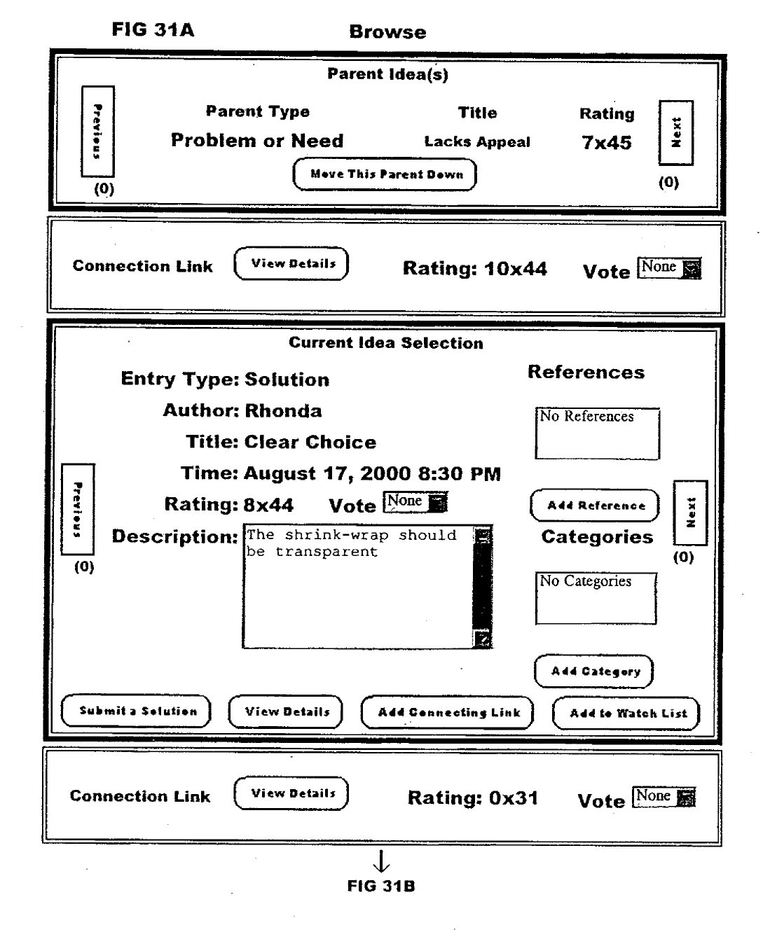

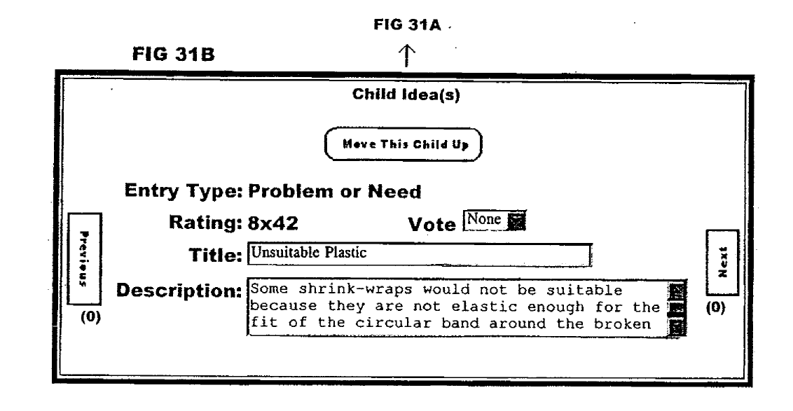

A screen display (as shown in FIG. 31), in which the child idea in the Child Idea(s) section of the screen display of FIG. 30 is displayed as the selected idea in the Current Idea Selection section, is accessed by clicking the “Move This Child Up” button in the Child Idea(s) section, in the screen display of FIG. 30.

In the screen display of FIG. 31, the selected idea described in the Current Idea Selection section is Solution Idea 10, the parent idea listed in the Parent section is Problem Idea 9, and the child idea described in the Child Idea(s) section is Problem Idea 11.

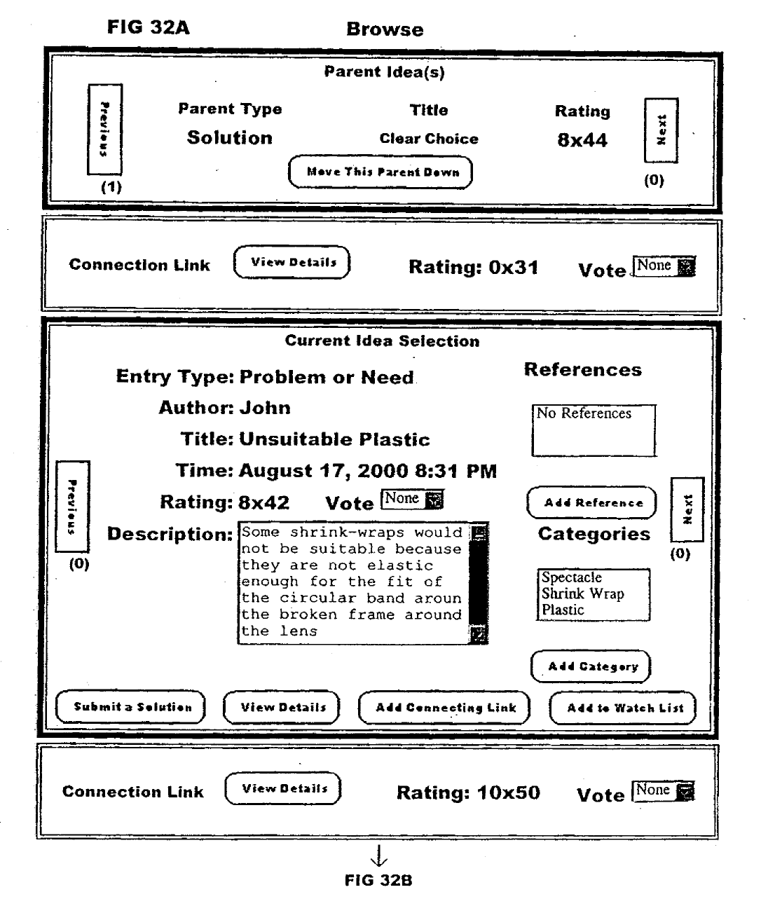

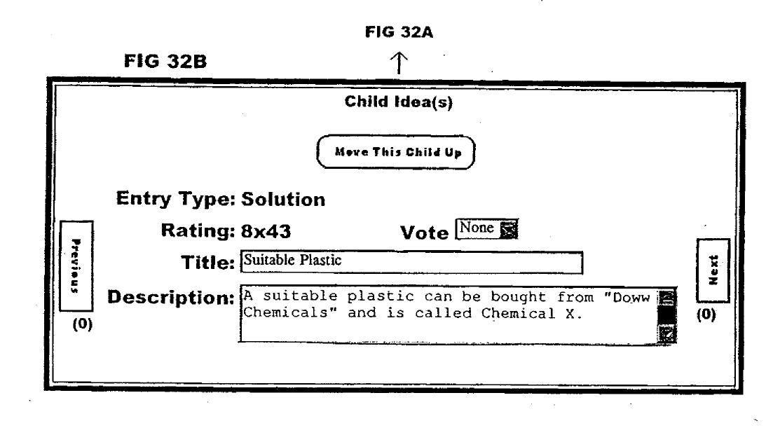

A screen display (as shown in FIG. 32), in which the child idea in the Child Idea(s) section of the screen display of FIG. 31 is displayed as the selected idea in the Current Idea Selection section, is accessed by clicking the “Move This Child Up” button in the Child Idea(s) section, in the screen display of FIG. 31.

In the screen display of FIG. 32, the selected idea described in the Current Idea Selection section is Problem Idea 11, the parent idea listed in the Parent section is Solution Idea 10, and the child idea described in the Child Idea(s) section is Solution Idea 12.

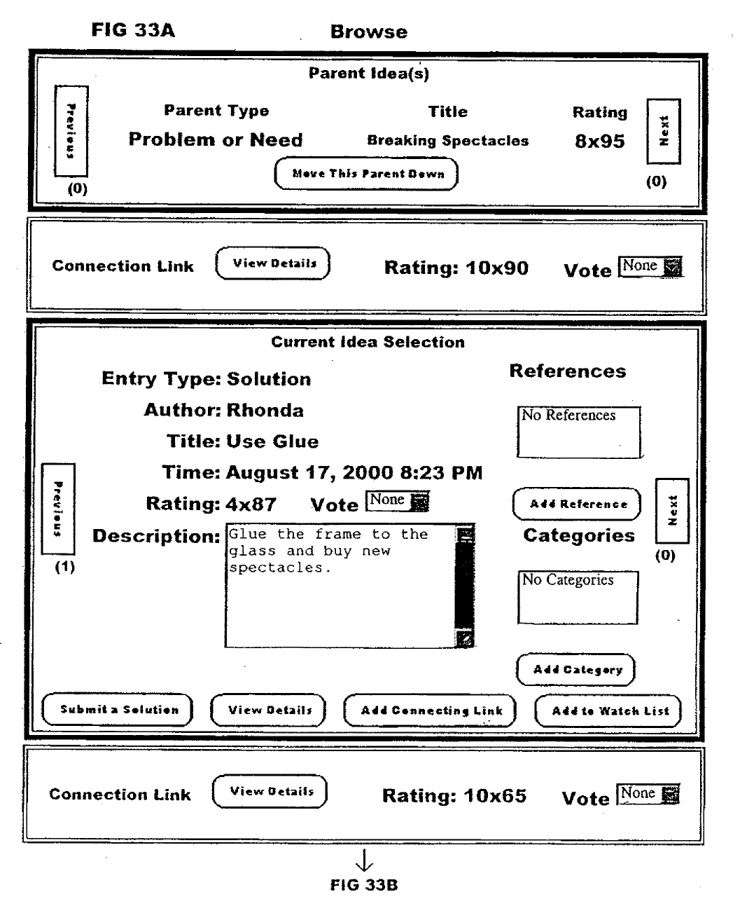

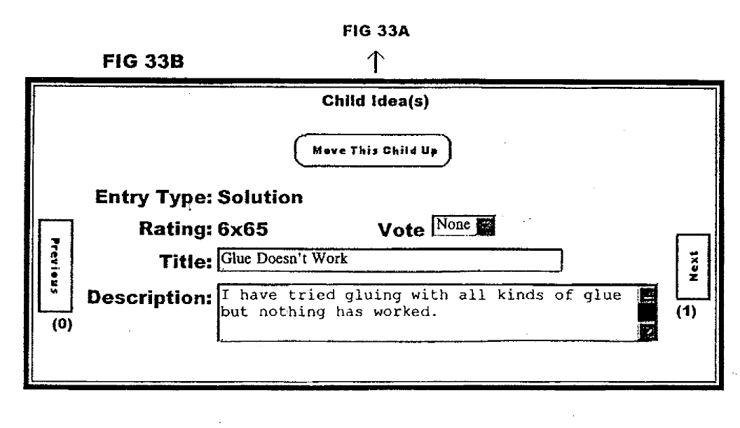

After returning to the screen display of FIG. 20, a screen display (as shown in FIG. 33), in which the child idea in the Child Idea(s) section of the screen display of FIG. 20 is displayed as the selected idea in the Current Idea Selection section, is accessed by clicking the “Move This Child Up” button in the Child Idea(s) section, in the screen display of FIG. 20.

In the screen display of FIG. 33, the selected idea described in the Current Idea Selection section is Solution Idea 3, the parent idea listed in the Parent section is Problem Idea 1, and the child idea described in the Child Idea(s) section is Problem Idea 4, as described above with reference to FIG. 2. In the Child Idea(s) section, the “(1)” indication beneath the Next button indicates that there is one other child idea linked to selected Solution Idea 3.

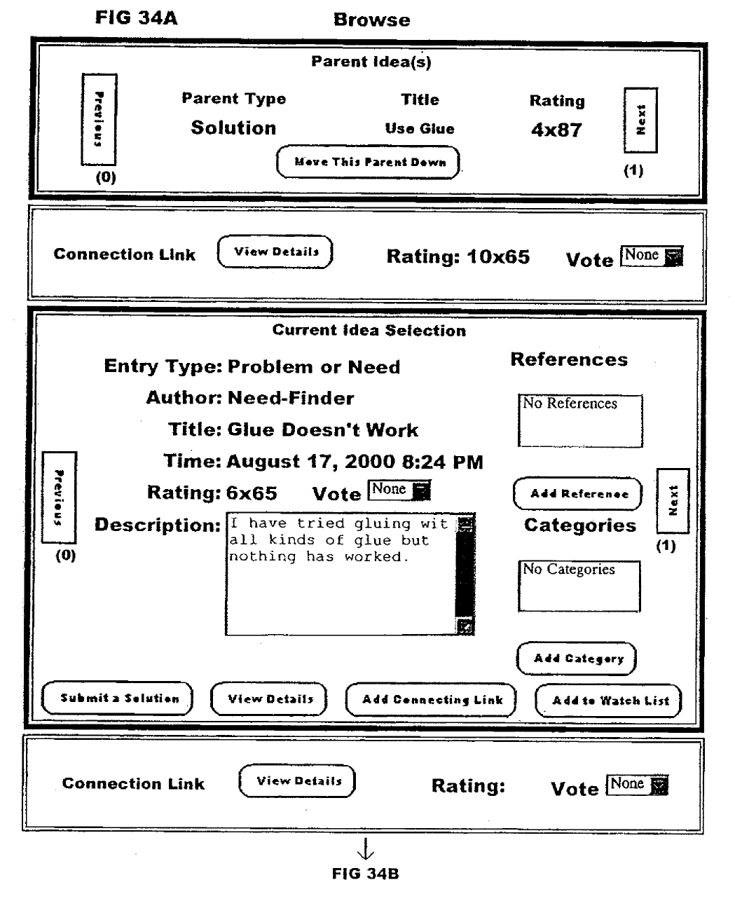

A screen display (as shown in FIG. 34), in which the child idea in the Child Idea(s) section of the screen display of FIG. 33 is displayed as the selected idea in the Current Idea Selection section, is accessed by clicking the “Move This Child Up” button in the Child Idea(s) section, in the screen display of FIG. 33.

In the screen display of FIG. 34, the selected idea described in the Current Idea Selection section is Problem Idea 4, the parent idea listed in the Parent section is Solution Idea 3, and no child idea described in the Child Idea(s) section.

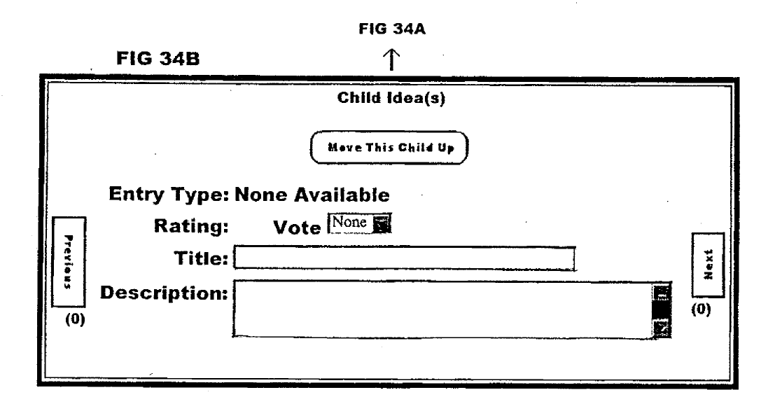

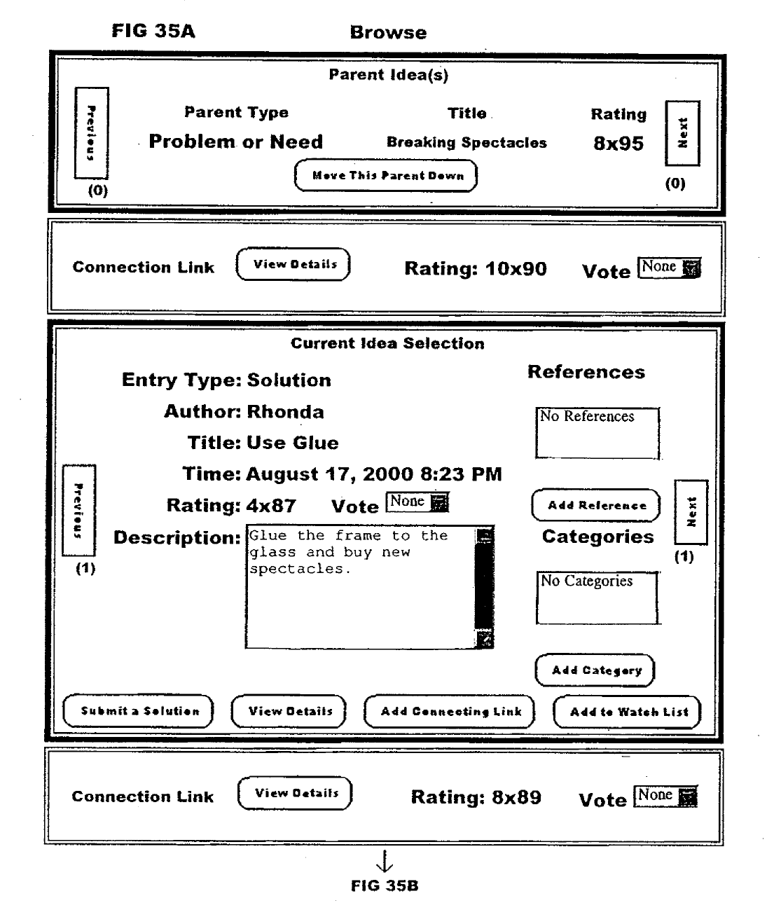

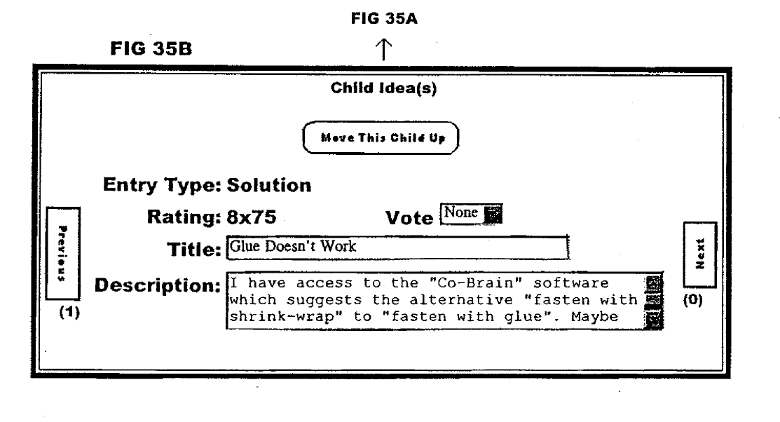

After returning to screen display of FIG. 33, clicking the Next button in the Child Idea(s) section of the screen display of FIG. 33 provides access to the screen display of FIG. 35, wherein the selected idea described in the Current Idea Selection section is Solution Idea 3, the parent idea listed in the Parent section is Problem Idea 1, and the child idea described in the Child Idea(s) section is Problem Idea 5, as described above with reference to FIG. 2.

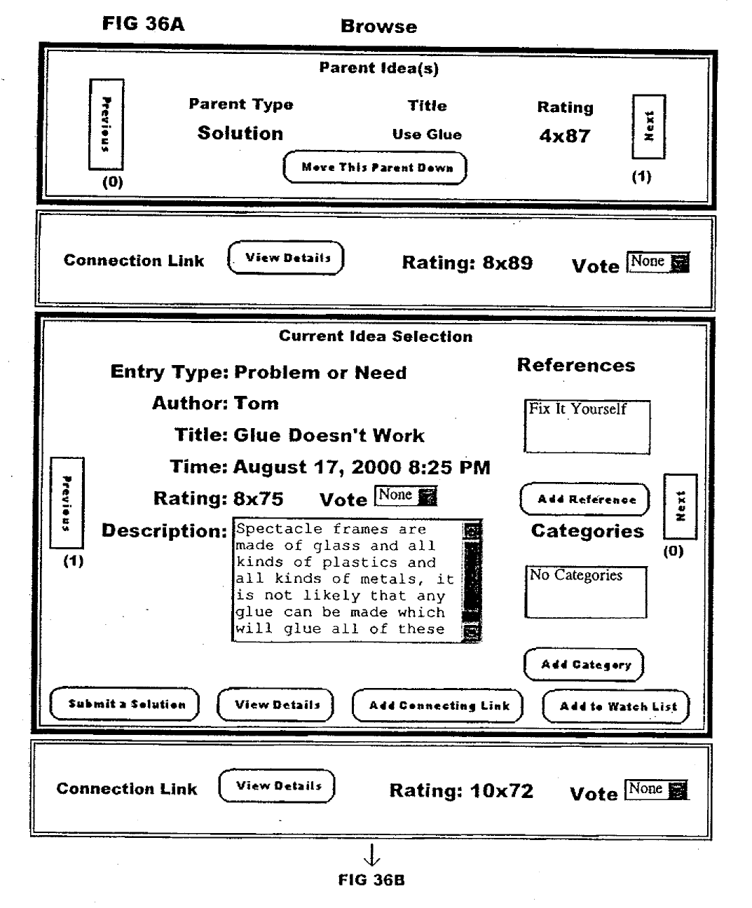

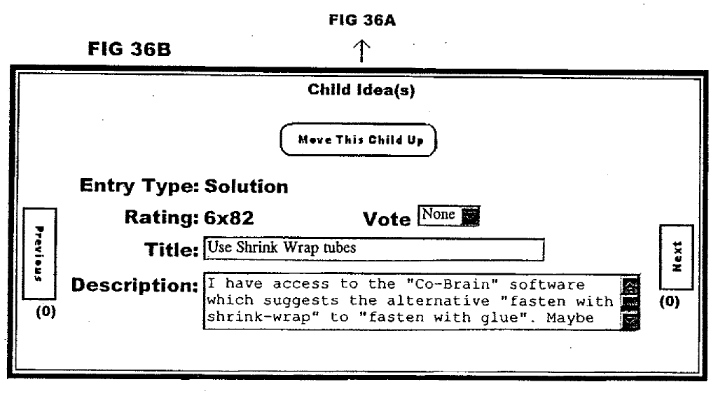

A screen display (as shown in FIG. 36), in which the child idea in the Child Idea(s) section of the screen display of FIG. 35 is displayed as the selected idea in the Current Idea Selection section, is accessed by clicking the “Move This Child Up” button in the Child Idea(s) section, in the screen display of FIG. 35.

In the screen display of FIG. 36, the selected idea described in the Current Idea Selection section is Problem Idea 5, the parent idea listed in the Parent section is Solution Idea 3, and Solution Idea 6 is child idea described in the Child Idea(s).

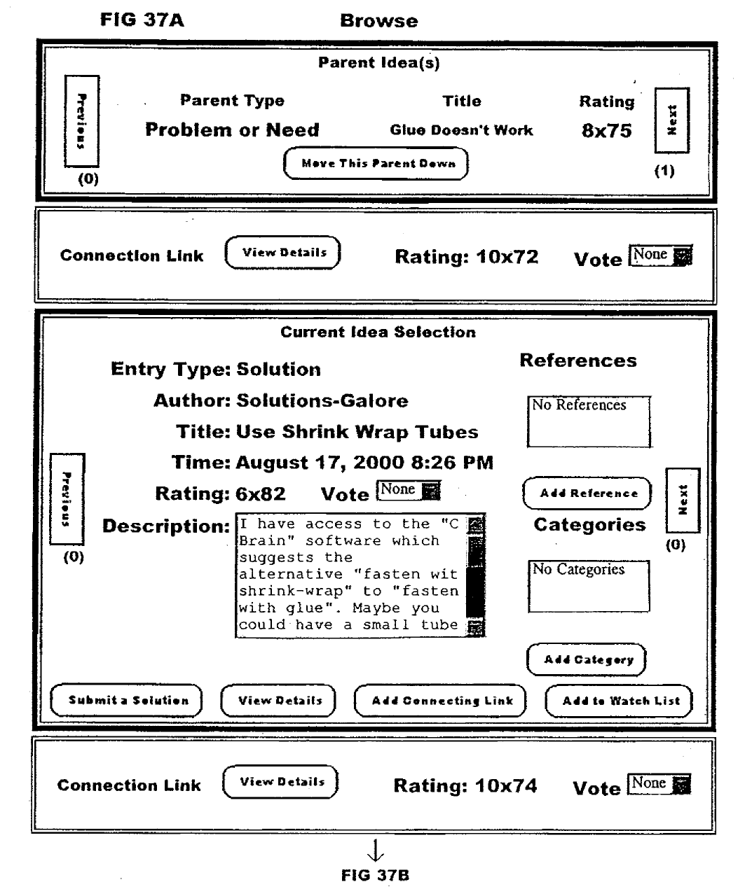

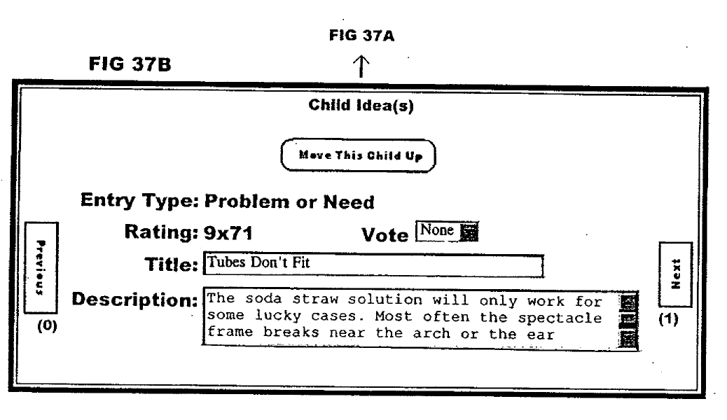

A screen display (as shown in FIG. 37), in which the child idea in the Child Idea(s) section of the screen display of FIG. 36 is displayed as the selected idea in the Current Idea Selection section, is accessed by clicking the “Move This Child Up” button in the Child Idea(s) section, in the screen display of FIG. 36.

In the screen display of FIG. 37, the selected idea described in the Current Idea Selection section is Solution Idea 6, the parent idea listed in the Parent section is Problem Idea 5, and the child idea described in the Child Idea(s) section is Problem Idea 7. In the Child Idea(s) section, the “(1)” indication beneath the Next button indicates that there is one other child idea linked to selected Solution Idea 6.

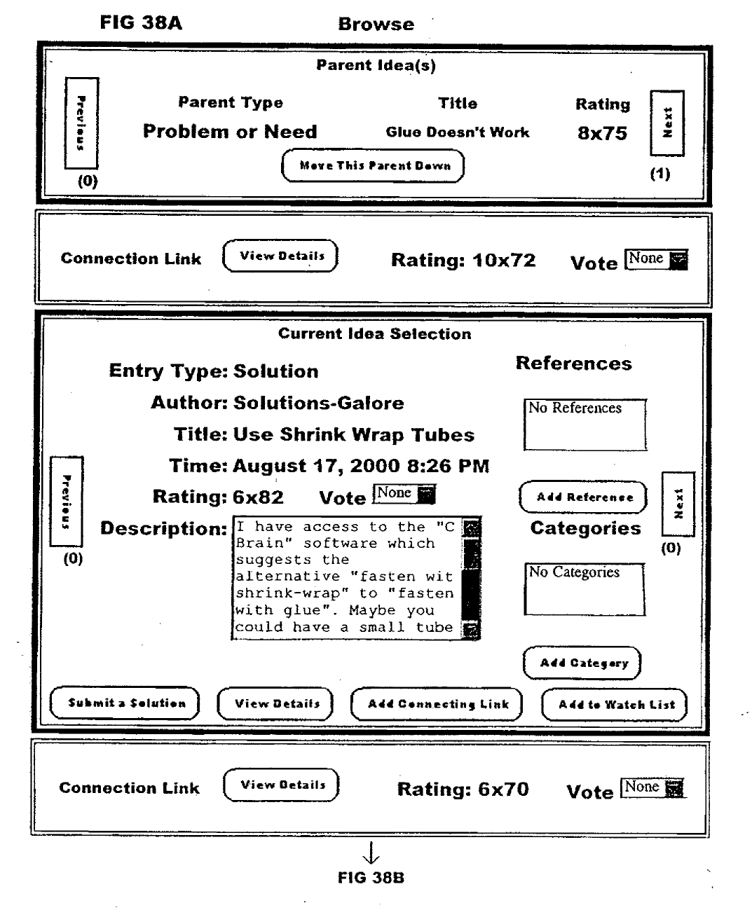

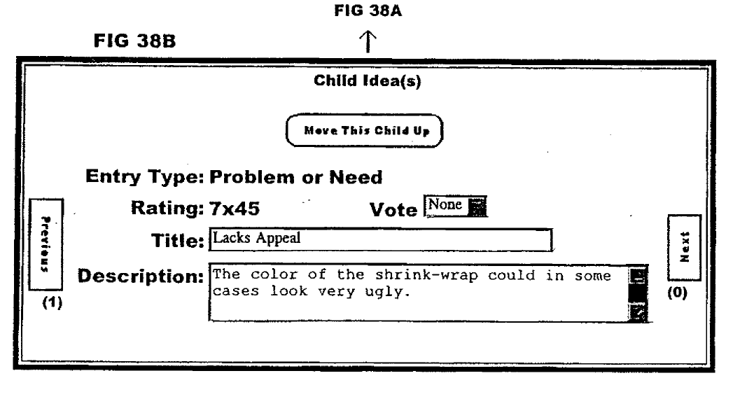

Clicking the Next button in the Child Idea(s) section of the screen display of FIG. 37 provides access to the screen display of FIG. 38, wherein the selected idea described in the Current Idea Selection section is Solution Idea 6, the parent idea listed in the Parent section is Problem Idea 5, and the child idea described in the Child Idea(s) section is Problem Idea 9.

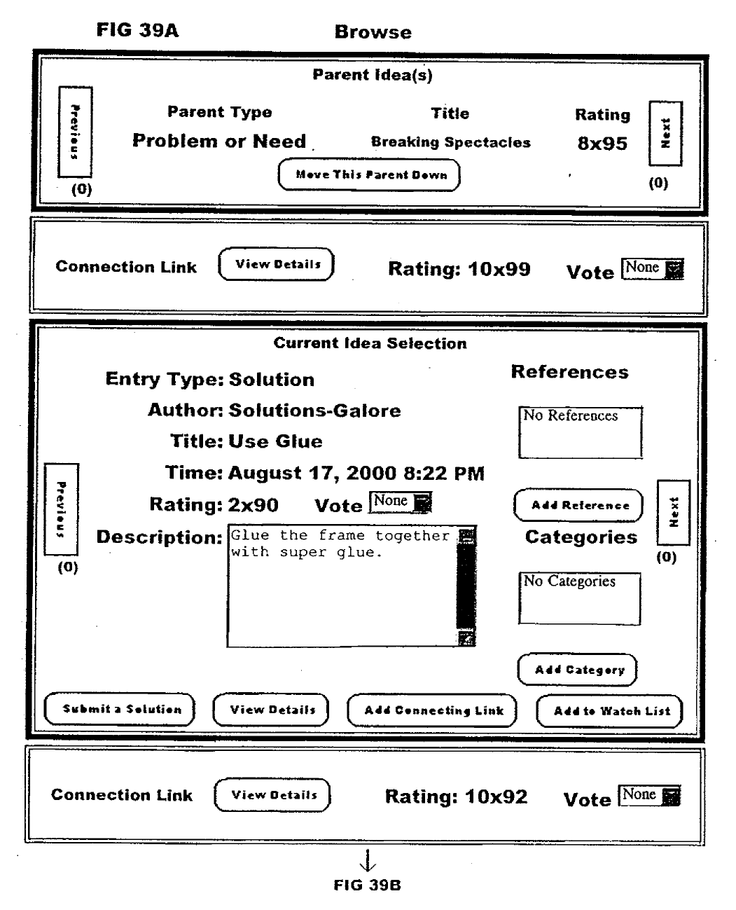

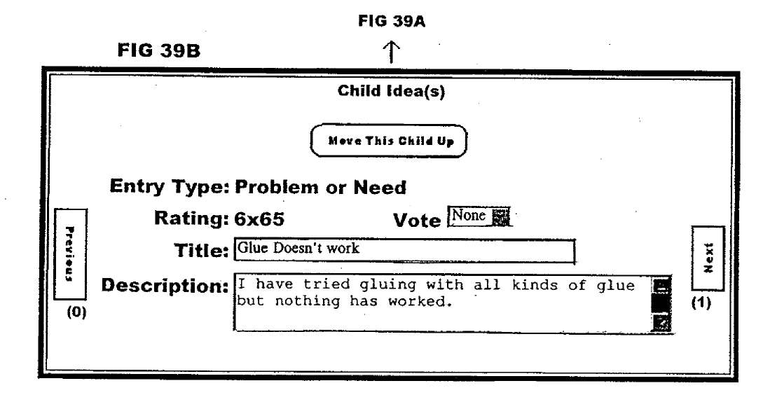

After returning to the screen display of FIG. 21, a screen display (as shown in FIG. 39), in which the child idea in the Child Idea(s) section of the screen display of FIG. 21 is displayed as the selected idea in the Current Idea Selection section, is accessed by clicking the “Move This Child Up” button in the Child Idea(s) section, in the screen display of FIG. 21.

In the screen display of FIG. 39, the selected idea described in the Current Idea Selection section is Solution Idea 2, the parent idea listed in the Parent section is Problem Idea 1, and the child idea described in the Child Idea(s) section is Problem Idea 4. In the Child Idea(s) section, the “(1)” indication beneath the Next button indicates that there is one other child idea linked to selected Solution Idea 2.

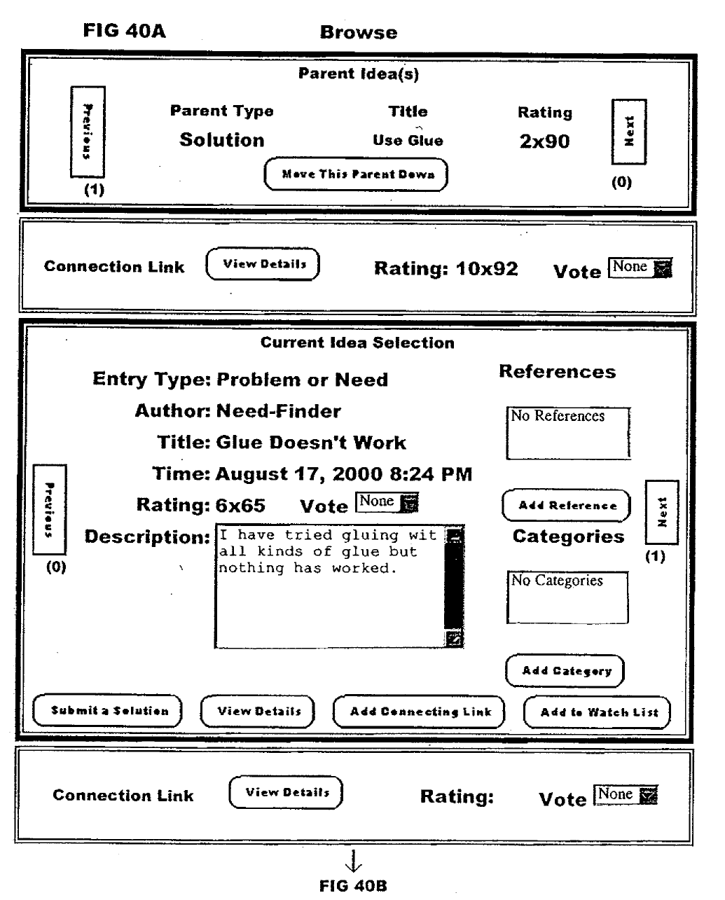

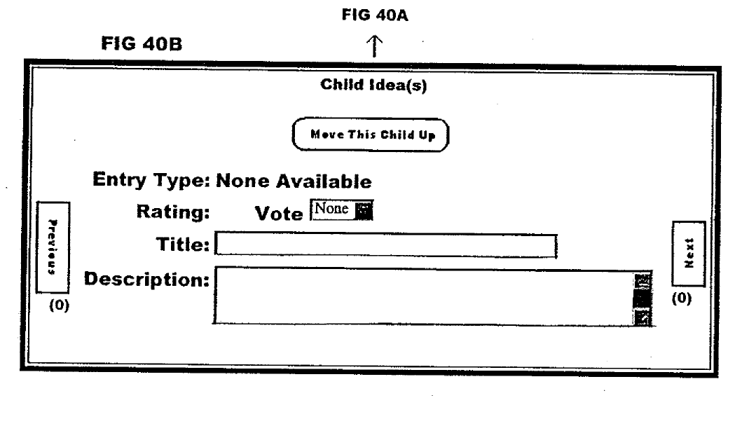

A screen display (as shown in FIG. 40), in which the child idea in the Child Idea(s) section of the screen display of FIG. 39 is displayed as the selected idea in the Current Idea Selection section, is accessed by clicking the “Move This Child Up” button in the Child Idea(s) section, in the screen display of FIG. 39.

In the screen display of FIG. 40, the selected idea described in the Current Idea Selection section is Problem Idea 4, the parent idea listed in the Parent section is Solution Idea 2, and no child idea described in the Child Idea(s) section.

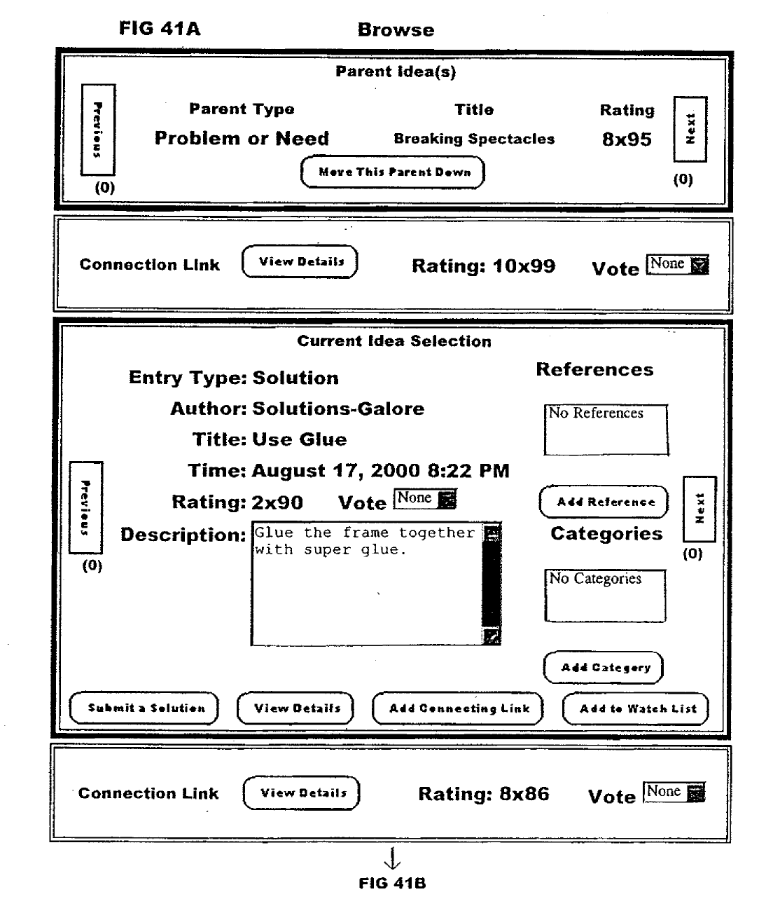

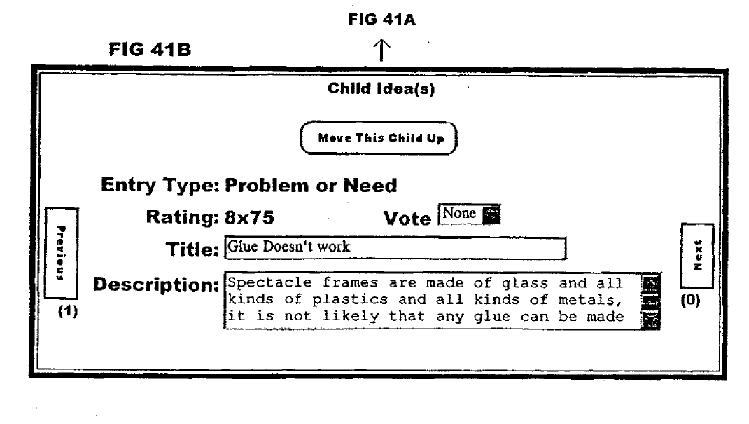

After returning to screen display of FIG. 39, clicking the Next button in the Child Idea(s) section of the screen display of FIG. 39 provides access to the screen display of FIG. 41, wherein the selected idea described in the Current Idea Selection section is Solution Idea 2, the parent idea listed in the Parent section is Problem Idea 1, and the child idea described in the Child Idea(s) section is Problem Idea 5.

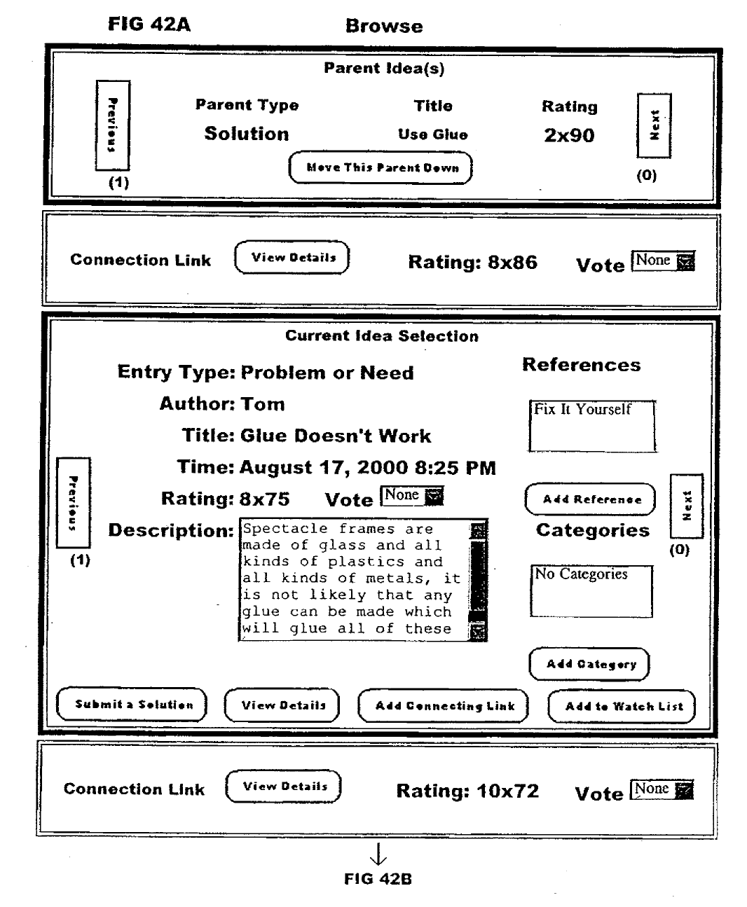

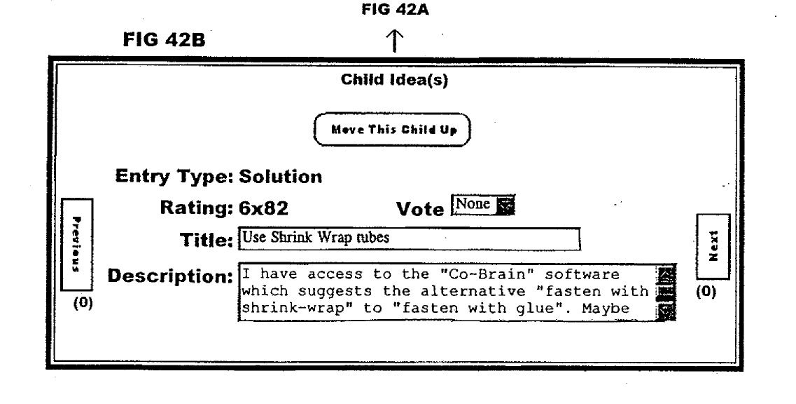

A screen display (as shown in FIG. 42), in which the child idea in the Child Idea(s) section of the screen display of FIG. 41 is displayed as the selected idea in the Current Idea Selection section, is accessed by clicking the “Move This Child Up” button in the Child Idea(s) section, in the screen display of FIG. 41.

In the screen display of FIG. 42, the selected idea described in the Current Idea Selection section is Problem Idea 5, the parent idea listed in the Parent section is Solution Idea 2, and the child idea described in the Child Idea(s) section is Solution Idea 6.

In the same manner, clicking the “Parent down” button moves the display of the parent down into the Current Idea Selection section.

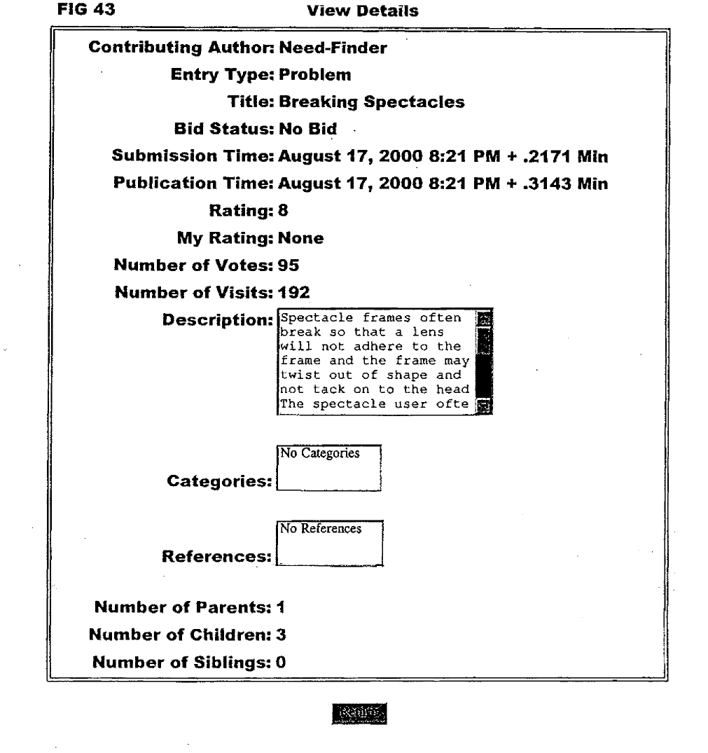

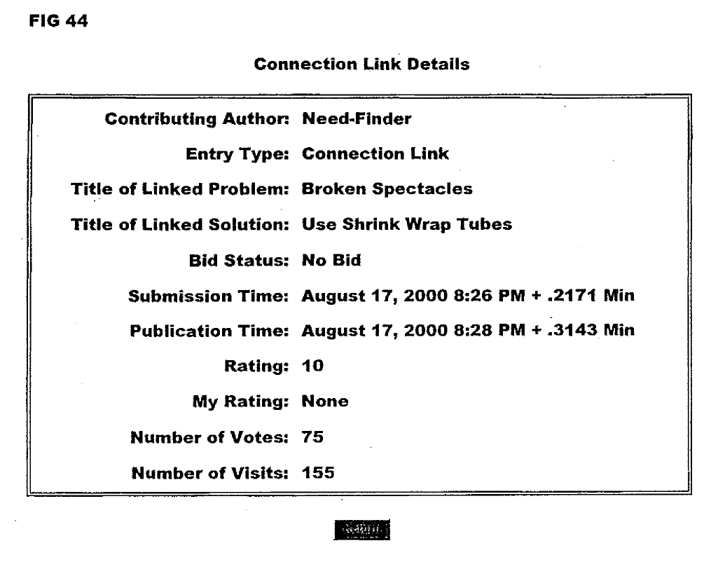

Referring again to the format of the screen display for a selected idea, as shown in FIG. 19, clicking the View Details button in the Current Idea Selection section provides access to the screen display of FIG. 43, which recites various details related to the selected idea in the Current Idea Selection section; and clicking the View Details button in the Connection Link section between the Current Idea Selection section and the Child Idea(s) section provides access to the screen display of FIG. 44, which recites various details related to the connection link between the current idea selection and the idea in the Child Idea(s) section

The Publish an Idea screen display of FIG. 12 includes an upper section for describing a first idea, a lower section for describing a second idea and a Connection Link section. The first idea is linked to the second idea unless the link is removed by clicking the “Remove this Link” button in the Connection link section. The display in the upper section corresponds to the Current Idea Selection section of a browse-mode display screen, such as shown in FIG. 19. Text is manually entered into the Title and Description portions of the lower section. The entered text may be added to a queue for submission with other entries by clicking the Add to Queue button in the lower section.

The queue is a storage area of a scratch book for members of the Idea Space website to store and organize sets of contributed ideas and sets of connection links before they are submitted to the Idea Space database. Contributed ideas and connecting links may then be submitted as a unit in a member-organized configuration. Connection links within the queue may connect two contributed ideas within the queue, two currently published contributed ideas within the database, or a contributed idea within the queue and a currently published contributed idea within the database. Until submitted to the database individually or as a part of a unit in a member-organized configuration, the idea files in the queue and/or their organization within one or more units, as defined by their connection links, may be modified, deleted, moved, or recombined by the user/member. New contributed ideas and connection links may be added to the queue. Means are provided for selecting contributed ideas and connection links for submission to the database as an organized unit or individually. Submission to the database is not limited by the order in which the contributed ideas and the connection links are created. Contributed ideas and connection links in the queue that are not submitted when other contributed ideas and connection links in the queue are submitted, are saved for later manipulation and/or submission to the idea database. The computer system managing the Idea Space website database does not process or publish contributed ideas or related connection links until the entire unit containing the contributed ideas and the related connection links is submitted. Partially received units are treated in the same manner as a partially received contributed idea or a partially received connection link; and the same time of receipt is recorded for all of the contributed ideas and connection links that are submitted as part of a unit. Upon publication in the database, the same time of publication is listed for all of the contributed ideas and connection links that are submitted as part of a unit.

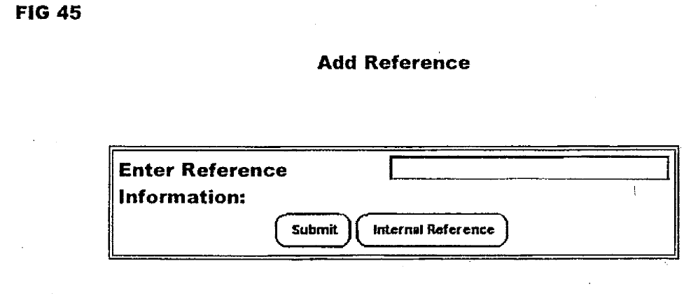

Referring again to the Publish an Idea screen display of FIG. 12, clicking the Add Reference button brings up the Add Reference screen display of FIG. 45, wherein an external reference may be identified by manually entering text in the Enter Reference Information space. Clicking the Submit button submits the identified external reference. If the user desires instead to enter an internal reference, the Internal Reference button is clicked.

Clicking the Internal Reference button brings up the Add Reference screen display of FIG. 46, wherein a Current Idea Selection in the database, such as shown in the screen display of FIG. 19, may be accessed and added as a reference by selecting the desired contributed idea in the same manner as described above in describing the browse mode by clicking the “Add this as the reference” button.

Upon clicking the Add Categories button in the Publish an Idea screen display of FIG. 12, the user is enabled to select and add a category or categories from a list or lists of classes and subclasses of the United States Patent and Trademark Office and/or the Standard Industrial Classification (SIC) system to the respective idea file. If an appropriate class and/or subclass does not exist, the user has the option of creating a new class and/or subclass. Other lists of classes may be used as a means for categorizing ideas and appropriate selection means are displayed to the user. Upon submission of the selected category or categories, selected category is associated with contributed idea described in the screen display from in which the Add Categories button is clicked.

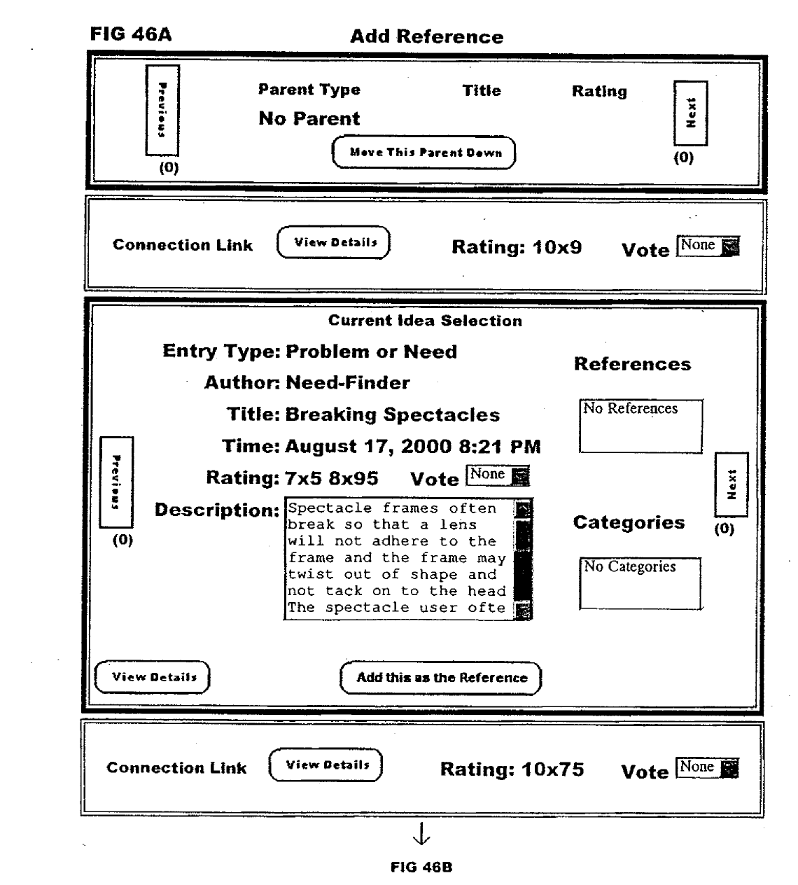

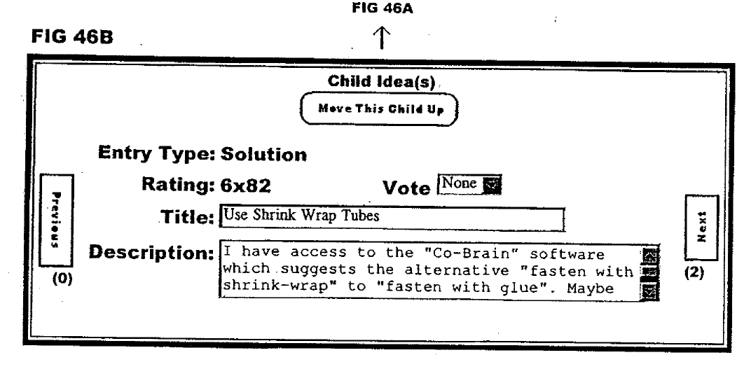

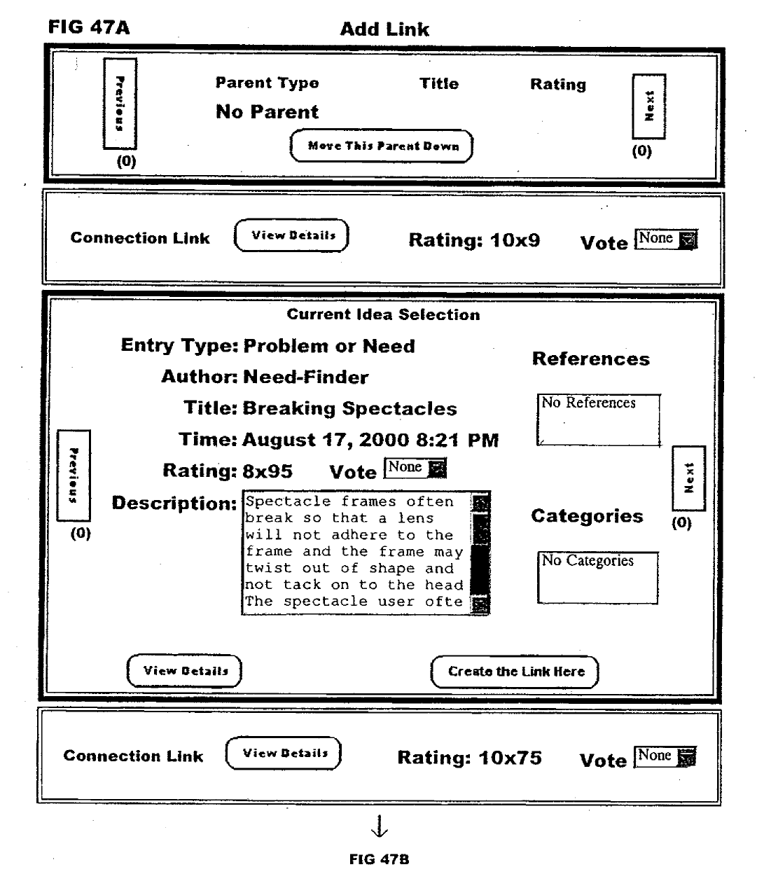

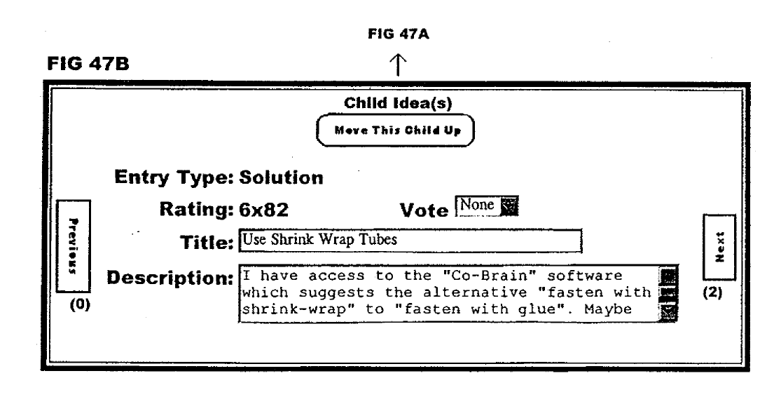

Clicking the Add Link button in the Publish an Idea screen display of FIG. 12 brings up the Add Link screen display of FIG. 47, wherein the Create the Link Here button is clicked to create the links shown in the Add Link screen display, after selecting the desired contributed idea in the same manner as described in describing the browse mode.

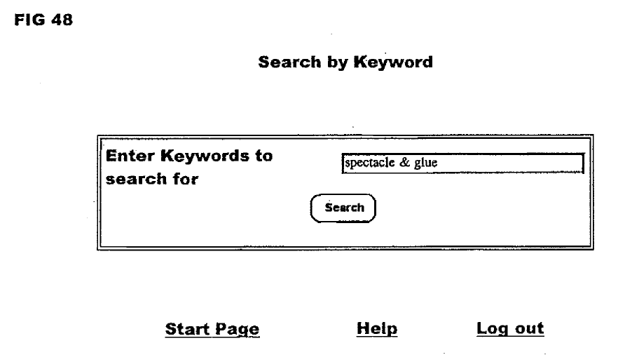

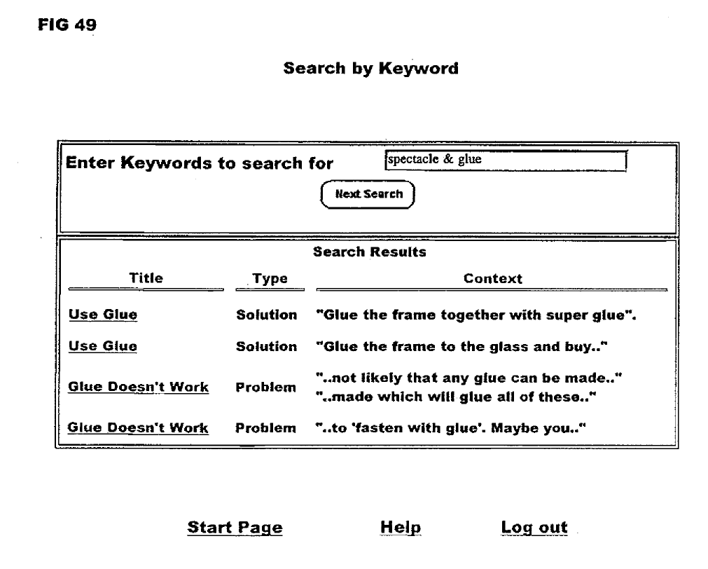

Referring to the Search for Contributions screen display of FIG. 13, clicking the Search by Keywords link brings up the screen display of FIG. 48. Clicking the search button in the screen display of FIG. 48 brings up the search results as shown in the screen display of FIG. 49.

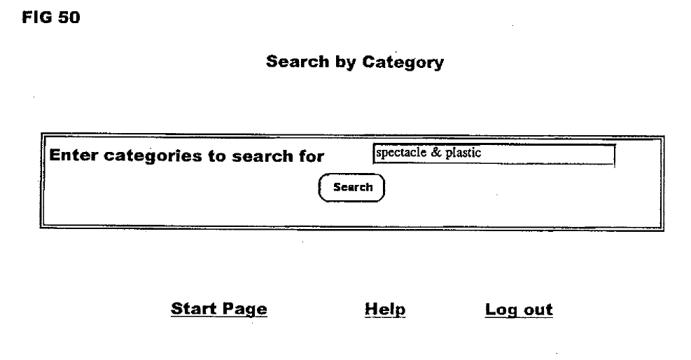

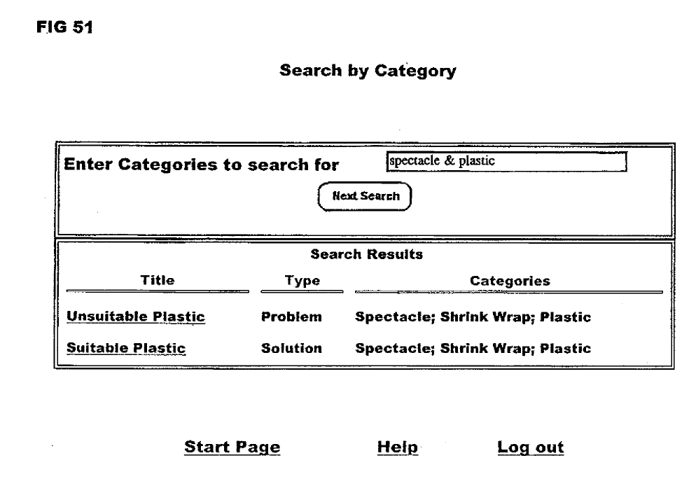

Clicking the Search by Categories link in the Search for Contributions screen display of FIG. 13 brings up the screen display of FIG. 50. Clicking the search button in the screen display of FIG. 50 brings up the search results as shown in the screen display of FIG. 51.

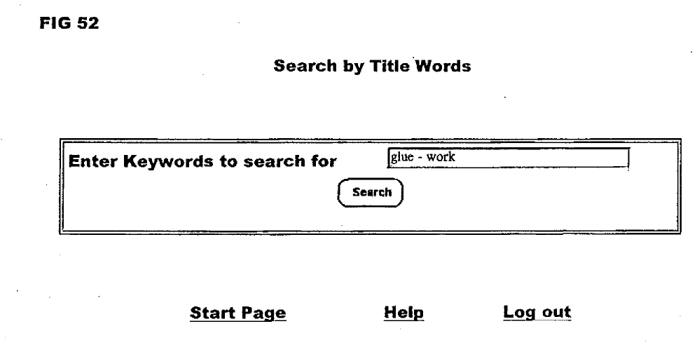

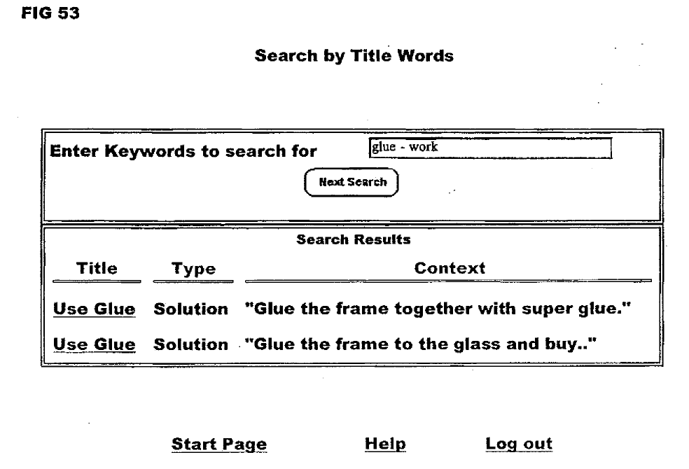

Clicking the Search by Title Words link in the Search for Contributions screen display of FIG. 13 brings up the screen display of FIG. 52. Clicking the search button in the screen display of FIG. 52 brings up the search results as shown in the screen display of FIG. 53.

Clicking the Advanced Search link in the Search for Contributions screen display of FIG. 13 enables a member user of the database to search the database for contributed ideas and/or connection links based on one or more sets of fields of their selection within the contributed files and/or connection links. The advanced search utilizes Boolean operators to logically combine together selections defined by key word entries within the same and different search fields. Wild cards are allowed for the key word entries in all fields.

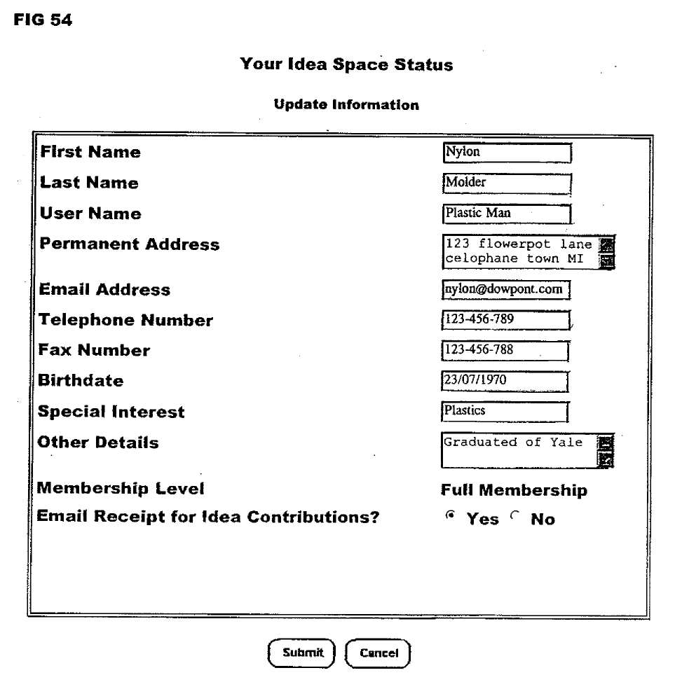

Clicking the Update Profile button in the Your Idea Space Status screen display of FIG. 18 brings up the screen display of FIG. 54. Note that the birth date of the user has been corrected in the screen display of FIG. 54.

In another embodiment, the related ideas that are processed to provide an integrated idea in the database include contributed ideas of “problems with theories” and “solutions to problems with theories”. An integrated idea in accordance with this embodiment is organized in the database by providing access links between contributed ideas of “problems with theories” and “solutions to problems with theories” and vice versa, but generally not between contributed ideas of “problems with theories” and contributed ideas of “problems with theories” or between contributed ideas of “solutions to problems with theories” and contributed ideas of “solutions to problems with theories”. This embodiment may have integrated ideas which are integrations of ideas of the other databases shown herein so that access links are generally created between contributed ideas of “solutions to problems with theories” and “problems with solutions and their enablement” and further between “problems with theories” and “solutions to problems and needs”. Alternatively, such an embodiment may not be so integrated.

In the various embodiments, the step of facilitating contribution of ideas to a computer database of ideas can be carried out automatically by the computer system. One example of such step being carried out automatically by a computer system would be as follows. In the exemplary embodiment described with reference to FIG. 2, where Idea 4 is contributed as a child of Idea 2, this step is accomplished by a human contributor; and where Idea 4 is contributed as a child of Idea 3, this latter contribution is accomplished automatically by a computer that is used to manage and provide the idea database in response to the computer recognizing the similarity of the words of Idea 2 and Idea 3. Such technology is known, and for example, was provided at the time of filing the parent application (U.S. patent application Ser. No. 10/309,384) by a “cobrain” website identified in the application. If an idea automatically contributed by a computer is inappropriate the idea will get a very low rating by the database users.

Another example of the step of facilitating contribution of ideas to a computer database of ideas being carried out automatically by a computer is as follows. Idea 10, which is based upon transparency, is contributed automatically by a computer owned and programmed by a member of the public in response to the computer recognizing the problem related to the word “color” in Idea 9. Such technology is also known, and for example, was provided at the time of filing the parent application (U.S. patent application Ser. No. 10/309,384) by a “cobrain” website identified in the application.

Another example of computer processing of ideas to provide an integrated idea was provided at the time of filing the parent application (U.S. patent application Ser. No. 10/309,384) by a “techoptimizer” website identified in the application, the disclosure of which is incorporated herein by reference thereto.

In some embodiments, the idea database 22 is maintained as a business by the idea manager 20, but is contributor and customer driven, in that some of the contributors 27 and some of the customers 28 suggest to the idea manager 20 when an idea is inappropriately located within the database 22 in relation to the search system. An idea file can be accessed by the search system by using a contributor identification code, a contributor-provided title, subject, keywords, time of entry into the database, time of publication (provision of access) on the database, time of first access of the idea entry, and/or the number of accesses to an idea entry. The time recordings are within an accuracy of one-one-hundredth or one-one-thousandth of a second. The search system is able to show a continuous listing of idea entries (files) in accordance with the time records.

In some embodiments, the time of entry into the database and the time of access from the database would be the same.

In some embodiments, the idea entries are never changed as a general rule, but may be repositioned in accordance with the search system.

In some embodiments, the idea manager 20 systematically effects transfer of property rights to inventions 24 derived at least in part from the accumulated ideas to transferee customers, other than the contributors of the ideas from which the invention 24 was at least in part derived; and the computer system 21 is programmed to facilitate such transfers by on-line communications between the computer system 21 and the contributor computers 27 and/or the customer computers 28. Some such transfers that are pursuant to an obligation by the contributor to transfer such rights are to a transferee customer that was not identified upon establishment of said obligation.

In some embodiments, the idea manager 20 systematically effects transfer of property rights 44 to inventions 24 derived at least in part from the accumulated ideas to itself 20 as the proprietor of the database 22 or to a party in concert with itself 20; and the computer system 21 is programmed to facilitate such transfers by on-line communications between the computer system 21 and the contributor computers 27 and/or the customer computers 28.

The transferred property rights 48 include rights to contributed ideas per se and/or at least some right under the patent rights to at least some of the inventions 24 derived at least in part from the ideas accumulated in the database 22, including both inventions derived from integrated contributed ideas and inventions innate to a single idea contributed by a single contributor.

Incident to facilitating transfer of such property rights 48, or independent of such transfer, the idea manager 20 (a) sells at least some right under the patent rights to at least some of the inventions 24; (b) auctions at least some right under the patent rights to at least some of the inventions 24; (c) brokers and/or markets at least some rights under the contingent contractual rights to at least some of the inventions 24; (d) acquires at least some right under the patent rights to at least some of the inventions 24; and/or (e) facilitates public sale of the acquired rights to at least some of the inventions 24. In certain embodiments, such sale, auction, brokering, marketing, acquisition and facilitation of public sale are performed systematically. In alternative embodiments one or more of such sale, auction, brokering, marketing, acquisition and facilitation of public sale are not performed systematically.

In some embodiments, the computer system 21 is programmed to enable transfer of contingent contractual rights 40 in a marketable format between an owner of contingent contractual rights 40 and another interested party. One embodiment of such a marketable format is described in the About IDEA SHARES screen display shown in FIG. 55, which may be accessed by clicking the About Idea Shares link in the About IDEA SPACE screen display shown in FIG. 4B.

The contributor of an idea is generally assigned ownership of contingent contractual rights 40 upon contribution of the idea in exchange for transfer of property rights 44, 48 to the idea manager 20 or some other transferee. However, the contributor may specify another party unto which to initially assign ownership of the contingent contractual rights 40, such as the employer of the contributor.

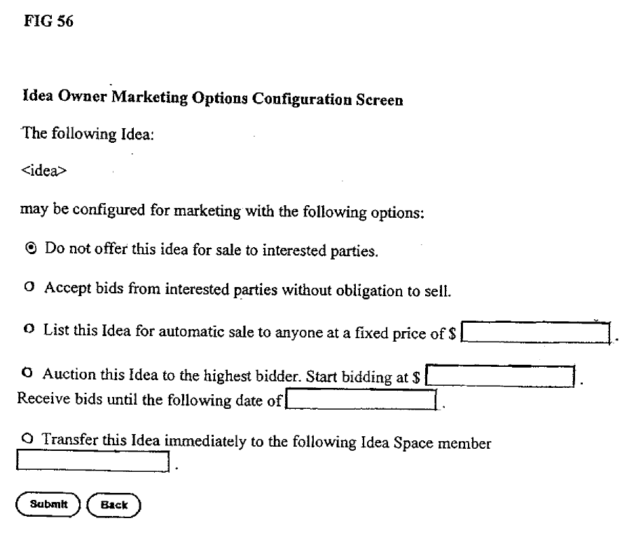

The current owner of a contingent contractual right 40 may elect, among other possible choices, to transfer, sell, or auction the contingent contractual rights 40 to other parties such as a party having a membership for the purpose of purchasing such contingent contractual rights 40. The computer system 21 is programmed to enable implementation of such choices by enabling only idea contributors whom own contingent contractual rights 40 to access an Idea Owner Marketing Options Configuration Screen display, such as shown in FIG. 56. Such access is effected by clicking a Marketing Options button in the Current Idea Section of a Solution type screen display, such as shown in FIG. 22A.

Depending upon which of the options shown in the screen display of FIG. 56 is selected and submitted, one of four different types of Idea Prospector Information Screen displays can be accessed when a person subsequently viewing the idea solution in the screen display of FIG. 22A clicks the Prospector Information button in the Current Idea Section of a Solution type screen display, such as shown in FIG. 22A.

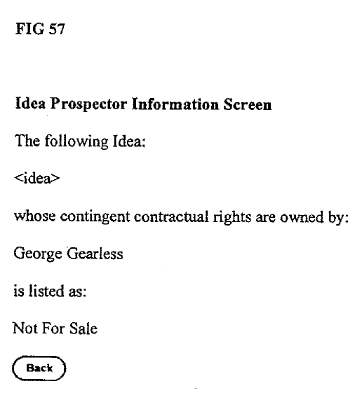

When the “Do not offer this idea for sale to interested parties” option on the screen display of FIG. 56 has been selected and submitted, the Idea Prospector Information Screen display shown in FIG. 57 is displayed in response to clicking the Prospector Information button in the screen display of FIG. 22A.

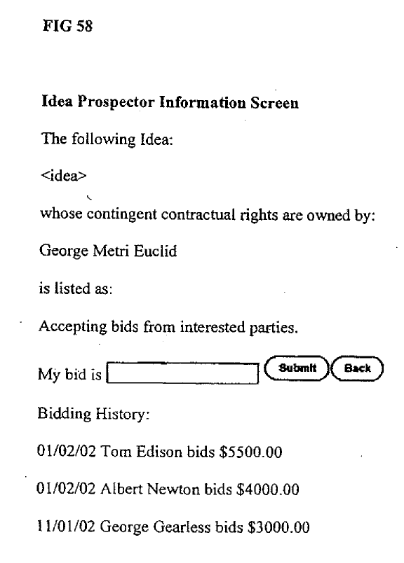

When the “Accept bids from interested parties without obligation to sell” option on the screen display of FIG. 56 has been selected and submitted, the Idea Prospector Information Screen display shown in FIG. 58 is displayed in response to clicking the Prospector Information button in the screen display of FIG. 22A.

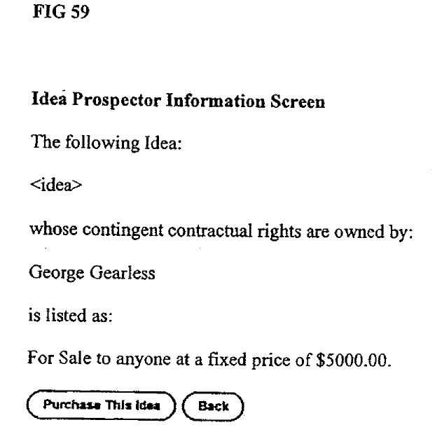

When the “List this Idea for automatic sale to anyone at a fixed price” option on the screen display of FIG. 56 has been selected and submitted, the Idea Prospector Information Screen display shown in FIG. 59 is displayed in response to clicking the Prospector Information button in the screen display of FIG. 22A.

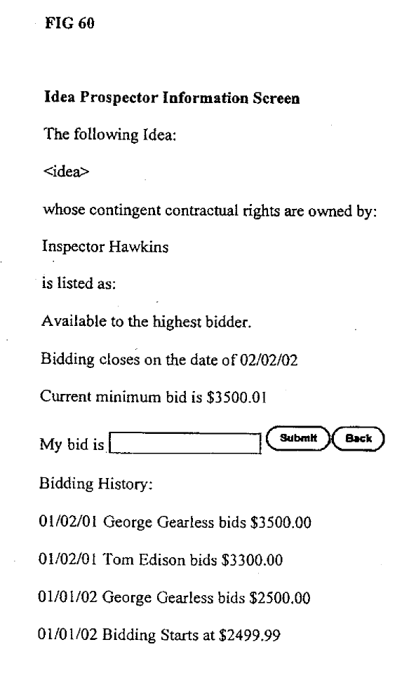

When the “Auction this Idea to the highest bidder” option on the screen display of FIG. 56 has been selected and submitted, the Idea Prospector Information Screen display shown in FIG. 60 is displayed in response to clicking the Prospector Information button in the screen display of FIG. 22A. Bids submitted by use of the screen display of FIG. 60 are subsequently displayed in the Bidding History portion of such screen display.

Methods of selling contingent contractual rights 40 other than at a fixed price or auction also are enabled by the computer system 21, including combinations of the methods utilizing the screen displays of FIGS. 56-60, and such other methods may be based on other conditions provided by the idea manager 20, the owner of the contingent contractual rights or an interested party.

In certain embodiments, the idea manager 20 also systematically facilitates preparation and/or filing of patent applications for at least some of the unpatented inventions, as indicated at 50 (FIG. 1). For some inventions, the step 48 of facilitating transfer of at least some right under the patent rights is carried out systematically before the step 50 of facilitating preparation and/or filing of a patent application. The computer system 21 is used to prepare and/or file a patent application for unpatented inventions innate to ideas in the database 22. Computer software for preparing patent applications from a database including an idea of an invention includes “Patent Pro” brand software available from Kernel Creations, Ltd. and “Patent Wizard” brand software available from Patent Wizard, LLC of Fargo, N. Dak. Computer software for filing patent applications in various national patent offices has been provided by the various national patent offices.

The idea manager 20 facilitates systematic filing of invention disclosure documents and/or patent applications disclosing some of the accumulated ideas that are new and/or related to accumulated ideas disclosed by previously filed disclosure documents and/or patent applications and accumulated in the computer database 22 subsequent to the filing of the previously filed disclosure documents and/or patent applications.

In some embodiments, a customer is enabled upon payment of a fee to file a first right of refusal to the property rights to a prospectively patentable invention. Such a filing can be accessed with the idea entry. Such rights may include contingent rights provided by the idea manager 20 and/or transferred property rights.

In some embodiments, the computer system 21 is programmed to publish the conditions for sale or license of property rights to at least some of the prospectively patentable inventions 24 in the database 22 and/or a history of sale or license of property rights to at least some of such inventions 24 by entering such conditions and history in the database 22 for public or member viewing. Examples of such conditions include: for sale, not for sale, will take bids, will sell to highest bidder before a specified date, will sell for a specified amount or to the highest bidder by a specified date. Examples of such a history include: sold to FSHP Company on a given date for a stated amount and licensed to General Plastics on a given date for a stated royalty.

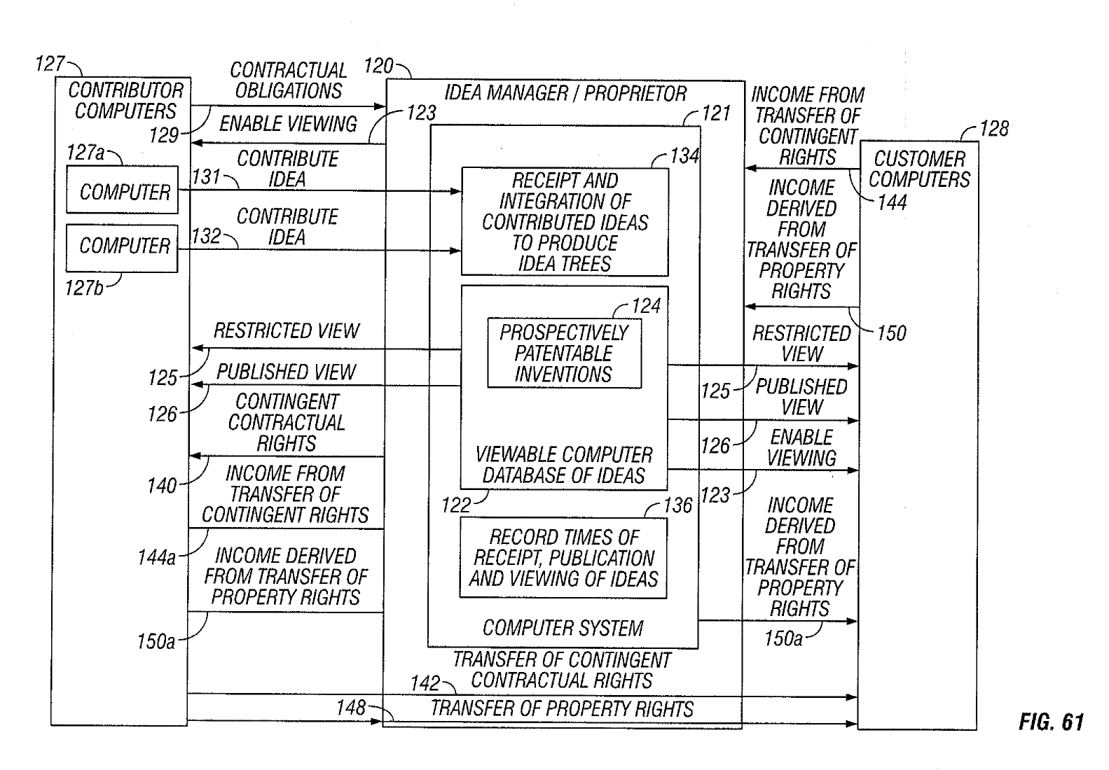

Referring to FIG. 61, in certain embodiments, rights related to inventions related to ideas accumulated in a computer database are managed by an idea manager 120, which maintains a computer system 121 and a computer database 122 for accumulating ideas for prospectively patentable inventions. The accumulated ideas may include needs and requirements of such inventions and/or are systematically accumulated prior to filing any patent applications for inventions respectively derived at least in part from the accumulated ideas. The idea manager 120 is the proprietor of the idea database 122 and/or one or more parties operating in concert with the proprietor. The computer system 121 is adapted by hardware, firmware and/or software for performing and/or enabling performance of the various methods described herein.

Various embodiments of systems and methods of managing the ideas contributed to and accumulated in the idea database 122 are described in International Patent Application Publication No. WO 02/15052 A1, the disclosure of which is incorporated herein by reference thereto. Said disclosure is also contained in related U.S. patent application Ser. No. 09/980,654 filed Oct. 25, 2001.

The computer system 121 may include one or more computers and one or more memories contained within or coupled to the computer(s). The idea manager 120 may be one party or different parties operating in concert with one another. Idea contributors use computers 127 to view 125, 126 the ideas accumulated in the idea database 122. One idea contributor can be the idea manager 120, including its staff and/or its computer system 121. Some contributor computers 127 may be shared by a plurality of contributors. Potential customers for property rights, including patent rights, to prospectively patentable inventions 124 derived at least in part from the ideas accumulated in the idea database 122 use computers 128 to view 125, 126 the accumulated ideas in the idea database 122 when viewing is enabled 123 by the computer system 121. In some embodiments, the contributor computers 127 may be the same as the customer computers 128 and/or the computers of the computer system 121. Some viewings 125 of the ideas from the idea database 122 are so restricted by non-disclosure agreements by the viewers as not to constitute a publication of the ideas; and some viewings 126 of the ideas from the idea database 122 are enabled without restriction and thereby constitute a publication of the ideas.

The computer system 121 is programmed to enable ideas contributed by one or more different contributors to the idea database 122 to be integrated by access links defined within the idea database 122 and contained in screen displays of the respective idea contributions to thereby produce idea trees that facilitate derivation of inventions 124 from the integrated ideas, as indicated at 134 in FIG. 61. For example, a first idea 131 contributed by a first member using the computer 127a is integrated with a second idea 132 contributed by a second member using the computer 127b to provide an integrated idea of a prospectively patentable invention 124. In another example, ideas contributed from the same computer by one or different contributors are integrated within the idea database 122. An embodiment of a system and method for integrating ideas contributed to a computer database is described in U.S. patent application Ser. No. 10/371,255, entitled “Computer Integration Of Invention Ideas” filed Feb. 21, 2003, the disclosure of which is incorporated herein by reference thereto.

In certain embodiments, the idea manager 120 provides a website from which the idea database 122 can be accessed for viewing and/or for entry of ideas therein, where access to the idea database 122 usually is over the Internet. In certain embodiments, a display of the web site provides a menu from which a user may select listings of (a) titles of the most recently contributed ideas; (b) titles of ideas that have received the most hits by users accessing the database; (c) integrated ideas combining the greatest number of prior ideas (such as the individual files respectively providing reference to the greatest number of files that are related either directly or indirectly to the identification code of another idea in the database); (d) the most recent integrated ideas (e) the identification codes, names or pseudonyms of the contributors whom have supplied the most ideas to the database; and (f) the identification codes, names or pseudonyms of the contributors whom have supplied the most ideas to the database for which rights have been provided/transferred. Such listings include links for accessing the ideas listed therein. Users can register for being notified by email of new entries of ideas having selected key words in the idea title and/or text; and such users are then so notified. The email notification includes a link to the new entry in the database.

A contributor enters an idea by text and/or attachment entry and/or by using software downloaded from the idea manager's website, or otherwise provided by the idea manager (such as in a compact disc), to enter drawings.

The computer system 121 is programmed by the idea manager 120 to facilitate use of the contributor computers 127 to make on-line contributions of ideas 131, 132 to the idea database 122. Computer programs that enable the contributor computers 127 to be used to make on-line contributions of ideas to the idea database 122 can be downloaded by the contributor computers 127 from the computer system 121. An on-line contribution is a contribution that is made over a communication network, such as the Internet.

The computer system 121 is programmed to enable receipt of contributions of ideas for prospective entry into the database 122, and to facilitate receipt of such contributions on-line from the contributor computers 127. In some embodiments, the computer system 121 is programmed to record (a) the time of receipt of each idea contributed for entry into the idea database 122; (b) the time of publication in the idea database 122 of each accumulated idea; (c) the time of first viewing of each idea contributed to the idea database 122; and/or (d) the time of first public viewing from the idea database 122 of each accumulated idea, as indicated at 136 in FIG. 61.

In some embodiments, the computer system 121 is programmed to systematically enter into the idea database 122 all the ideas contributed for entry into the database 122 without requiring any contributor of such ideas to have subject matter expertise as a prerequisite for entry of such contributions. In other embodiments, the computer system 121 is programmed to require contributors of ideas to the database 122 to have subject matter expertise as a prerequisite for contributing ideas for prospective entry into the idea database 122, and facilitate entry of evidence of such expertise by on-line communications between the computer system 121 and the contributor computers 127. Such evidence can also be effected by other means, such as by mail. In still other embodiments, the computer system 121 is programmed to selectively enter only some of the contributed ideas into the idea database 122. In some embodiments, selective entry is accomplished by systematic computer screening for relevant subject matter. In some embodiments, selective entry is accomplished by systematic computer screening for keywords and by a computer operator making a selective entry decision based upon the context in which the keywords are used.

In certain embodiments, the computer system 121 is programmed to require entities to enter into a membership as a prerequisite for viewing a portion of the idea database 122 containing at least some of the accumulated ideas, and to facilitate entry into such membership by on-line communications between the computer system 121 and the contributor computers 127. An entity may be a natural person; an organization, such as a corporation, company, partnership, association or the like; or a group of person(s) and/or organization(s). Entry into such a membership can also be effected by other means, such as by mail. Upon entering into a viewer membership, an entity agrees to give up some legal rights, such as by agreeing to nondisclosure agreements pertaining to given ideas accumulated in the idea database 122. In these embodiments, the computer system 121 is programmed to enable 123 entities, whom have entered into a membership as a prerequisite for viewing the ideas accumulated in the idea database 122 to view 125, 126 accumulated ideas from the idea database 122, including ideas not respectively contributed by such entities.

In alternative embodiments, no such membership is required for on-line viewing of any portion of the idea database 122 by the general public.

The computer system 121 provides a search engine for keyword searching for selected ideas in the idea database 122. Once the selected idea has been found by such a search, the specific details of the selected idea can be accessed and viewed in computer generated display screens. In certain embodiments, these specific details include: (a) the type of idea submission: e.g., need, solution, or comment, (b) the title, (c) the author, (d) the certificate owner or the property rights owner if the property rights have been sold to a technology customer, (e) a textual description of the idea, (f) access links specifically directed to any attached supporting illustrations, (g) associated industry fields, (h) access links specifically directed to the parent node and the root need node if different from the parent node, (i) access links specifically directed to any children nodes, d) the submittal date, (k) the last purchase date, (l) the sale price, (m) a minimum or starting bid amount if the idea is being offered for sale or auction, (n) the date the idea was posted for sale or auction, (o) identity of and access links specifically directed to associated idea brokers, (p) identity of and access links specifically directed to representing idea agents, (q) a rating of the idea, (r) access links specifically directed to prior art references and (s) access links specifically directed to associated idea submissions.

The computer system 121 facilitates the rating of the uniqueness, commercial usefulness, and appropriateness of idea submissions by members of the system by providing a rating screen display. In certain embodiments, the rating is limited to five levels, and is presented as questions as opposed to a numerical scale. The questions may appear as “Was this solution was very unique?”, “Was this solution was somewhat unique?”, “Was this solution very surprising?” and/or “Was this solution was somewhat surprising?”. The computer system 121 enumerates the rating questions and provides an average rating based on a scale of one to five stars, with five stars being high.

In certain embodiments, the computer system 121 facilitates an auto-notification of ideas identified by member viewers. When members define a search criterion or create a favorite search criterion, they may also use that criterion for defining the basis of an auto-notification agent. The member specifies a periodic rate at which an automated search for a selected idea will be performed in the idea database 122. Any new results, since the agent creation date or since the last time the search was performed, are forwarded to the member via Email without the member having to log into the computer system 121. Since it will be possible for a member to specify multiple auto-notification agents, the computer system 121 provides tools for managing a collection of auto-notification agents. This tool facilitates the creation, removal, activation, deactivation, and editing of auto-notification agents.

In certain embodiments, the computer system 121 is programmed to require contributors of ideas for prospective entry into the idea database 122 to enter into a membership as a prerequisite for contributing ideas for entry into the idea database 122, and to facilitate entry into such membership by on-line communications between the computer system 121 and the contributor computers 127. Entry into such a membership can also be effected by other means, such as by mail. In these embodiments, the computer system 121 is programmed to enable 123 entities, whom have entered into a membership as a prerequisite for contributing ideas to the idea database 122, to view 125, 126 accumulated ideas from the idea database 122, including ideas not respectively contributed by such entities.

Upon entering into a contributor membership, an entity is required to agree to transfer property rights related to any inventions derived from any idea contributed by the entity, and in some embodiments may also be required to agree to give up some additional legal rights with respect to ideas contributed by the entity.

In certain embodiments, the computer system 121 is programmed to systematically facilitate establishment of contractual obligations 129 by contributors of the ideas to the idea database 122 by on-line communications between the computer system 121 and the contributor computers 127. With regard to some of the contractual obligations 129, in some embodiments, the entities that are obligated generally are not employees of the proprietor 120 or employees of a party in concert with the proprietor 120.

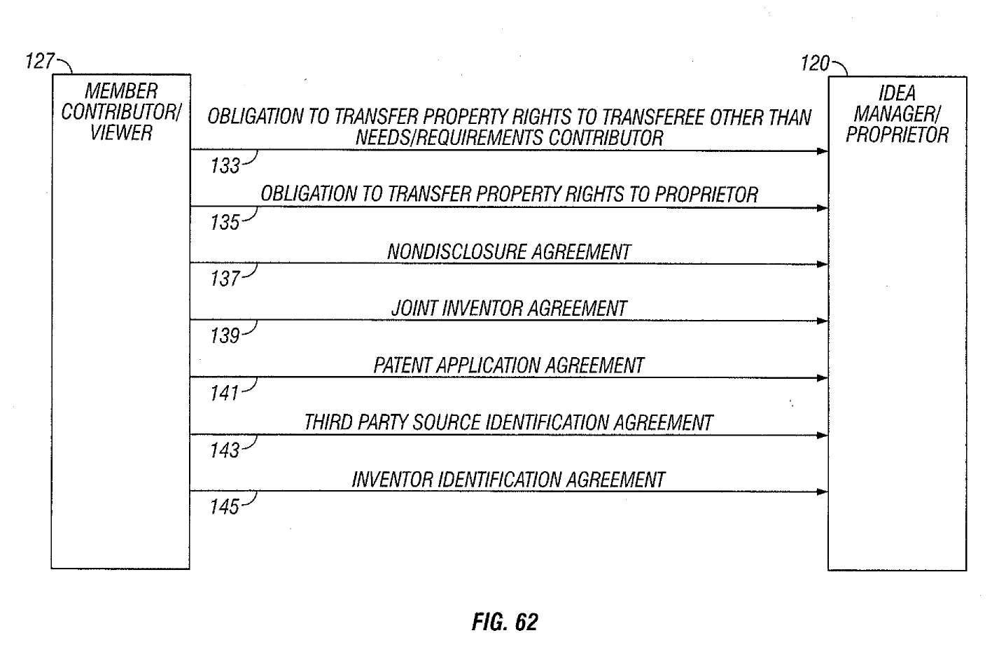

Referring to FIG. 62, in certain embodiments, these systematically established contractual obligations 129 include at least:
(a) obligations 133 by contributors of ideas to the idea database 122 to transfer property rights related to inventions respectively derived at least in part from the contributed ideas to transferees determined by the proprietor of the database, whom in some embodiments are restricted to other than contributors of ideas of needs and/or requirements of the respectively derived inventions. Such obligations 133 may include:
(b) obligations 135 by contributors of ideas to the idea database 122 to transfer such property rights to the proprietor 120 of the idea database 122.
In some embodiments, these systematically established contractual obligations 129 by contributor entities of ideas to the idea database 122 also include:
(c) nondisclosure agreements 137 pertaining to given ideas accumulated in the database 122;
(d) joint inventor agreements 139 to file as a joint inventor any patent application for any invention derived from a combination of any ideas contributed to the idea database 122 by such entity and given accumulated ideas contributed to the idea database 122 by other entities;
(e) patent application agreements including a covenant by the contributor not to file, without permission of the proprietor 120 of the idea database 122, a patent application for any invention related to a given idea accumulated in the idea database 122 until after an established period of time subsequent to accumulation of the given idea, and a covenant by the contributor that if he/she or any successor in title to such patent application and any patents issuing therefrom ever claims a priority date within said established period for the related invention, title to such patent application and any patents issuing therefrom shall be transferred to the proprietor 120 of the idea database 122 or the proprietor's nominee;
(f) third party source identification agreements 143 to disclose the identity of any third-party sources of ideas contributed by such entity that are related to given ideas accumulated in the idea database 122; and
(g) inventor identification agreements 145 to disclose the identity of each inventor of any invention derived from ideas contributed by such entity that are related to given ideas accumulated in the idea database 122.

In certain embodiments, the idea manager 121 establishes and regulates the operation of deposit accounts for the members.

The idea manager 120 systematically provides contingent contractual rights 140 to at least a portion of anticipated income derived from the property rights related to prospectively patentable inventions 124 respectively derived at least in part from ideas contributed to the computer database by the contributors whom receive such contingent contractual rights 140. The idea manager 120 systematically provides such contingent contractual rights 140 to the contributors of ideas to the idea database 122 as an incentive to contribute ideas to the idea database 122. These contingent contractual rights 140 are provided to contributors of the ideas in exchange for the contractual obligations 129 to transfer the property rights related to the inventions.

In some embodiments, the respective contractually obligated contributors generally are not employees of a proprietor of the idea database 122 or employees of a party in concert with the proprietor.

The idea manager 120 systematically facilitates transfer of the property rights 148 by the contributors of ideas to the idea database 122 to a transferee determined by the proprietor. In some of these embodiments, the transfers of property rights 148 are to transferees other than contributors of ideas from which the invention was at least in part derived. In some of the embodiments, the transfer of property rights 148 is to a proprietor of the idea database 122, such as the idea manager 120, or to a party in concert with such proprietor 120. In some of these embodiments, the transferees are not identified upon establishing such obligations; and in some of these embodiments, the transferees are identified upon establishing such obligations.

The computer system 121 is programmed to facilitate such transfers of the property rights by on-line communications between the computer system 121 and the contributor computers 127 and/or the customer computers 128. In implementing the transfer of the property rights 148, the idea manager systematically assures that documents transferring the property rights are executed by the contributors and delivered to the transferee either on-line or by mail.

The contributor of an idea that is obligated to transfer the property rights is generally assigned ownership of the contingent contractual rights 140 upon contribution of the idea. However, the contributor may specify another party unto which to initially assign ownership of the contingent contractual rights 140, such as the employer of the contributor.

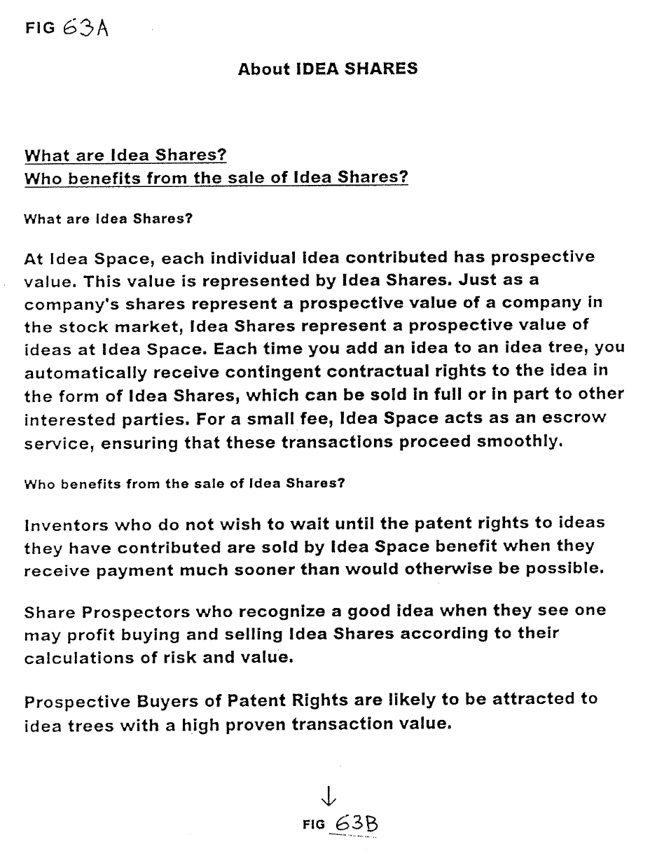

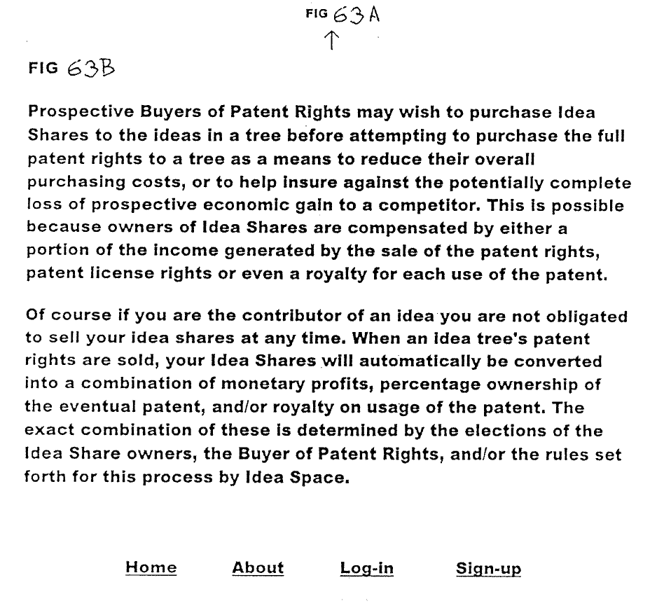

In some embodiments, the computer system 121 is programmed to systematically provide the contributors of ideas with such contingent contractual rights 140 in a marketable format, such as an electronically tradable idea certificate, by on-line communications between the computer system 121 and the contributor computers 127. One embodiment of such a marketable format is described in the About IDEA SHARES screen display shown in FIG. 63.

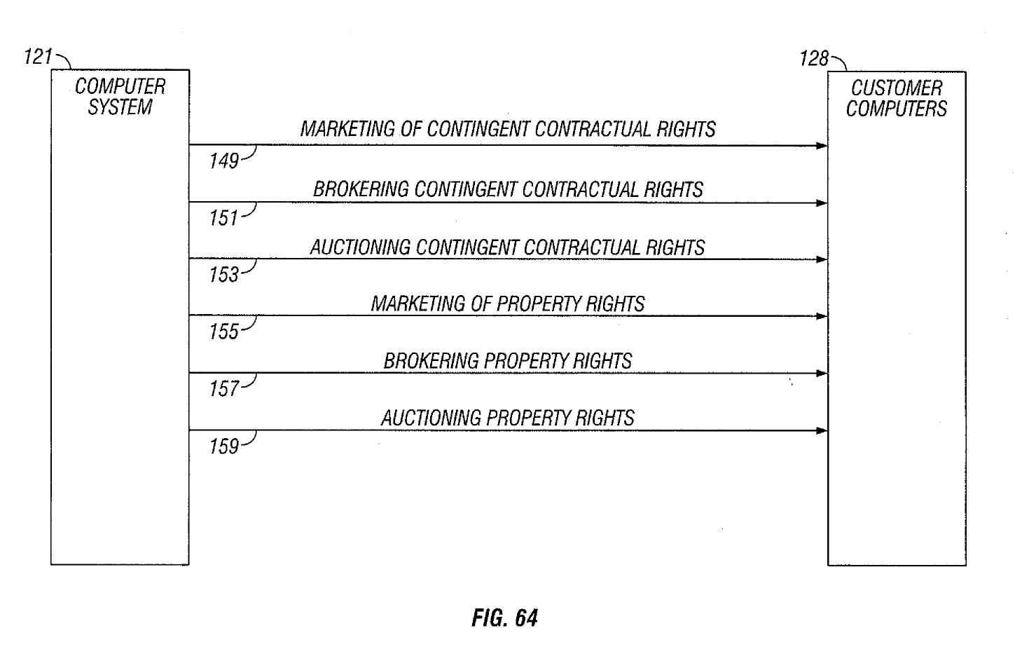

In certain embodiments, the computer system 121 is programmed to facilitate prospective transfer of contingent contractual rights 142 from an owner of contingent property rights to another interested party by facilitating marketing 149 of the contingent contractual rights 140, brokering 151 the contingent contractual rights 140 and/or auctioning 153 the contingent contractual rights 140, as shown in FIG. 64.

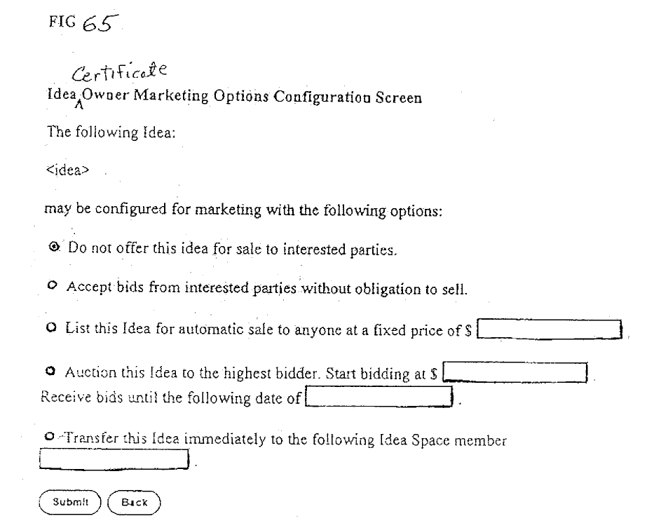

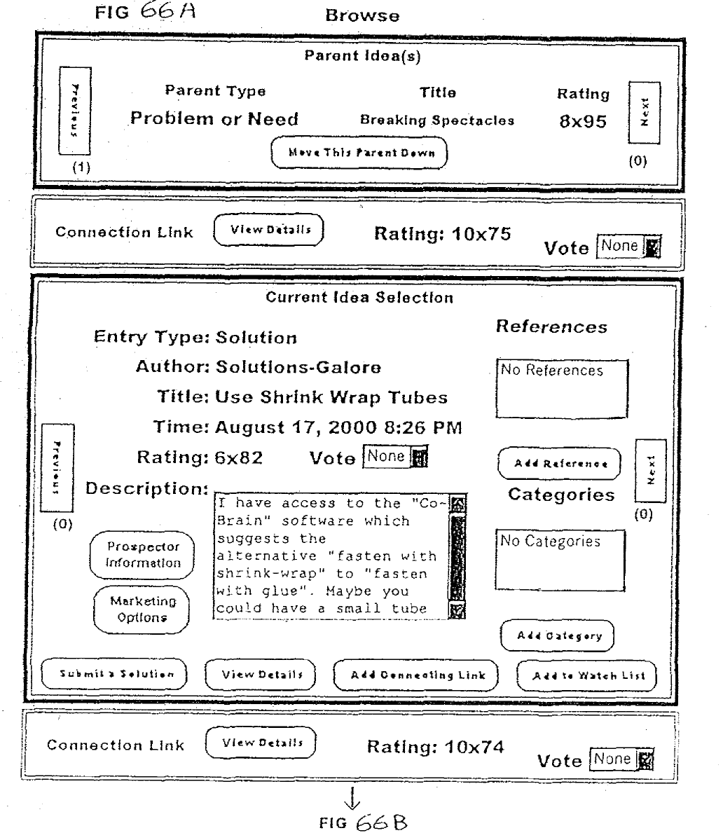

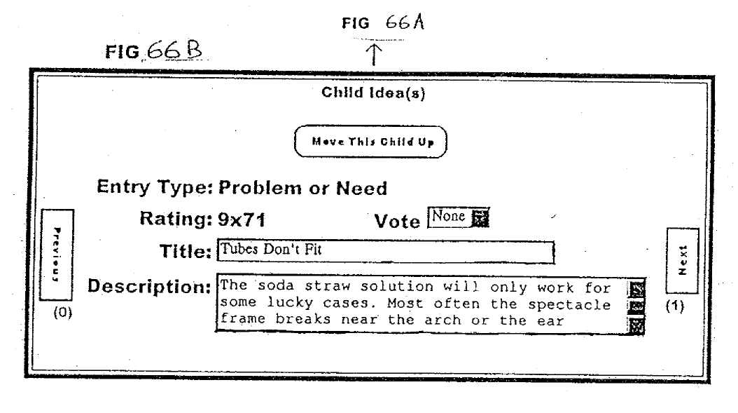

The current owner of a contingent contractual right 140 may elect, among other possible choices, to transfer, sell, or auction the contingent contractual rights 140 to other parties, such as a party having a membership for the purpose of purchasing such contingent contractual rights 140. The computer system 121 is programmed to enable implementation of such choices by enabling entities whom own contingent contractual rights 140 to access an Idea Certificate Owner Marketing Options Configuration Screen display, such as shown in FIG. 65. Such access is accomplished by clicking a Marketing Options button in the Current Idea Section of a Solution type screen display, such as shown in FIG. 66.

Depending upon which of the options shown in the screen display of FIG. 65 is selected and submitted, one of four different types of Idea Prospector Information Screen displays can be accessed when an entity subsequently viewing the idea solution in the screen display of FIG. 66 clicks the Prospector Information button in the Current Idea Section of a Solution type screen display, such as shown in FIG. 66.

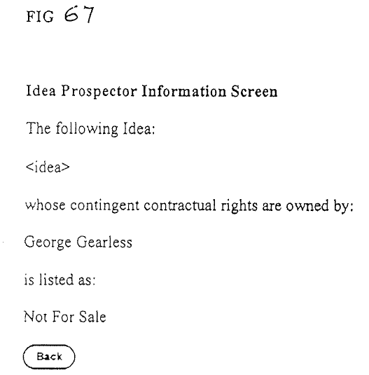

When the “Do not offer this idea for sale to interested parties” option on the screen display of FIG. 65 has been selected and submitted, the Idea Prospector Information Screen display shown in FIG. 67 is displayed in response to clicking the Prospector Information button in the screen display of FIG. 66.

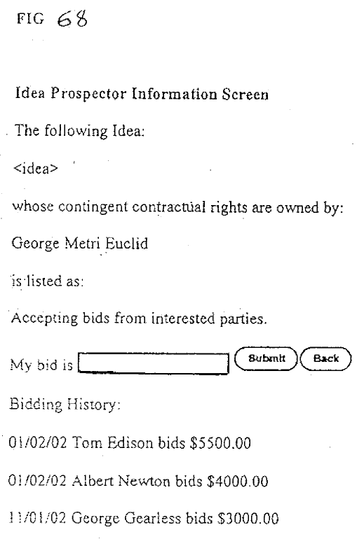

When the “Accept bids from interested parties without obligation to sell” option on the screen display of FIG. 65 has been selected and submitted, the Idea Prospector Information Screen display shown in FIG. 68 is displayed in response to clicking the Prospector Information button in the screen display of FIG. 66.

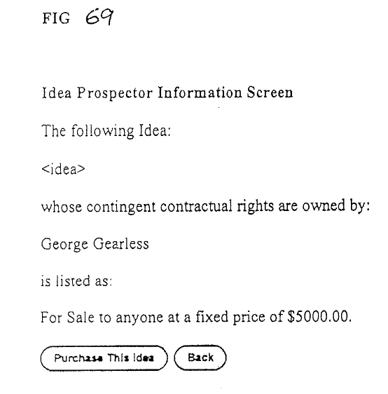

When the “List this Idea for automatic sale to anyone at a fixed price” option on the screen display of FIG. 65 has been selected and submitted, the Idea Prospector Information Screen display shown in FIG. 69 is displayed in response to clicking the Prospector Information button in the screen display of FIG. 66.

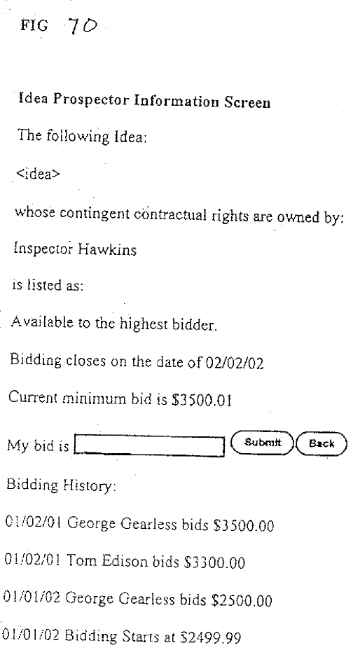

When the “Auction this Idea to the highest bidder” option on the screen display of FIG. 65 has been selected and submitted, the Idea Prospector Information Screen display shown in FIG. 70 is displayed in response to clicking the Prospector Information button in the screen display of FIG. 66. Bids submitted by use of the screen display of FIG. 70 are subsequently displayed in the Bidding History portion of such screen display.

In some embodiments, the computer system 121 facilitates the marketing of idea certificates to other members and/or to the general public. The computer system 121 establishes one or more viewer-accessible memory locations for marketing idea certificates, wherein the ideas certificates are advertised. An algorithm that selects idea certificates for advertisement may change periodically. For example, such algorithm may select the idea certificates for the ideas that were rated in the most recent period, may select idea certificates for the most recent idea submissions to be posted to the idea database 122, and/or may select the idea certificates most recently posted for sale by their owners.

Whether the idea certificate is listed on a member's website or listed at one of the marketing locations established by the computer system 121, when an inquiring viewer, such as an idea speculator, accesses the listed certificate, a displayed access link directs the viewer to a point-of-sale display screen or to an idea submission display screen. If the idea certificate has been posted for auction, the point-of-sale display screen will be an auction site where the inquiring viewer is prompted to make a bid. If the idea certificate is up for direct sale by the owner, the point-of-sale display screen will be a direct-sale site where the inquiring viewer is prompted to purchase the certificate at the advertised sale price.

In some embodiments, the computer system 121 facilitates the posting of idea certificates representing contingent contractual rights 140 as being for sale by posting the idea certificates for sale in accordance with an auctioning routine and by a listing posted on the web page of a member-owner of the idea certificate. In one embodiment, only the owner of the idea certificate may set the sale price of the idea certificate.

The auctioning routine enables the idea certificate owner to specify an open or closed bidding format, a preset sale price and/or a starting or minimum bidding value and an auction duration. Although an idea certificate is posted for auction, if anyone agrees to the specified preset certificate sale price, the auction is immediately terminated and it is deemed that the idea certificate has been sold at the preset sale price. Otherwise, the auction is completed when the duration is reached; and the computer system 121 determines that the highest bidder surpassing the starting/minimum bid has purchased the idea certificate for the highest bid price. If the auction is an open auction, each new bid and a code, name or pseudonym assigned to the viewer/idea speculator making the new offer is displayed.

If the idea certificate is not up for auction, but a preset sale price is listed, the idea speculator may make an offer to purchase the idea certificate. If the offer meets or exceeds the sale price, the computer system 121 determines that the offer has been accepted.

Methods of selling contingent contractual rights 140 other than at a preset price or by auction also are enabled by the computer system 121, including combinations of the methods utilizing the screen displays of FIGS. 65-70 and the alternative methods described above, and such other methods may be based on other conditions provided by the idea manager 120, the owner of the contingent contractual rights or an interested party.

After an idea certificate has been purchased by either auctioning or some method of sale, the computer system 121 removes the posted sale and/or auction advertisements and listings of the idea certificate and facilitates payment of the purchase price by the purchaser and transfer of ownership of the idea certificate to the purchaser, whereupon a new idea certificate in the name of the new owner is issued to the new owner in an electronic format, as described above.

In certain embodiments, once an idea certificate has been sold, the computer system 121 securely consummates the sale by debiting a deposit account maintained by the purchaser, charging any remaining amount due to the purchaser's credit card, and upon the acquisition of income 150 in the amount of the full purchase price, such as by wire transfer, distributing the acquired income 150. The computer system 121 provides a site at which both the purchase and seller can monitor the status of the consummation-of-sale transaction.

In certain embodiments, when income in the amount of the full purchase price has been acquired, the computer system 121 distributes the acquired income 144 by extracting a commission from the sale at a predetermined percentage rate and adding the commission to the proprietor's account. If the seller of the idea certificate had an agreement with one or more agents and/or brokers, the computer system 121 extracts their commission(s) from the acquired income 144 based on the agreed upon commission rate and adds it to the agents' and/or brokers' accounts. The remaining acquired income 144a is then distributed to the selling idea certificate owner by crediting the remaining income 144a to the selling owner's deposit account. Any listed association with agents and/or brokers are then removed from the certificate; and a new idea certificate in the purchaser's name is forwarded to the purchaser. The computer system 121 confirms the transaction to all parties.

The foregoing described methods of facilitating the transfer of an idea certificate are also implemented by the computer system 121 when a plurality of idea certificates are bundled together for sale.

The idea manager 120 systematically facilitates prospective derivation of income from the property rights 148 by facilitating transfer of the property rights 148. In certain embodiments, the computer system 121 is programmed to facilitate prospective derivation of income from the property rights 148 by facilitating marketing 155 of the property rights 148, brokering 157 the property rights 148 and/or auctioning 159 the property rights 148, as shown in FIG. 64.

In some embodiments, the computer system 121 is programmed to publish the conditions for sale or license of property rights related to at least some of the prospectively patentable inventions 124 in the idea database 122 and/or a history of sale or license of property rights to at least some of such inventions 124 by entering such conditions and history in the idea database 122 for public or member viewing. Examples of such conditions include: for sale, not for sale, will take bids, will sell to highest bidder before a specified date, will sell for a specified amount or to the highest bidder by a specified date. Examples of such a history include: sold to FSHP Company on a given date for a stated amount and licensed to General Plastics on a given date for a stated royalty.

A property rights product includes at least one property right related to at least one prospectively patentable invention derived from at least one idea accumulated in the idea database 122. The computer system 121 is adapted for bundling specified property rights related to one or more inventions derived from one or more ideas and/or one or more idea trees into a product that can be sold to technology customers.

The idea manager 120, property rights owners, idea brokers, idea agents, and technology customers viewing the idea database 122 are enabled to specify different property rights related to various inventions derived from various ideas in the idea database 122 for bundling into property rights products. In certain embodiments, after it has determined after consultation with the idea manager 120 which of the specified property rights are to be bundled into given property rights products, the computer system 121 facilitates the transfer of the given property rights products.

In some embodiments, the computer system 121 facilitates the marketing of the property rights products. The computer system 121 establishes one or more viewer-accessible memory locations where the property rights products are respectively advertised. An algorithm that selects property rights products for advertisement may change periodically. For example, such algorithm may select the property rights products related to inventions derived from the ideas that were rated best in the most recent period, may select the property rights products related to the ideas most recently accumulated in the idea database 122, and/or may select the property rights products most recently posted for sale by their owners.

Whether the property rights product is listed on a member's website or listed at one of the marketing locations established by the computer system 121, when an inquiring viewer, such as a technology customer, accesses the listed certificate, a displayed access link directs the viewer to a point-of-sale display screen or to an idea submission display screen. If the property rights product has been posted for auction, the point-of-sale display screen will be an auction site where the inquiring viewer is prompted to make a bid. If the property rights product is up for direct sale by the owner, the point-of-sale display screen will be a direct-sale site where the inquiring viewer is prompted to purchase the certificate at the advertised sale price.

In some embodiments, the computer system 121 facilitates the posting of property rights products as being for sale by posting the property rights products for sale in accordance with an auctioning routine and by a listing posted on the web page of a member-owner of the property rights product. In one embodiment, only the owner of the property rights product may set the sale price of the property rights product.

The auctioning routine enables the property rights product owner(s) to specify an open or closed bidding format, a preset sale price and/or a starting or minimum bidding value and an auction duration. Although a property rights product is posted for auction, if anyone agrees to the specified preset sale price, the auction is immediately terminated and it is deemed that the property rights product has been sold at the preset sale price. Otherwise, the auction is completed when the duration is reached; and the computer system 121 determines that the highest bidder surpassing the starting/minimum bid has purchased the property rights product for the highest bid price. If the auction is an open auction, each new bid and a code, name or pseudonym assigned to the viewer/technology customer making the new offer is displayed.

If the property rights product is not up for auction, but a preset sale price is listed, the technology customer may make an offer to purchase the property rights product. If the offer meets or exceeds the sale price, the computer system 121 determines that the offer has been accepted.

Methods of transferring property rights products other than by sale at a preset price or by auction also are enabled by the computer system 121, including licensing of rights under the property rights and combinations of the alternative methods described above, and such other methods may be based on other conditions provided by the idea manager 120, the owners of the property rights products or an interested party.

After a property rights product has been purchased by either auctioning or some method of sale, the computer system 121 removes the posted sale and/or auction advertisements and listings of the property rights product and facilitates payment of the purchase price by the purchaser and transfer of ownership of the property rights product to the purchaser.

In certain embodiments, once a property rights product has been sold, the computer system 121 securely consummates the sale by debiting a deposit account maintained by the purchaser, charging any remaining amount due to the purchaser's credit card, and upon the acquisition of income 150 in the amount of the full purchase price, such as by wire transfer, distributing the acquired income 150. The computer system 121 provides a site at which both the purchaser and seller can monitor the status of the consummation-of-sale transaction.

In certain embodiments, when income in the amount of the full purchase price has been acquired, the computer system 121 distributes the acquired income 150 by extracting a commission from the sale at a predetermined percentage rate and adding the commission to the proprietor's account. If the seller of the property rights product had an agreement with one or more agents and/or brokers, the computer system 121 extracts their commission(s) from the acquired income 150 based on the agreed upon commission rate and adds it to the agents' and/or brokers' accounts. The remaining acquired income 150a is then distributed to the selling property rights product owner by crediting the remaining income 150a to the selling owner(s) deposit account(s). The computer system 121 confirms the transaction to all parties.

When the property rights included in the sold property rights product are owned by more than one owner, apportionment of the remaining acquired income 150a for distribution to the respective owners is determined either by agreement among the owners or by a distribution-apportionment committee formed by the idea manager 121 in accordance with a rating of the respective property rights and ideas included in the property rights product.

The computer system 121 facilitates the selection of the distribution committee from a list of committee candidates. Once the candidates have been selected, the computer system 121 forwards to each committee member by Email a listing of the property rights and the ideas of needs and associated solutions to be evaluated.

The computer system 121 provides a rating process, whereby the committee members have the option of using a wizard, which walks the user through the rating process or the option to bypass the wizard and complete the rating form directly. In addition, the computer system 121 assists the committee member by “auto-suggesting” previous data entry values where applicable in the attempt to reduce end-user keystrokes. The computer system 121 provides on-line help that provides guidelines for evaluating the submissions. Each submission is rated for its uniqueness, commercial use, and appropriateness.

In certain embodiments, the rating process is simple in form, limited to five levels, and presented as questions as opposed to a numerical scale. The questions may appear as “Was this solution was very unique?”, “Was this solution was somewhat unique?”, “Was this solution very surprising?” and/or “Was this solution was somewhat surprising?”. The computer system 121 enumerates the rating questions and provides an average value. The computer system 121 also provides committee members with tools so they can ensure the idea submissions are unique and are not preceded by prior art that may exist within and external to the computer system 121.

In certain embodiments, all of the various functions described herein are performed systematically. In alternative embodiments some of the various functions described herein are not performed systematically.

Computer readable storage media for use with computer systems is provided, where the computer readable storage media include computer executable instructions for causing computer systems to perform and/or enable performance of the various functions described herein. The above-described methods may be realized in a program format to be stored on a computer readable recording medium that includes any kinds of recording devices for storing computer readable data, for example, a CD-ROM, a DVD, a magnetic tape, and a disk, and may also be realized in a carrier wave format (e.g., Internet transmission).

In still other embodiments the various embodiments described herein are combined with one another to the extent that they are not incompatible with each other.

The features specifically stated herein do not necessarily apply to every conceivable embodiment. Further, such stated features are only examples and should not be construed as the only features.

While the above description contains many specificities, these specificities are not to be construed as limitations on the scope of the present invention, but rather as examples of the embodiments described herein. Other variations are possible and the scope of the present invention is to be determined not by the embodiments described herein but rather by the claims and their legal equivalents. The claims require no implicit limitations. Each claim is to be construed explicitly as stated, or by its legal equivalent.

We claim:

1. A computerized method of managing idea contributions for prospectively patentable inventions that are accumulated in a computer database, the method comprising:
(a) establishing a contractual obligation by a prospective contributor of an idea contribution for the database to transfer property rights of the contributor of a prospectively patentable invention derived at least in part from the idea contribution;
(b) enabling the contributor to view at least some other idea contributions accumulated in the database that are contributed by other contributors;
(c) receiving the idea contribution for the database from the contributor;
(d) providing ownership of a contractual benefit relating to the idea contribution to the contributor,
wherein the contractual benefit is transferred from the owner of the contractual benefit to a new owner of the contractual benefit;
(e) publishing the idea contribution prior to (f);
(f) transferring some of the property rights to a customer to thereby allow the customer to file a patent application for the prospectively patentable invention derived at least in part from the idea contribution; and
(g) distributing remuneration
/reimbursement to the new owner in exchange for the contractual benefit.
